(19) United States
(12) Patent Application Publication
(10) Pub. No.: US 2006/0200395 A1
(43) Pub. Date: Sep. 7, 2006

(54) Stock portfolio selection device, stock portfolio selection method and medium storing stock portfolio selection program

(76) Inventors: Hiroaki Masuyama, Osaka (JP); Kaoru Miyamoto, Tokyo (JP); Makoto Asada, Tokyo (JP); Kazumi Hasuko, Tokyo (JP); Hideaki Hotta, Tokyo (JP); Manabu Orito, Tokyo (JP); Yu Zhang, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/205,219

(22) Filed: Aug. 17, 2005

(30) Foreign Application Priority Data
Mar. 7, 2005 (JP) 2005-063169

(51) Int. Cl. G06Q 40/00

(52) U.S. Cl. 705/35

(57) ABSTRACT

Provided is a device for automatically selecting a more preferable stock portfolio based on the results upon performing a comprehensive valuation of companies using a corporate valuation index containing an intellectual asset related index. Upon selecting the stock portfolio, a plurality of corporate valuation index related data containing an intellectual asset related index is acquired (steps S1 to S6), analysis is performed with the acquired corporate valuation index related data and a company ranking corresponding to at least one prescribed index is created (steps S7 to S13 and S19), a prescribed number of companies is selected from the created company ranking (step S14), an investment ratio is selected in relation to each of the selected companies (step S15), and, based on the obtained distribution result of the investment ratio, a stock portfolio corresponding to the selected company is created and output (steps S16, S17).

### BACKGROUND OF THE INVENTION

1. Field of the Invention

The present invention relates to a stock portfolio selection device for selecting a stock portfolio based on a corporate valuation index. The present invention further relates to a stock portfolio selection method and a medium storing a program for stock portfolio selection.

2. Description of the Related Art

When creating a stock portfolio, it is desirable to incorporate stock expected to yield a high return in the portfolio while combining a portfolio capable of reducing the risk of the return fluctuating. Thus, when creating a stock portfolio, in addition to selecting the stock, it is desirable to seek a portfolio combination giving consideration to the optimum investment ratio in relation to the selected stock. Thereupon, stocks expected to yield a high return are often determined by financial institutions and financial analysts based on their knowledge, experience and quantitative analysis. Further, as data for making this decision, for instance, it is standard to employ macro data publicly announced by government and public offices or the Tokyo Stock Exchange such as the transition of the interest rate trend, transition of the Nikkei Stock Average/TOPIX, capital investment trend of companies and so on. Moreover, as micro data, it is standard to employ the previous stock price transition and financial statements of companies as data for making this decision. In other words, the selection of this kind of stock was made based on the macro data publicly announced as described above and the valuation on the on-balance assets represented in financial statements.

Nevertheless, today, the profit and corporate value of companies are determined depending largely on the off-balance intellectual assets such as technology, R&D and brand. And, in light of the above, proposed is a method of selecting stock expected to yield a high return in the future by valuating the potential technical capabilities of companies not represented in financial statements and the like with an intellectual asset related index such as patents (e.g., U.S. Pat. No. 6,175,824)

Nevertheless, in foregoing U.S. Pat. No. 6,175,824, as the index used for calculating the corporate valuation, only an index obtained from public information of intellectual assets such as patents is used.

Thus, the present invention uses the indexes obtained from patents representing off-balance intellectual assets and further adds data obtained from information concerning the management and finance of companies. The present invention then comprehensively valuates how the respective companies are creating and operating the triune management strategy consisting of business strategy, R&D strategy and intellectual property strategy so as to increase the corporate value. Moreover, this is used as the criterion of judgment upon selecting the stock for portfolio. In addition, the optimum investment ratio can be determined and output based on the same criterion as the case of selecting the stock for portfolio. As a result, provided is a highly convenient stock portfolio selection device, stock portfolio selection method and medium storing a program for stock portfolio selection.

### SUMMARY OF THE INVENTION

In order to achieve the foregoing object, the present invention comprising the following constitution. Incidentally, definition of the terms used for explaining the invention claimed in any of the claims shall be applicable to the invention pertaining to the other claims to the extent possible according to its nature.

(1) The present invention is a device for selecting a stock portfolio based on a corporate valuation index, having the following units; that is, a data acquisition unit for acquiring corporate valuation index related data containing an intellectual asset related index; a company ranking creation unit for performing corporate valuation with the corporate valuation index related data to create a company ranking; a stock-for-portfolio stock selection unit for selecting a prescribed number of companies from the company ranking and making the companies the stock for portfolio; a investment ratio selection unit for selecting the investment ratio of funds to be invested in the respective companies selected by the stock-for-portfolio selection unit; and a stock portfolio creation unit for creating a stock portfolio corresponding to the stock for portfolio based on the investment ratio.

According to the foregoing constitution, the intellectual assets accumulated based on R&D activities and the potential competitive power as the organization and personnel for creating intellectual assets can be valuated appropriately. Further, based on the strategic utilization of such intellectual assets and organization/personnel, companies expected to increasing their overt competitive power and profitability can be appropriately selected. And, it is also possible to select the distribution ratio of invested funds in relation to the selected stock-for-portfolio company based on the same criterion as in the case of selecting the companies. Thereby, information on the exchange of stocks and investment ratio can be acquired easily and accurately.

(2) In the foregoing stock portfolio selection device, it is desirable to further provide an industry/company selection unit for selecting an industry and/or company.

According to the foregoing constitution, in addition to the operation and effect described above, the industry and/or company of the investor's interest can be arbitrarily designated upon selecting the optimum stock portfolio.

Incidentally, the term “industry” as used herein is not limited to the case of indicating the business industry as used generally, and also refers to an arbitrary company group. For example, a group classified by the type of technology, merchandise or product; or a group classified based on the International Patent Classification (IPC) as the patent classification, FI, F term, and US Patent Classification (UPC) or US Standard Industry Classification (SIC).

(3) In each of the foregoing stock portfolio selection devices, as the company ranking creation unit, it is desirable to provide an index selection unit for selecting a prescribed number of corporate valuation indexes so as to contain at least one intellectual asset related index from the corporate valuation index related data acquired with the data acquisition unit; and a principle component analysis unit for performing principle component analysis with the corporate valuation index selected by the index selection unit and calculating the principle component score of each company.

According to the foregoing constitution, upon selecting a stock-for-portfolio company, a selection is made from the corporate valuation index related data so as to contain at least one intellectual asset related index. Therefore, in addition to the respective operations and effects described above, the intellectual assets accumulated based on R&D activities and the potential competitive power as the organization and personnel for creating intellectual assets can be valuated appropriately, and companies expected to increasing their profitability can be appropriately selected.

In addition, since a company ranking can be created based on the principle component analysis, stock-for-portfolio candidate companies can be objectively selected without depending on arbitrariness.

(4) In each of the foregoing stock portfolio selection devices, as the company ranking creation unit, it is preferable to provide a factor analysis unit for performing factor analysis to extract factor with the corporate valuation index related data acquired by the data acquisition unit and uniting the corporate valuation index based on the factor; a multiple regression analysis unit for performing multiple regression analysis based on the factor extracted by the factor analysis unit and the profit related index representing various profits such as intellectual asset related profits, and selecting the corporate valuation index based on the factor showing the statistical significance in relation to the profit related index; and a principle component analysis unit for performing principle component analysis with the corporate valuation index selected by the multiple regression analysis unit and calculating principle component score of each company.

According to the foregoing constitution, upon selecting a stock-for-portfolio company, corporate valuation is performed upon selecting a factor showing the statistical significance in relation to the profit related index such as intellectual asset related profits. Therefore, the indexes are made comprehensive upon clarifying the structure of what is contributing to the various profits such as the intellectual asset related profits of the company. Thus, in addition to the respective operations and effect described above, stock-for-portfolio candidate companies can be objectively selected based on the corporate valuation indeed without depending on arbitrariness.

(5) In each of the foregoing stock portfolio selection devices, as the company ranking creation unit, it is preferable to provide a covariance structure analysis unit for performing covariance structure analysis with the corporate valuation index containing the intellectual asset related index as observed variable so as to perform corporate valuation to the respective companies.

According to the foregoing constitution, in addition to the foregoing operations and effects, the causal structure among abstract elements that cannot be directly observed with covariance structure analysis can be comprehended and valuated. Further, by making various indexes such as the intellectual asset related index an observed variable, it will be possible to comprehensively valuate companies that are promoting the management strategy of such intellectual assets and linking this to the improved profitability of the company. Moreover, it will be possible to valuate companies multilaterally per index constituting the observed variable.

(6) In each of the foregoing stock portfolio selection devices, it is desirable that the investment ratio selection unit distributes investment funds equally to the stock of the respective companies selected by the stock-for-portfolio selection unit.

The potential value of the company is appropriately valuated upon containing at least one intellectual asset related index from the corporate valuation index related data at the stage of selecting the stock-for-portfolio company. Therefore, by equally distributing the invested funds, in addition to the respective operations and effects described above, a highly concise and profitable stock portfolio can be created.

(7) In each of the foregoing stock portfolio selection devices, as the investment ratio selection unit, it is desirable to provide the following; that is, a theoretical stock price calculation unit for calculating the theoretical stock price of the respective companies selected by the stock-for-portfolio selection unit; a first parameter calculation unit for calculating first parameters of the theoretical excess profit in relation to the market stock price of the respective companies, theoretical sensitivity of the stock price of the respective companies in relation to the fluctuation of the market stock price, and theoretical residual showing an independent price movement of the stock of the respective companies based on said theoretical stock price; an expected return calculation unit for calculating the expected return of the stock for portfolio based on the first parameters; a risk calculation unit for calculating the risk of the stock for portfolio based on the first parameters; an efficient frontier derivation unit for deriving the efficient frontier by calculating the share of portfolio of the stock for portfolio in relation to the value of the respective expected returns so as to make the value of the expected return a fixed value; a risk-free rate data acquisition unit for acquiring the risk-free rate data; a capital market line derivation unit for deriving a capital market line through a fixed point of the risk-free rate and tangent to the efficient frontier; an optimum share of portfolio calculation unit for calculating the share of portfolio of the stock for portfolio in the contact point of the efficient frontier and the capital market line; and a fund investment ratio calculation unit for calculating the fund investment ratio in relation to the stock of the respective companies forming the stock for portfolio based on the optimum share of portfolio.

According to the foregoing constitution, by calculating the expected return and risk of each stock of the respective companies of the stock for portfolio, in addition to the respective operations and effects described above, it will be possible to select an investment ratio in the contact point of the capital market line and efficient frontier. Further, by valuating, with the theoretical stock price, the potential competitive power of the company, it is expected that the distortion of the actual stock price due to arbitrariness of the market trend or the like unrelated to the asset value essential to the company will be eliminated as much as possible. As a result, the stock portfolio based on the correction of this theoretical stock price, in comparison to the stock portfolio based on the actual stock price, will be able to achieve the reduction of relative risks and/or a relatively high expected return. In other words, it will be possible to select a more preferable investment ratio.

(8) In each of the foregoing stock portfolio selection devices, as the investment ratio selection unit, it is desirable to provide the following; that is, a theoretical stock price calculation unit for calculating the theoretical stock price of the respective companies selected by the stock-for-portfolio selection unit; a stock price index data acquisition unit for acquiring price movement data of the stock price index; an individual stock data acquisition unit for acquiring price movement data of the stock price of said respective companies; a second parameter calculation unit for performing comparative analysis of the price movement of said stock price index and the price movement of the stock price of said respective companies, and calculating second parameters of the excess profit of each stock of said respective companies in relation to the profit of said stock price index, sensitivity of the stock price of said respective companies in relation to the price movement of said stock price index, and residual showing an independent price movement of the stock of said respective companies which is independent from the price movement of said stock price index; a correction unit for correcting said second parameters based on said theoretical stock price; an expected return calculation unit for calculating the expected return of the stock for portfolio based on the corrected second parameters; a risk calculation unit for calculating the risk of the stock for portfolio based on the corrected second parameters; an efficient frontier derivation unit for deriving the efficient frontier by calculating the share of portfolio of the stock for portfolio in relation to the value of the respective expected returns so as to make the value of the expected return a fixed value and make the value of said risk a minimum value; a risk-free rate data acquisition unit for acquiring the risk-free rate data; a capital market line derivation unit for deriving a capital market line through a fixed point of the risk-free rate and tangent to the efficient frontier; an optimum share of portfolio calculation unit for calculating the share of portfolio of the stock for portfolio in the contact point of the efficient frontier and the capital market line; and a fund investment ratio calculation unit for calculating the fund investment ratio in relation to the stock of the respective companies forming the stock for portfolio based on the optimum share of portfolio.

According to the foregoing constitution, by calculating the expected return and risk of each stock of the respective companies of the stock for portfolio, in addition to the respective operations and effects described above, it will be possible to select an investment ratio in the contact point of the capital market line and efficient frontier. Further, by correcting, with the theoretical stock price, the parameter calculated based on the comparative analysis of the price movement of the stock price index and the price movement of the stock price of the respective companies and appropriately valuating the potential competitive power of the company, it is expected that the distortion of the actual stock price due to arbitrariness of the market trend or the like unrelated to the asset value essential to the company will be eliminated as much as possible. As a result, the stock portfolio based on the correction of this theoretical stock price, in comparison to the stock portfolio based on the actual stock price, will be able to achieve the reduction of relative risks and/or a relatively high expected return. In other words, it will be possible to select a more preferable investment ratio.

(9) and (10) In each of the foregoing stock portfolio selection devices, it is desirable that the theoretical stock price calculation unit is provided with the following; that is, a total business income after tax theoretical value calculation unit for calculating the total business income after tax theoretical value of a company with corporate valuation index related data containing the intellectual asset related index; an investment capital cost calculation unit for calculating the investment capital cost of a company with the corporate valuation index related data; a theoretical economic excess profit calculation unit for calculating the theoretical economic excess profit by deducting the investment capital cost from the total business income after tax theoretical value; a discount rate calculation unit for calculating the discount rate for derivation of the present value of a company with corporate valuation index related data containing the intellectual asset related index; a theoretical market value added calculation unit for calculating the theoretical market value added by dividing the theoretical economic excess profit by the discount rate; an equity capital calculation unit for calculating the equity capital of a company with corporate valuation index related data containing the intellectual asset related index; an estimated aggregate market value calculation unit for calculating the estimated aggregate market value of a company by adding the market value added and the equity capital; and a theoretical stock price calculation unit for calculating the theoretical stock price by dividing the estimated aggregate market value by the total outstanding stock volume.

According to the foregoing constitution, in addition to the respective operations and effects described above, the R&D cost related index and intellectual asset related index can be utilized to calculate the theoretical stock price appropriately reflecting the potential competitive power of the company. Based on this result, it will be possible to determine whether the present stock price of a prescribed company is relatively cheap or relatively expensive in comparison to the potential corporate value essential to such company.

(11) through (30) Further, the present invention also relates to a stock portfolio selection method including the same steps as the processing steps to be executed by each of the foregoing devices, and a computer-readable medium storing a program for causing a computer to execute the same functions as the functions provided to each of the foregoing devices.

### BRIEF DESCRIPTION OF THE DRAWINGS

FIG. 1 is a diagram showing a configuration example of the stock portfolio selection system employing the stock portfolio selection device according to the present embodiment;

FIG. 2 is a block diagram showing the configuration of the stock portfolio selection device 30;

FIG. 3 is a flowchart showing the processing steps of the stock portfolio selection device 30;

FIG. 4 is a chart illustrating the business/management related index (No. 1);

FIG. 5 is a chart illustrating the business/management related index (No. 2);

FIG. 6 is a chart illustrating the R&D related index;

FIG. 7 is chart illustrating the intellectual asset related index (No. 1);

FIG. 8 is a chart illustrating the intellectual asset related index (No. 2);

FIG. 9 is a chart illustrating the intellectual asset related index (No. 3);

FIG. 10 is a diagram showing an example of a screen for selecting the industry, company and index;

FIG. 11 is a flowchart showing the processing steps for performing the principle component analysis;

FIG. 12 is a chart showing the characteristic vector of the principle component analysis;

FIG. 13 is a concentration type company ranking corresponding to principle component 1;

FIG. 14 is a diversification type company ranking corresponding to principle component 2;

FIG. 15 is a flowchart of the factor analysis processing;

FIG. 16 is a chart showing the factor loading, characteristic value and cumulative contribution ratio;

FIG. 17 is a chart showing a list of factors;

FIG. 18 is a flowchart of the multiple regression analysis processing;

FIG. 19 is a chart showing a list of the multiple regression analysis;

FIG. 20 is a diagram showing the relationship of the index and factor;

FIG. 21 is a chart showing a list of the principle component analysis;

FIG. 22 is a comprehensive index ranking based on the principle component analysis;

FIG. 23 is a flowchart of the covariance structure analysis processing;

FIG. 24 is a path diagram showing the relationship of the intellectual property strategic management model;

FIG. 25 is a chart showing the company ranking based on the analysis of the intellectual property strategic management model;

FIG. 26 is a chart showing the company ranking based on the analysis of the intellectual property strategic management model;

FIG. 27 is a chart showing the company ranking based on the analysis of the intellectual property strategic management model;

FIG. 28 is a chart showing the company ranking based on the analysis of the intellectual property strategic management model;

FIG. 29 is a chart showing the company ranking based on the analysis of the intellectual property strategic management model;

FIG. 30A is a scatter plot of the analysis of the intellectual property strategic management model;

FIG. 30B is a chart showing a company ranking based on a plurality of indexes representing patent features.

FIG. 31A is a scatter plot of the analysis of the intellectual property strategic management model;

FIG. 31B is a chart showing a company ranking based on a plurality of indexes representing patent features.

FIG. 32 is a flowchart showing the selection operation of the investment ratio;

FIG. 33 is a diagram showing the price movement data of the index;

FIG. 34 is a diagram showing the price movement data of individual stock;

FIGS. 35A and 35B are diagrams showing an example of the calculated αᵢ, βᵢ, εᵢ;

FIG. 36 is a flowchart showing the processing steps of calculating the theoretical stock price;

FIG. 37 is a flowchart showing the processing steps of calculating the total business income after tax theoretical value;

FIGS. 38A and 38B are diagrams showing an example of the results of the factor analysis and multiple regression analysis;

FIG. 39 is a diagram showing an example of the results of the multiple regression analysis;

FIG. 40 is a diagram showing an example of the results of the regression line of the ROA β in relation to the factor;

FIG. 41 is a diagram showing an example of the calculated theoretical stock price;

FIG. 42 is a list of the calculation results of the theoretical stock price;

FIG. 43 is a diagram showing an example of αᵢ, βᵢ, εᵢ and αᵢ′, βᵢ′, εᵢ′;

FIG. 44 is a diagram showing an example of the efficient frontier and capital market line;

FIG. 45 is a diagram showing an example of the efficient frontier and capital market line;

FIG. 46 is a diagram showing an example of the theoretical addition ratio of each stock of the stock portfolio in the contact point;

FIG. 47 is a diagram showing an example of the actual addition ratio determined from the theoretical addition ratio;

FIG. 48 is a diagram showing an example of the stock portfolio corresponding to principle component 1;

FIG. 49 is a diagram showing an example of the stock portfolio corresponding to principle component 2;

FIG. 50 is a diagram showing a comparative example of the fluctuation ratio of the stock price; and

FIG. 51 is a diagram showing an example of the return.

### DETAILED DESCRIPTION OF THE PREFERRED EMBODIMENTS

(1. Configuration of Stock Portfolio Selection Device)

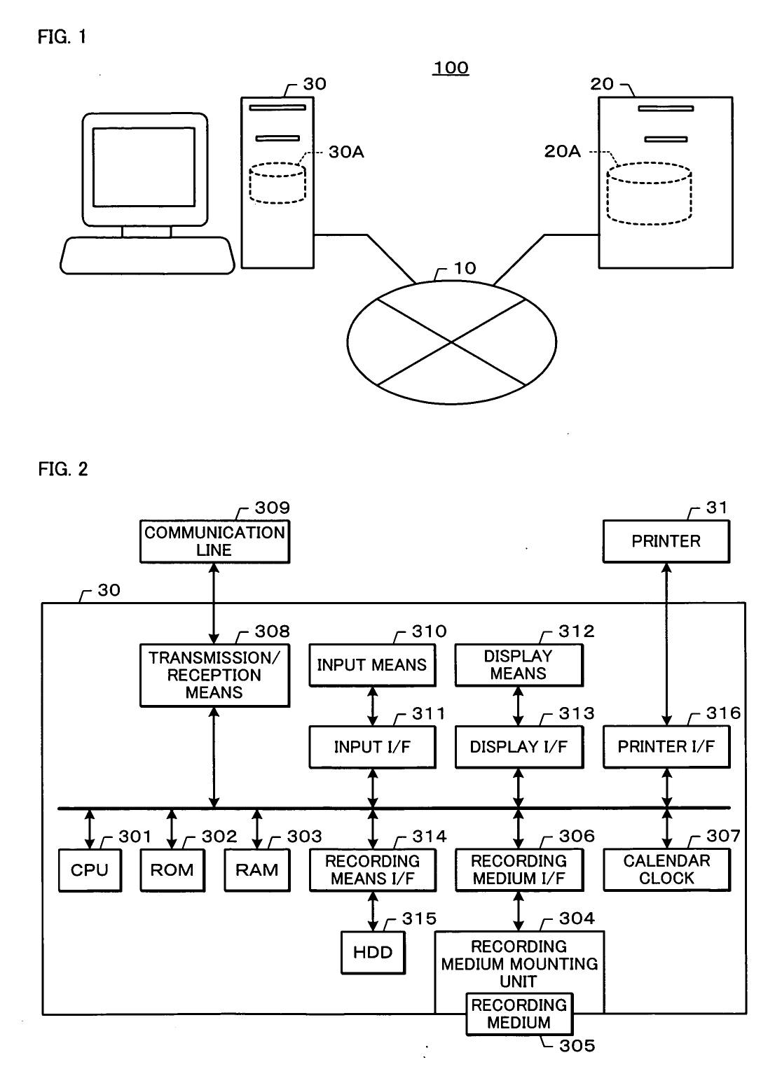

Embodiments of the present invention are now explained with reference to FIG. 1 and FIG. 2. FIG. 1 is a diagram showing the constitution of a stock portfolio selection system 100 containing a stock portfolio selection device 30 according to the present embodiment.

The stock portfolio selection system 100 is constituted from a stock portfolio selection device 30 and an external database server 20. The stock portfolio selection device 30 is connected to the external database server 20 via a communication network 10 such as the Internet, for instance, or is capable of incorporating external data from the external database server 20 offline via an appropriate recording medium.

Further, the external database 20A stores, for instance, an industry/company database storing company names based on industry or alphabetical order; corporate index such as the business/management related index or R&D related index or intellectual asset related index; classification of corporate indexes; various constants and threshold values and determination results on adequacy based on such threshold value; various types of information of categories and the like; and stock prices of the respective companies.

The stock portfolio selection device 30 is constituted from a computer such as a personal computer or workstation, and has an internal database 30A.

FIG. 2 is a block diagram showing the constitution of the stock portfolio selection device 30. As shown in FIG. 2, the stock portfolio selection device 30 has a CPU 301, a ROM 302, a RAM 303, a recording medium mounting unit 304, a recording medium 305, a recording medium interface 306, a calendar clock 307, a transmission/reception means 308, a communication line 309, an input means 310, an input interface 311, a display means 312, a display interface 313, a recording means interface 314, a recording means 315 such as a hard disk (HDD), a printer interface 316, and a bus 317.

The CPU 301 controls the overall operation of the stock portfolio selection device 30 while using the RAM 303 as the work area according to program information for the stock portfolio selection device.

Incidentally, the CPU 301 may execute all processing, or a plurality of dedicated processing devices may be provided so as to make the respective processing devices share and execute such processing.

The recording medium 305 is detachably mounted to the recording medium mounting unit 304. Further, the recording medium mounting unit 304 is connected to the bus 317 via the recording medium interface 306 which records and reads various types of information in and from the recording medium 305. Incidentally, the recording medium 305 is a detachable recording medium of a magnetic recording system or optical recording system as represented by semiconductors such as a memory card, MO or magnetic disk. The recording medium 305 is capable of housing the internal database 30A. Incidentally, the recording medium 305 is also capable of incorporating external data from the external database server 20 offline.

The calendar clock 307 is used as a clock means, and is connected to the bus 317.

The transmission/reception means 308 is connected to the external database server 20 with the communication line 309, and it communicates with the external database server 20 via the communication network 10, and acquires indexes for corporate valuation and stock prices of companies from the external database 20A of the external database server 20. The acquired data is stored in the HDD 315 or recording medium 305 as the internal database 30A. Incidentally, in the stock portfolio selection device 30, index data may be selected automatically or manually upon acquiring indexes for corporate valuation and stock prices of companies from the external database 20A.

The input means 310 is constituted from the likes of a keyboard, mouse, tablet or touch panel, and is connected to the bus 317 via the input interface 311. This input means 310 is used for selecting whether to update data, selecting the industry/company and selecting the analyzing method in the selection screen (not shown) of various instructions displayed on the display means 312.

The display means 312, for instance, is constituted from the likes of an LCD (Liquid Crystal Display), and is connected to the bus 317 via the display interface 313. This display means 312 displays the data input from the input means 310 and options of operational instructions on the screen. Further, the display means 312 displays the results of the calculated theoretical stock price on the screen.

The HDD (hard disk) 315 is a recording means storing various types of information such as the various constants relating to the processing of the stock portfolio selection device 30 and attribute information upon communicating with a communication device on a network; connection information such as URL (Uniform Resource Locators), gateway information and DNS (Domain Name System); management/finance information regarding the management of companies; technical documents concerning patents; patent information; market value information; and threshold values for determining the corporate value and determination results of adequacy based on such threshold value.

Further, the information stored in the HDD 315 can be read out via the recording means interface 314, and information can also be written in the HDD 315. The HDD 315 houses the internal database 30A having recorded thereon various data.

The printer 31 is connected to the bus 317 via the printer interface 316. This printer 31, as a printing means, prints the chart and the like concerning the stock portfolio created by the stock portfolio selection device 30 on a paper medium or the like.

According to the stock portfolio selection system according to an embodiment of the present invention, it is possible to perform a comprehensive valuation of companies with a corporate valuation index containing an intellectual asset related index and the like. In addition, it is possible to select a company to become the stock for portfolio candidate, and to create a stock portfolio enabling the output of the optimum investment ratio. Further, information on the exchange of stocks and investment ratio can be acquired easily and accurately.

(2. Process of Stock Portfolio Selection)

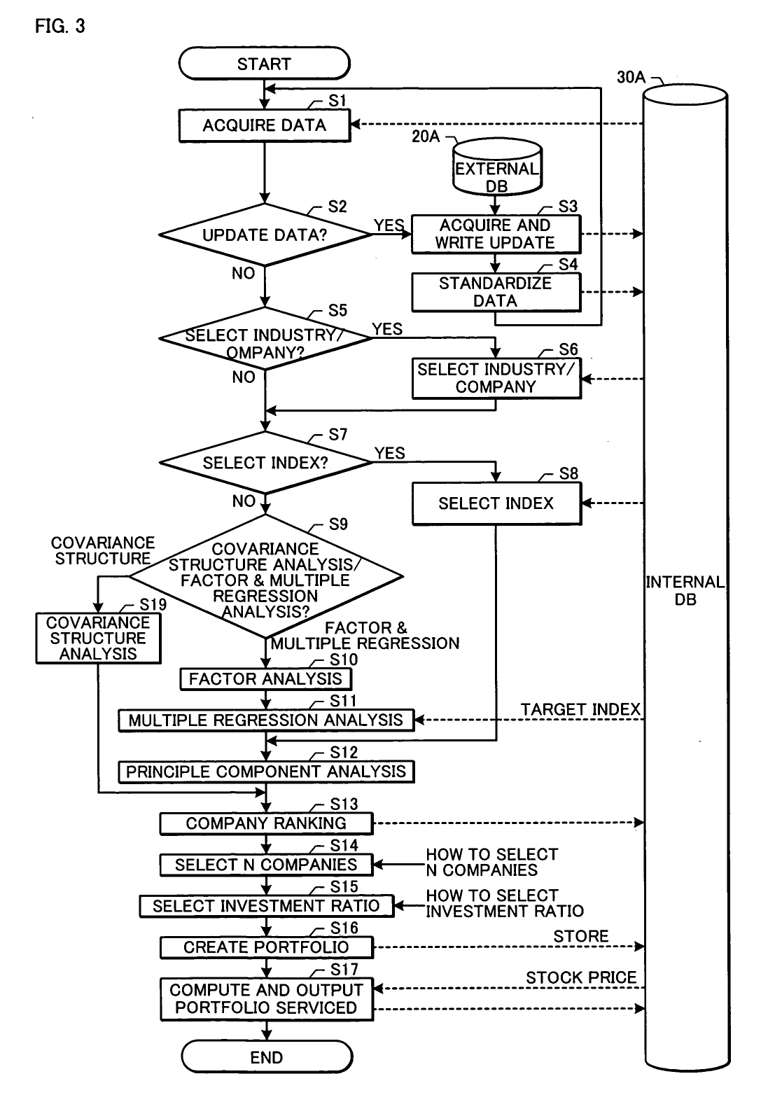

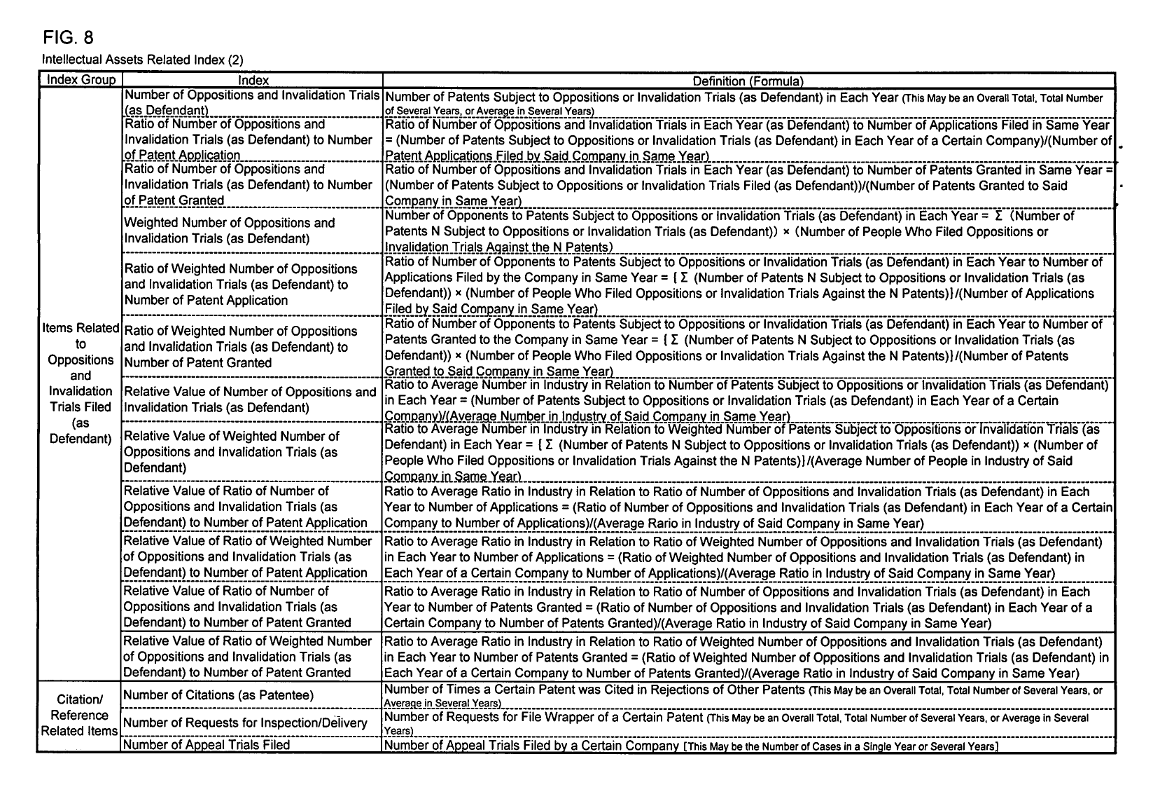

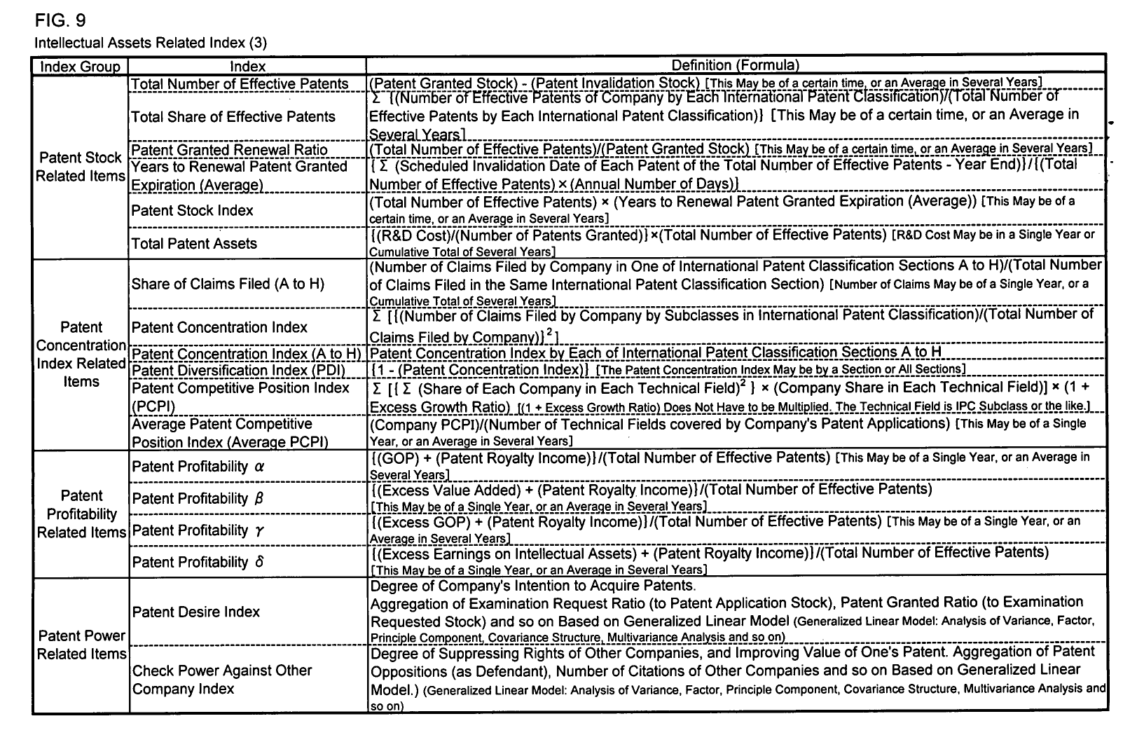

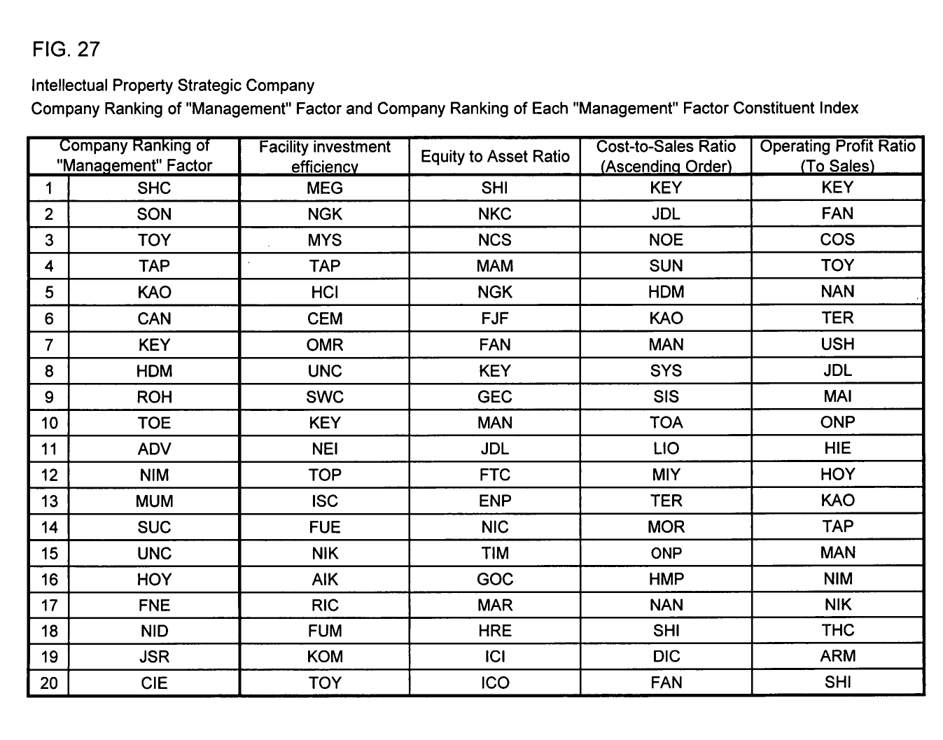

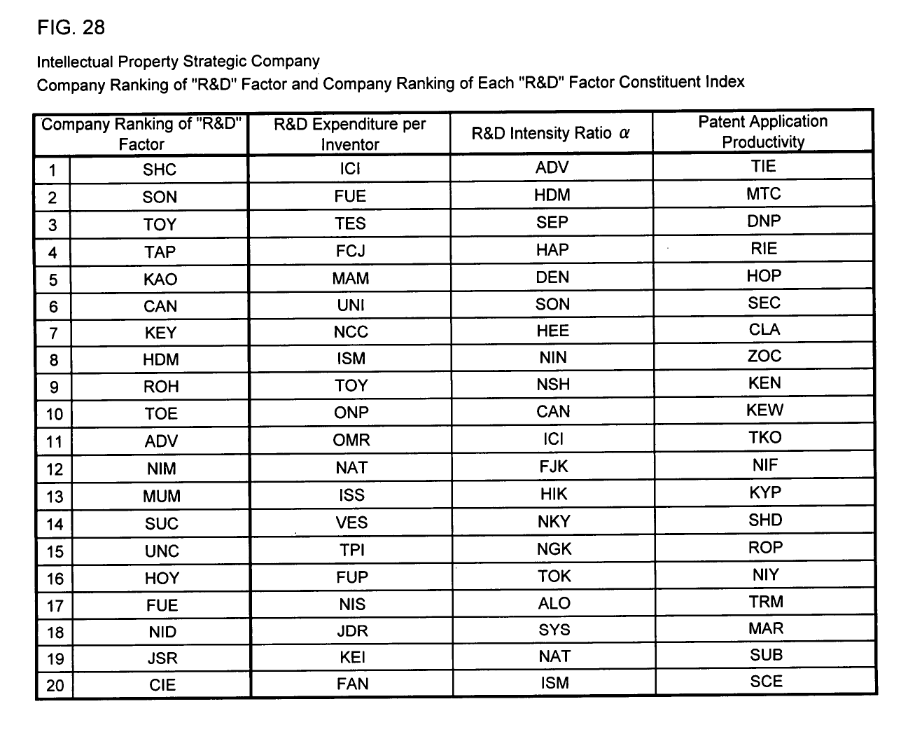

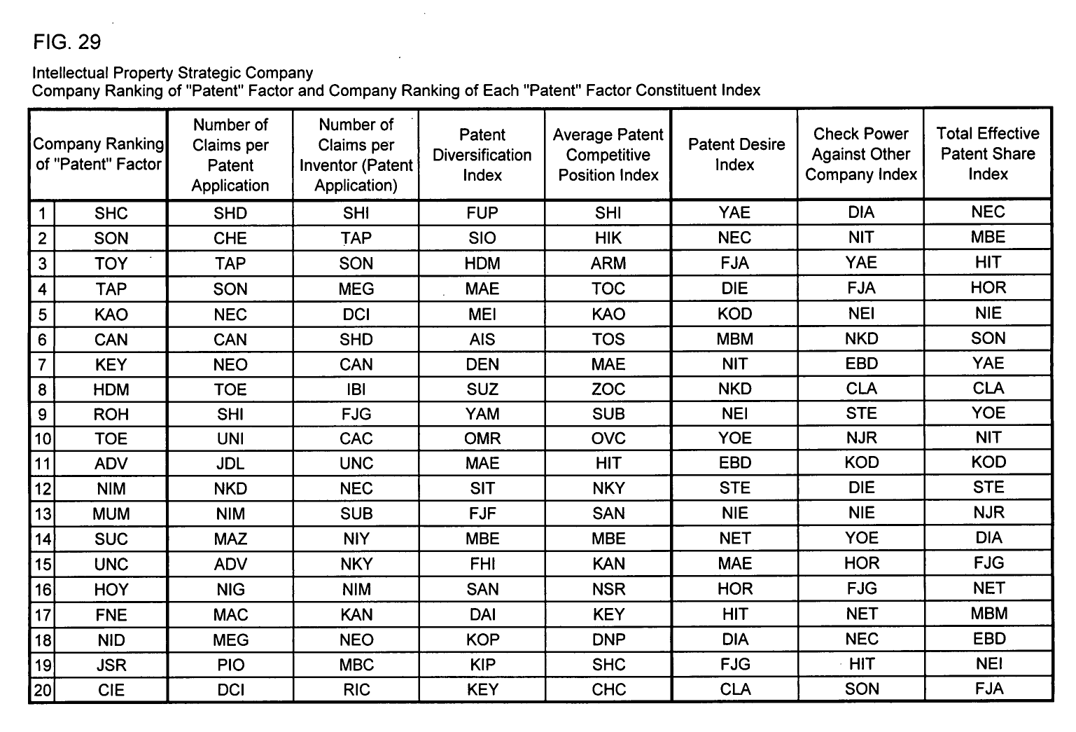

Next, the processing steps of creating the stock portfolio with the stock portfolio selection device, method and program are explained with reference to FIG. 3 to FIG. 47. FIG. 3 is a flowchart representing the processing steps of the stock portfolio selection based on the stock portfolio selection system 100. This processing is realized pursuant to the control of the CPU 301 based on the information incorporated in the stock portfolio selection program.

(2-1. Data Acquisition)

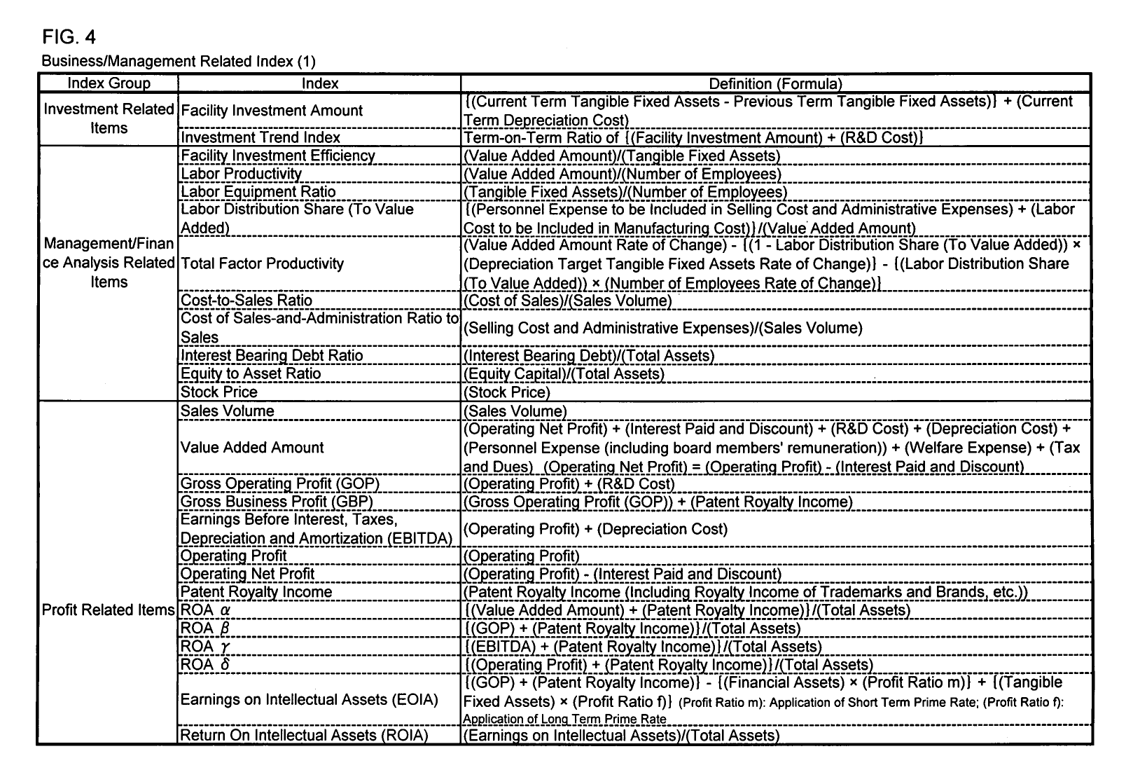

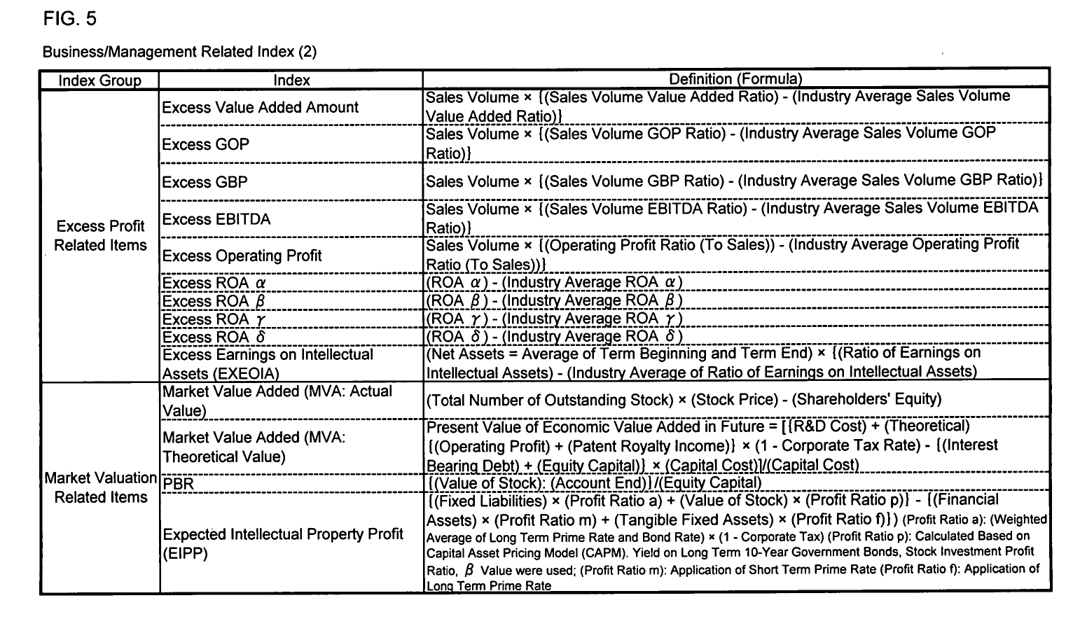

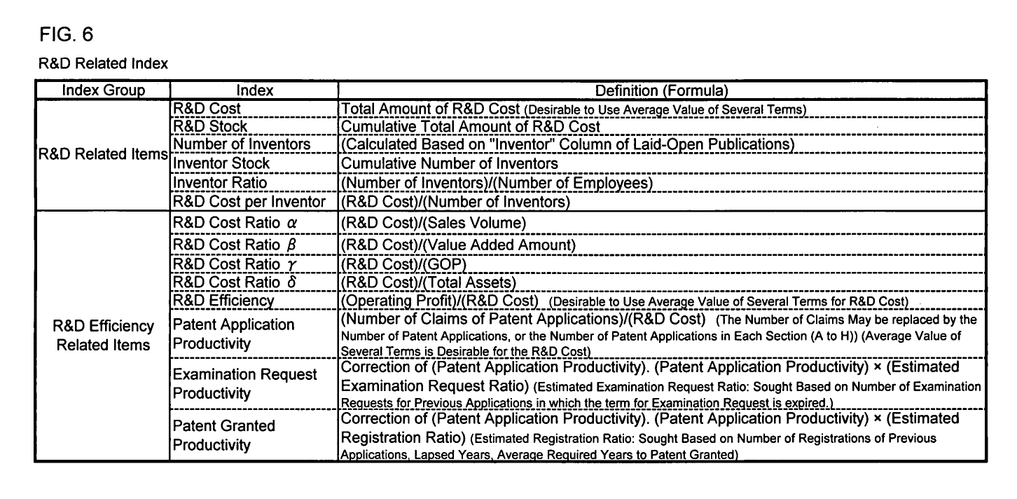

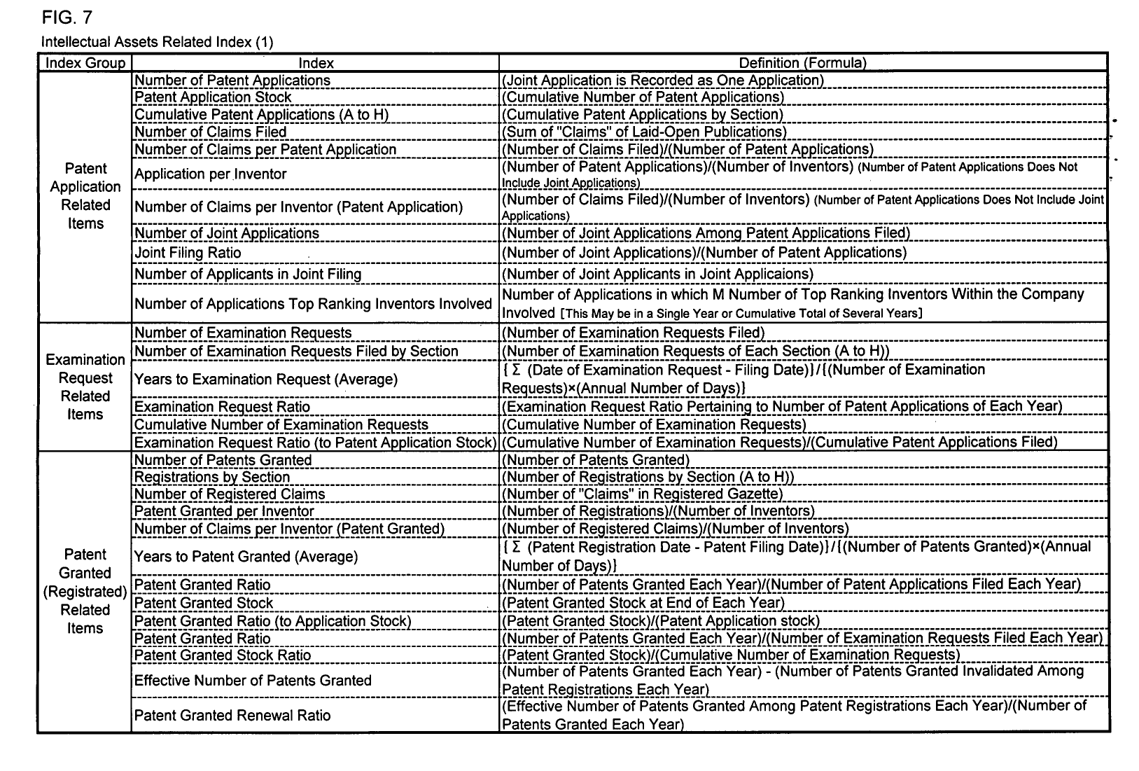

The stock portfolio selection system 100, foremost, at step S1, acquires necessary data from the internal database 30A. For example, corporate index such as the business/management related index or R&D related index or intellectual asset related index, or data on the stock prices of the respective companies. FIG. 4 and FIG. 5 are diagrams showing a list of the business/management related index, and, for instance, these are indexes of the capital investment amount, facility investment efficiency and so on. FIG. 6 is a diagram showing a list of the R&D related index, and, for instance, these are indexes of the R&D cost, R&D intensity a and so on. FIG. 7 through FIG. 9 are diagrams showing a list of the intellectual asset related index, and, for instance, these are indexes of the number of patent applications filed, number of examination requests filed, or total number of effective patents, number of claims filed, and so on.

The internal database 30A stores live data acquired from the external database 20A, standardized processing data and so on.

Next, at step S2, whether the update of data is required is determined. For example, a daily predetermined time is set as the data update time, and update processing is performed at such time. Or, data may be updated each time new data is added to the external database 20A.

When it is determined that an update is required, at step S3, updated data is acquired from the external database 20A and written in the internal database 30A. Then, at step S4, standardization of data is performed according to formula 1 below in relation to the data acquired from the external database 20A. The reason for performing this standardization of data is primarily for eliminating the gaps of numerical values arising pursuant to the difference of units and scales among industries or indexes.
(Live Data−Average Live Data)/Standard Deviation (Formula 1)

Then, the data standardized for each industry is stored in the internal database 30A. After the standardization of data, the routine returns to step S1, and acquires the updated data. Next, at step S2, when it is determined that the update of data is not required, the routine proceeds to step S5 for the selection of industry/company.

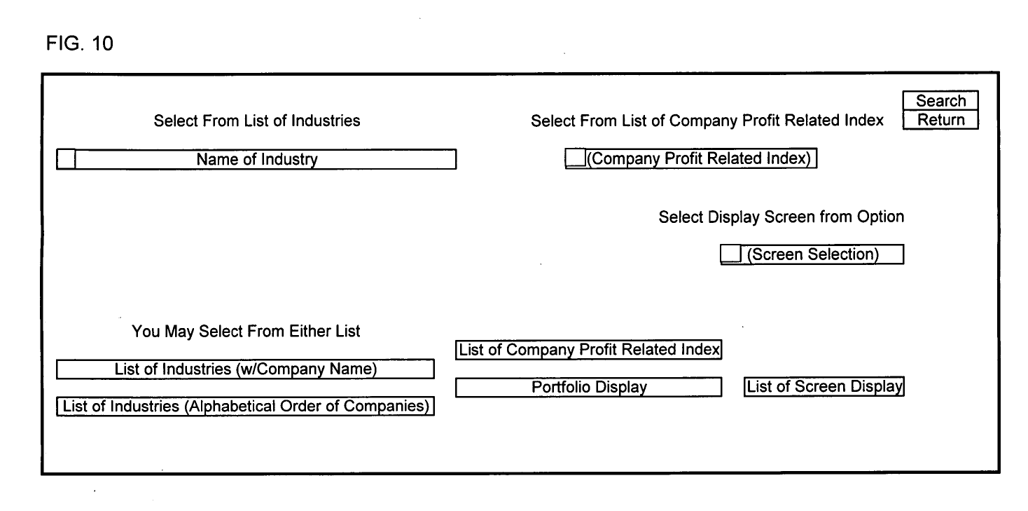

At step S5, whether the industry and/or company is to be selected is determined. Here, when the user determines that the selection of the industry and/or company is required and inputs instructions to the effect of selecting the industry and/or company, at step S6, the selection of the desired industry and/or specific company is accepted. For example, as shown in FIG. 10, the user may input the industry name or company name in the input unit of the industry or company name displayed on the display screen so as to select the desired industry and specific company. Further, for instance, by the user may also select the desired industry and specific company by selecting the option of the industry name and company name displayed on the display screen. Incidentally, when desiring to combine a certain industry with another industry, or when desiring to add a specific company, the stock portfolio can be created by designating such industries or companies.

(2-2. Company Valuation)

Next, at step S7, whether an index is to be selected is determined. When the user inputs instructions to the effect of performing index selection, at step S8, selection of the desired index is accepted. For example, as shown in FIG. 10, the user is able to select a desired index from the index option displayed on the display screen.

Incidentally, upon selecting an index, as a general rule, it is desirable to include one to three R&D related indexes and intellectual asset related index, respectively, among the business/management related index, R&D related index and intellectual asset related index shown in FIG. 4 to FIG. 9. As a result, the intellectual assets accumulated based on R&D activities and the potential competitive power as the organization and personnel for creating intellectual assets can be valuated appropriately. Further, based on the strategic utilization of such intellectual assets and organization/personnel, companies expected to increasing their overt competitive power and profitability can be appropriately selected. After the selection of the index, principle component analysis is performed at step S12.

(2-2-1. Principle Component Analysis Using Selected Indexes)

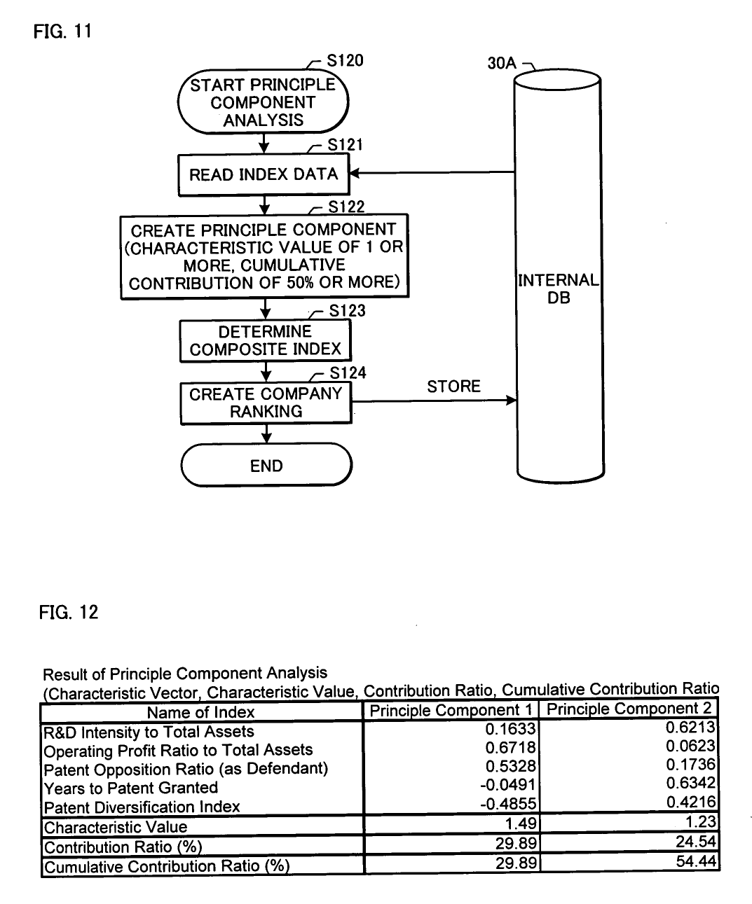

FIG. 11 is a flowchart representing the processing steps for performing principle component analysis. Here, principle component analysis is the method of analysis for extracting a component common to the observed variable and creating a synthesized variable. The purpose of performing the principle component analysis is to generalize the numerous existing indexes and create one or two comprehensive indexes, and to valuate companies to become the stock-for-portfolio candidate based on this comprehensive index.

When commencing the principle component analysis processing at step S120, index data is incorporated at step S121. In the embodiment of the present invention, the total assets R&D intensity, total assets operating profit ratio, ratio of oppositions filed (as defendant), years to patent granted (average) and patent diversification index are selected as the valuation indexes designated by the user. Incidentally, the indexes to be selected are not limited to the above, and arbitrary indexes may be set according to the purpose or nature of analysis.

Here, the total assets R&D intensity is the ratio in relation to the total assets of the total R&D cost in each year of the company. The total assets R&D intensity is used for measuring the scope of the R&D cost viewed from the company's asset stock. As a result of adding the total assets R&D intensity, in addition to intellectual assets, it will be possible to measure the degree of contribution of the comprehensive intellectual assets potentially possessed by companies. The total assets R&D intensity is calculated based on the calculation formula shown in Formula 2 below.
Total Assets R&D Intensity=R&D Cost/Total Assets (Formula 2)

Next, a total assets operating profit ratio is the ratio in relation to the total assets of the operating profit; that is, the accounting business profit obtained from the manufacturing/sales activities of the company of each year of the company. This is an index representing how much the total assets containing intellectual assets contributed to the profit. The total assets operating profit ratio is calculated with the calculation formula shown in Formula 3 below.
Total Assets Operating Profit Ratio=Operating Profit/Total Assets (Formula 3)

Next, the ratio of oppositions filed (as defendant) is the ratio of cases where a patent opposition or invalidation trial was filed against one patent in each year of the company. This is an index representing the quality of the patents acquired by the respective companies. In an embodiment of the present invention, the number of cases per one patent is used to eliminate the influence of the corporate size. The ratio of oppositions filed (as defendant) is calculated with the calculation formula shown in Formula 4 below.
Ratio of Oppositions Filed (as Defendant)=Number of Patents Subject to Oppositions or Invalidation Trials in Each Year/Number of Patents Granted to the Company in Same Year (Formula 4)

Next, years to patent granted (average) is an index representing the average number of years from filing to registration regarding a patent granted in each year of a company. As a result of employing the years to patent granted (average), it will be possible to know the purpose of the company acquiring the patent or the nature of the acquired patent. For example, an examination request is filed in a relatively short time in relation to strategic applications aiming for an early registration. Therefore, if the average number of years required from the filing to registration of a certain patent is short, it can be determined that it is highly likely of this patent being effectively utilized and producing results in business. The years to patent granted (average) is calculated with the calculation formula shown in Formula 5 below.
Years to Patent Granted (Average)=Σ(Patent Registration Date−Patent Filing Date)/Number of Patents Granted/Annual Number of Days (Formula 5)

Next, a patent diversification index is the composition ratio (share) of the number of claims filed by International Patent Classification (IPC) subclasses among the overall claims filed in the patent applications of each year of the company. As a result of employing the patent diversification index, it will be possible to measure the degree of concentration and diversification of the technical development field of the company. The patent diversification index is calculated with the calculation formula shown in Formula 6 below.
Patent Diversification Index=1−Σ(Claims Filed by International Patent Classifications of the Company/Total of Claims Filed of the Company)² (Formula 6)

After the indexes are selected, principle component analysis is performed for the purpose of creating a comprehensive index by combining the selected indexes. Foremost, at step S122, coefficient αᵢ of the linear combination for synthesizing the selected index xᵢ and principle component Z are calculated. Here, principle component Z is the quantity of information calculated based on coefficient αᵢ calculated such that the variance will become maximum. Specifically, in light of the linear combination of the selected index xᵢ, coefficient αᵢ of the respective indexes is determined such that the variance of such linear combination will become maximum. Here, in order to prevent the variance from diverging infinitely, the value of coefficient αᵢ is calculated so that the variance will become maximum under the restriction that the sum of squares of the coefficient is 1. Specifically, this is as shown in Formula 7 below.
Z=α₁x₁+α₂x₂+α₃x₃+ . . . +αₙxₙ (Constraint Condition) α₁²+ . . . +αₙ²=1 (Formula 7)

Based on Formula 7, coefficient αᵢ (i=1 . . . n) is calculated, and principle component Z is sought based on the calculated coefficient. The value of coefficient αᵢ (i=1 . . . n) is sought by calculating the characteristic value and characteristic vector of the linear combination of Formula 7 above with the variance-covariance matrix or correlation matrix. Here, the characteristic vector represents the coefficient, and the characteristic value represents the quantity of information containing the principle component.

Next, the principle component to be adopted is selected. In the principle component analysis, principle components are calculated to the number of variables. Further, with the principle component obtained from the principle component analysis, the larger the characteristic value, the larger the quantity of information. Thus, generally, principle components are in descending order of the quantity of information from principle component 1, principle component 2, principle component 3, . . . , principle component n. In an embodiment of the present invention, principle components where the characteristic value is 1 or more and the cumulative contribution ratio exceeds 50% are left. Needless to say, the threshold value is not limited to the above, and may be set arbitrarily according to the type or nature of analysis.

Here, the characteristic value being 1 or more means that the adopted principle component contains the quantity of information at least in the same amount as the average quantity of information held by the selected index. Further, a contribution ratio is a ratio representing to what degree the respective principle components are able to explain the overall index. The contribution ratio is calculated by dividing the characteristic value of the respective principle components by the sum of the characteristic values of all principle components. And, the cumulative contribution ratio is calculated by adding the contribution ratios of the respective principle components in deceasing order. The cumulative contribution ratio is a ratio representing to what degree the quantity of information of the overall index is able to explain the overall principle components adopted.

And, among the principle components where the characteristic value exceeds 1, the principle component in which the characteristic value is largest and the contribution ratio is largest will be the first principle component. Further, a principle component in which the characteristic value exceeds 1 and the cumulative contribution ratio is 50% or more is selected, and this will be the second principle component.

FIG. 12 is a list representing the characteristic vector and characteristic value of the principle component analysis, and the contribution ratio and cumulative contribution ratio. In an embodiment of the present invention, only the principle component in which the characteristic value exceeds 1 is extracted. According to the analysis, principle component 1, which is the first principle component, has a contribution ratio of 29% or more. Further, principle component 2, which is the second principle component, has a contribution ratio of 24% or more.

Next, the comprehensive index is determined at step S123. The numerical value (characteristic vector) calculated for each index in the list of FIG. 12 represents the value of the coefficient of each index. Foremost, with respect to principle component 1, the coefficient of “total assets R&D intensity”, “total assets operating profit ratio” and “ratio of oppositions filed (as defendant)” show positive, and the coefficient of “years to patent granted (average)” and “patent diversification index (average)” show negative. What is evident from this result is that even though the ratio in relation to the total assets of the R&D cost is average, companies in which the technology and patents are concentrated, number of years to registration is short, and the total assets operating profit ratio is high are valuated highly. In other words, principle component 1 represents the characteristics of a company that is concentrating its intellectual assets including patents to a single field. Based on this result, principle component 1 is determined as the comprehensive index representing the “intellectual assets concentration type”.

With principle component 2, the coefficient of all indexes is positive. What is evident from this result is that companies in which the technology and patents are diversified, number of years to registration is long, and the total assets operating profit ratio is low are valuated highly. In other words, principle component 2 represents the characteristics of companies seeking to expand the intellectual assets stock including patents. Based on this result, principle component 2 is determined as the comprehensive index representing the “intellectual assets diversification type”.

Next, at step S124, the total score of each company relating to principle component 1 and principle component 2 is calculated. The total score of each company is calculated based on the calculation formation shown with Formula 8 and Formula 9 below.
Z₁=0.1633×Total Assets R&D Intensity+0.6718×Total Assets Operating Profit Ratio+0.5328×Ratio of Oppositions Filed (as Defendant)−0.0491×Years to Patent Granted−0.4855×Patent Diversification Index (Formula 8)

In the formula, Z₁ is the principle component score of the “intellectual assets concentration type” of principle component 1, and the numerical values placed in front of the respective indexes are the values of the coefficient of the respective indexes in principle component 1 illustrated in FIG. 12.
Z₂=0.6213×Total Assets R&D Intensity+0.0623×Total Assets Operating Profit Ratio+0.1736×Ratio of Oppositions Filed (as Defendant)+0.6342×Years to Patent Granted+0.4216×Patent Diversification Index (Formula 9)

In the formula, Z₂ is the principle component score of the “intellectual assets diversification type” of principle component 2, and the numerical values placed in front of the respective indexes are the values of the coefficient of the respective indexes in principle component 2 illustrated in FIG. 12.

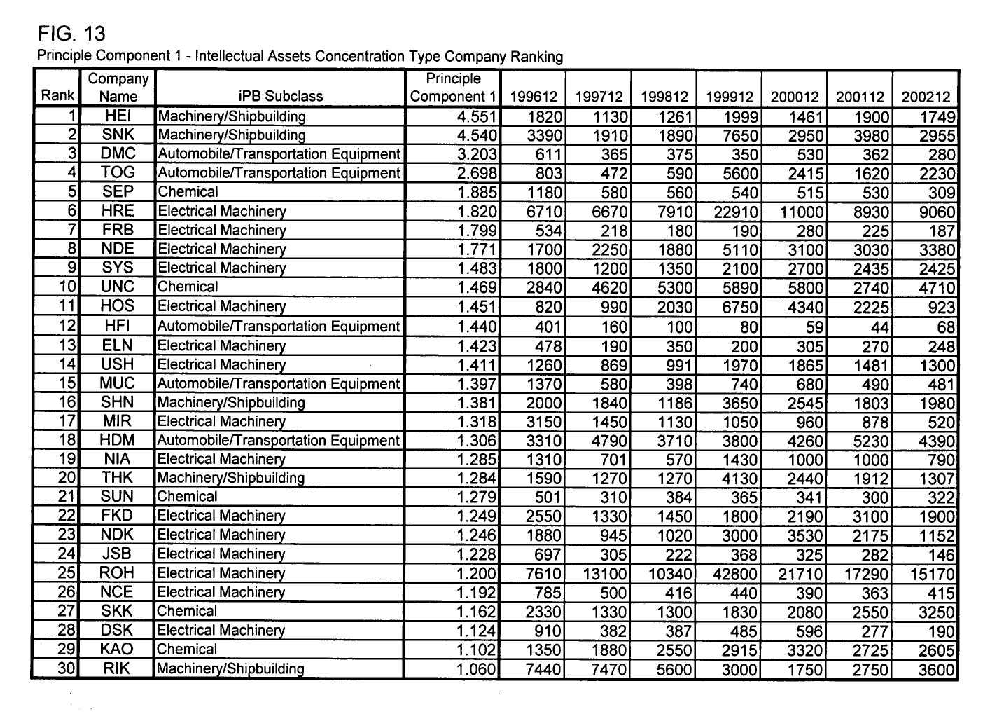

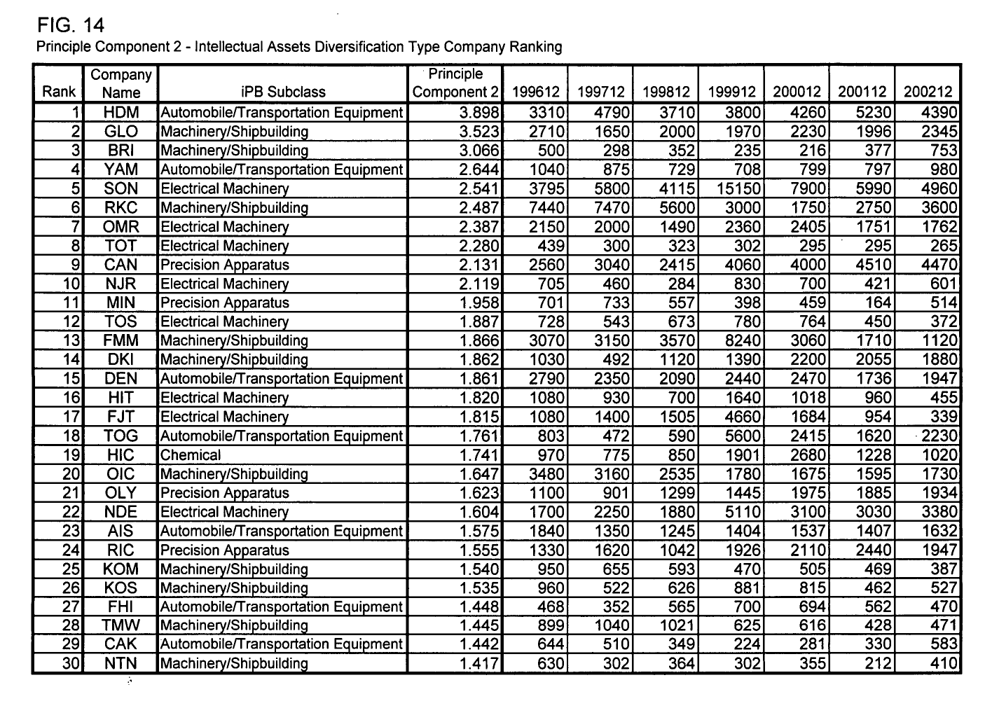

FIG. 13 is a ranking chart of the corporate valuation corresponding to the “intellectual assets concentration type” of principle component 1, and FIG. 14 is a ranking chart of the corporate valuation corresponding to the “intellectual assets diversification type” of principle component 2.

(2-2-2. Factor Analysis and Multiple Regression Analysis before Principle Component Analysis)

(2-2-2-1. Factor Analysis)

Returning once again to the flowchart of FIG. 3 representing the processing steps of the stock portfolio selection, the steps are resumed. Foremost, at step S7, when it is determined that an index is not to be selected, at step S9, whether covariance structure analysis, or factor analysis and multiple regression analysis are to be performed as the method of analysis is determined. At step S9, when the user inputs instructions for performing factor analysis and multiple regression analysis, the routine proceeds to step S10, and performs factor analysis.

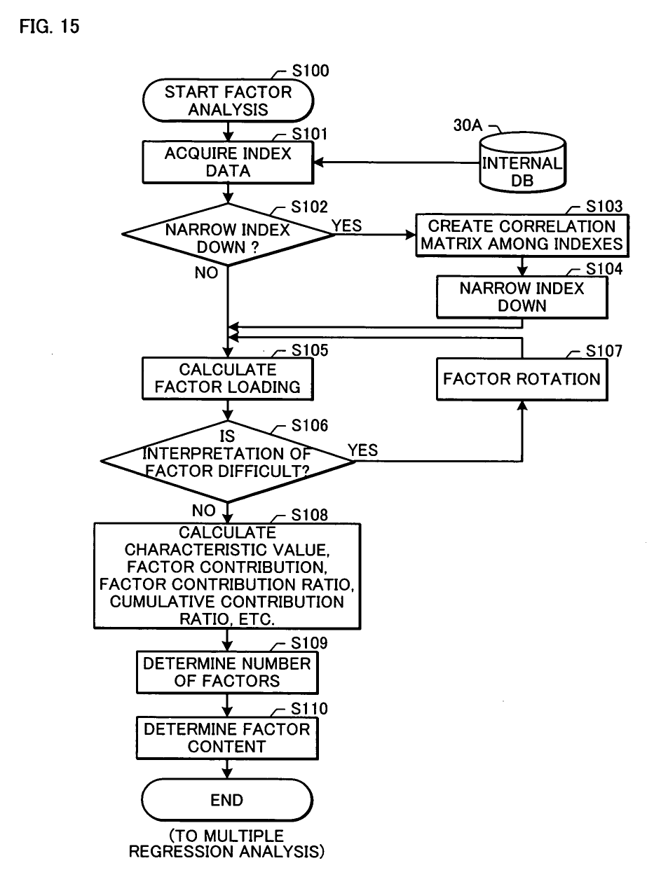

Here, factor analysis processing is explained with reference to the flowchart of FIG. 15. Factor analysis is the method of searching for a common factor hiding behind a certain observation data and which prescribes the same. The purpose of performing factor analysis is to clarify the characteristics and structure of the indexes by clarifying the potential factors prescribing such various indexes, and uniting these indexes into the clarified factors.

Foremost, at step S100, factor analysis processing is commenced, and, at step S101, data concerning the index is acquired from the internal database 30A. Nevertheless, the profit related index contained in the business/management related index of FIG. 4 and FIG. 5 will be excluded. This is because the profit related indexes will be used as the target variable in the multiple regression analysis described later.

Next, at step S102, whether the narrowing down of indexes is determined. When the user inputs instructions for narrowing down of the indexes, at step S103, the correlation matrix of each index is calculated. And, at step S104, remotely related indexes without any commonality are removed, and deeply related and strongly associated indexes are extracted. Thereafter, the routine proceeds to the calculation of factor loading at step S105.

When the narrowing down of indexes is not performed in advance at step S102, the routine proceeds directly to the calculation of factor loading at step S105. Here, factor loading is the value showing the strength of influence against the observed variable of the factor. In the factor analysis, the primary objective is to calculate this factor loading. As the calculation method of this factor loading, a principal factor method or maximum likelihood method, least square method, generalized least square method and the like are known. In an embodiment of the present invention, the principal factor method is employed. The principal factor method is a method of calculating the factor loading in order from the first factor such that the factor contribution of the respective factors will become maximum. Incidentally, the calculation method of the factor loading may be arbitrarily selected according to the objective or nature of the observation.

Next, at step S106, whether it is difficult to interpret the factors based on the calculated factor loading is determined. When the user determines that it is difficult to interpret the factors and makes an input to such effect, factor rotation is performed at step S107 in order to search for the solution capable of optimally interpreting the data. The method of rotation may be an orthogonal rotation or an oblique rotation, and this may be arbitrarily selected according to the objective and nature of the observation. In an embodiment of the present invention, Varimax rotation, which is a type of orthogonal rotation, is employed. Varimax rotation is a rotation method of rotating the factors such that those with the factor loading of each factor closest to 0 and those with a large absolute value will increase, and thereby searching for the degree of contribution of the factor. And, after the factor rotation, the routine returns to step S105 and calculates the rotated factor loading. Incidentally, at step S106, when it is determined that it is not difficult to interpret the factors, factor rotation is not performed, and the initial solution of the calculated factor loading is used without change.

Next, at step S108, the characteristic value, factor contribution, factor contribution ratio and cumulative contribution ratio of each factor is calculated based on the calculated factor loading. A characteristic value is the numerical value output when calculating the initial solution of the factor loading. The characteristic value is calculated for each factor as though there is the same number of factors as the number of indexes. As a result, an arbitrary minimum characteristic value will be selected as the criterion for determining the number of factors to be adopted. Further, factor contribution is an amount of a certain factor capable of explaining the data, and is calculated for each factor based on the sum of squares of the factor loading of each index. Incidentally, at the point in time of calculating the initial solution of the factor loading, the characteristic value and the factor contribution value are the same. Further, a factor contribution ratio is the ratio of a certain factor that explains the overall data, and is calculated by dividing the factor contribution by the number of indexes. Finally, a cumulative contribution ratio is a value in which the factor contribution is accumulated pursuant to the increase of factors, and is an index showing up to how many factors are able to explain data to what degree.

Next, at step S109, the number of factors is determined based on the calculated characteristic value, factor contribution and cumulative contribution ratio. Theoretically, the number of factors is represented for the number of indexes. Thus, in an embodiment of the present invention, as the criterion upon determining the number of factors, a judgment criterion in which the characteristic value is 1 or more and the cumulative contribution ratio is 70% or more is used. As a result, 5 factors are selected in an embodiment of the present invention.

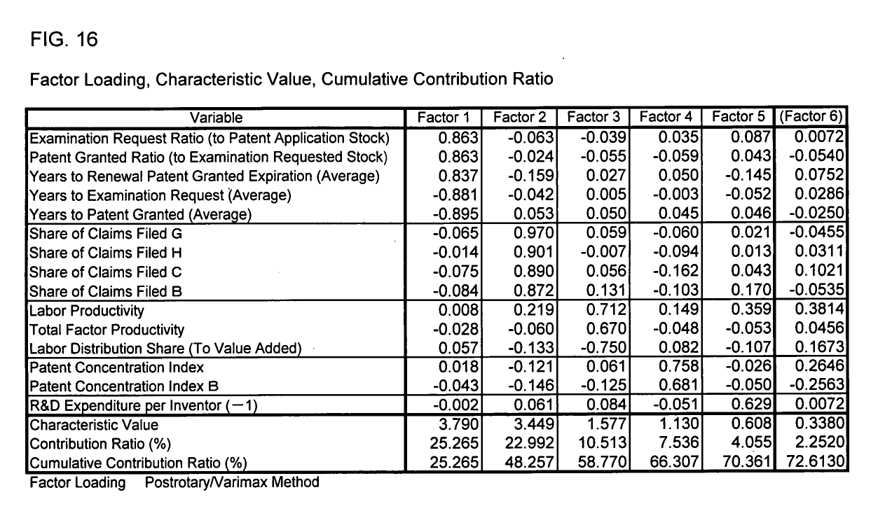

FIG. 16 is a list showing the factor loading, characteristic value, factor contribution and cumulative contribution ratio of the 5 factors selected in an embodiment of the present invention. Incidentally, the judgment criterion is not limited to the above, and this may be arbitrarily set according to the objective and nature of the observance.

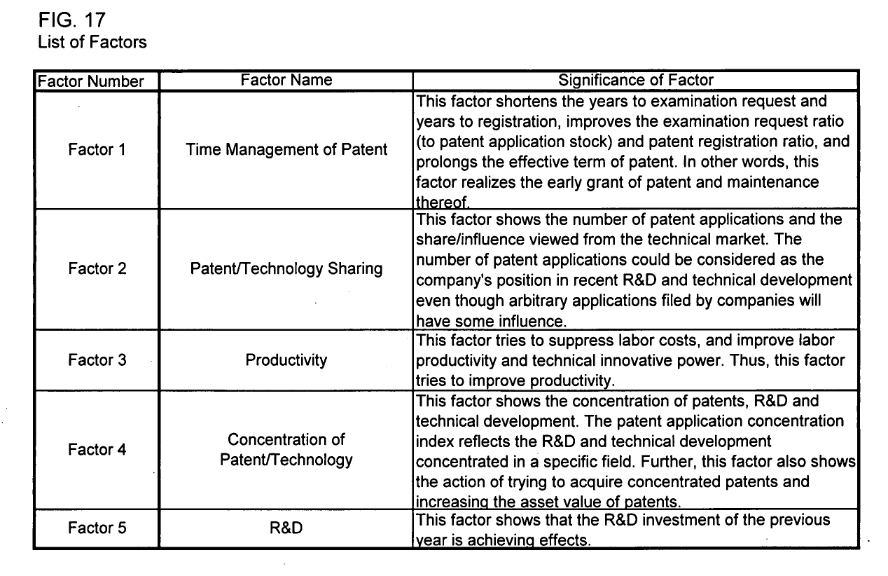

Next, at step S110, the factor content is determined. Specifically, the significance of the 5 factors selected at step S109 is interpreted based on the factor loading calculated for each index regarding factors 1 to 5. Explanation on the significance and factor name of each of the factors 1 to 5 is as per the list of FIG. 17.

Foremost, when viewing factor 1, among the index constituting factor 1, it is evident that the indexes having a large factor loading are the following 5 indexes; namely, the examination request ratio (to patent application stock), patent granted ratio (to application stock), years to renewal patent granted expiration (average), years to examination request (average), and years to patent granted (average). When interpreting the significance of factor 1 from the above, it could be said that factor 1 is a factor that improves the examination request ratio (to patent application stock) and patent granted ratio (to examination requested stock) by shortening the years to examination request and years to patent granted, and thereby prolongs the effective term of the patent. In other words, factor 1 can be interpreted to be a factor that quickly acquires and maintains a patent right. Based on this interpretation result, the factor name of factor 1 will be called “patent time management”.

Similarly, the significance and factor name of the respective factors are also determined according to the foregoing procedures for factor 2 to factor 5 as well. Although the explanation is omitted to avoid redundancy, details are as per the list of FIG. 17. Incidentally, the definition and calculation method of the respective indexes shall be as per the lists of FIG. 4 to FIG. 9.

(2-2-2-2. Multiple Regression Analysis)

Returning once again to the flowchart of FIG. 3 representing the processing steps of the stock portfolio selection, after performing the factor analysis at step S10, multiple regression analysis processing is performed at step S11. The multiple regression analysis processing is now explained.

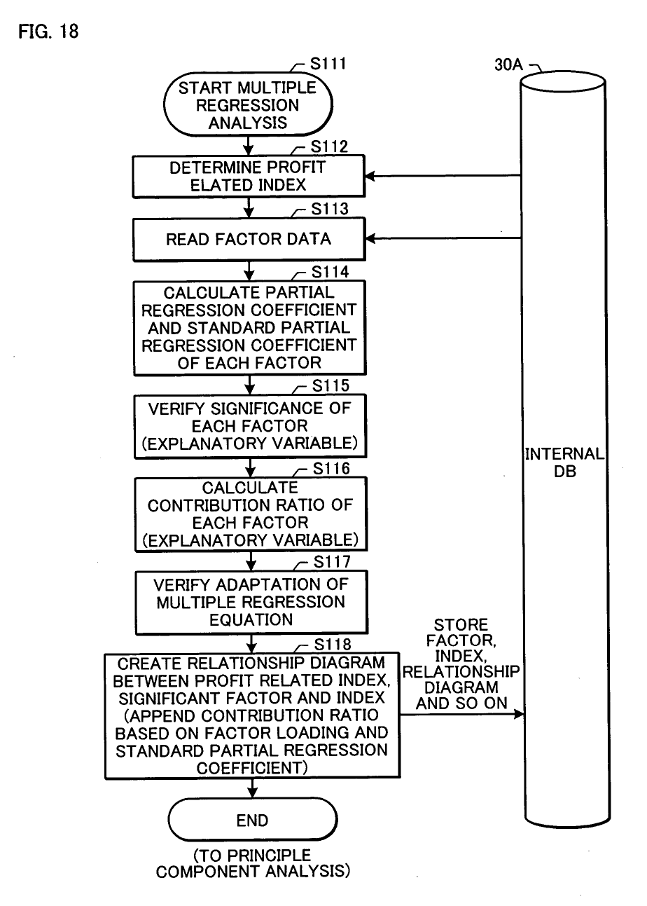

FIG. 18 is a flowchart representing the processing steps of the multiple regression analysis. Here, multiple regression analysis is a method of analyzing to what degree the value of the target variable can be explained based on the prediction relation constituted from such target variable and a plurality of explanatory variables. Incidentally, a target variable and explanatory variable are sometimes set as a dependent variable and independent variable according to the objective of analysis.

The purpose of performing multiple regression analysis is to verify whether the 5 factors clarified as a result of the foregoing factor analysis are actually contributing to the profit increase of the company. Further, among the above, it also specifies the factors with a high contribution ratio in relation to the profit and which indexes constitute such factors.

At step S111, multiple regression analysis processing is performed. Foremost, at step S112, the profit related index data is loaded from the list of the profit related index data stored in the internal database 30A, and the profit related index to be the target variable is determined. An example of the type and definition of the profit related index data is as per the profit related index list contained in the business/management related index of FIG. 4 and FIG. 5. Incidentally, the profit related index shown in FIG. 4 and FIG. 5 is primarily related to the business performance and results of the company, but the profit related index is not limited to the above, and arbitrary indexes may be set according to the objective or nature of analysis.

In an embodiment of the present invention, the profit related index is represented with an ROA. ROA is the abbreviation of Return On Asset, and this is also referred to as the total assets profit ratio. ROA is the ratio obtained by dividing the current profit by the total assets, and is an index for measuring how much profit was gained from the total assets. The reason the index for comprehensively valuating the business performance of companies is represented with ROA is because ROA is an appropriate achievement index for representing the annual assets efficiency of a company. Although there is a similar index referred to as ROE (Return On Equity), ROE is not adopted in an embodiment of the present invention. The reason for this is because ROE is used for measuring the profit per equity capital, and, in order to the company to actually gain profit, it must utilize outside capital in addition to the equity capital, and it has been determined that it is difficult to measure the true assets efficiency of companies with ROE.

Further, in an embodiment of the present invention, instead of ordinary ROA, a total assets ratio of an amount obtained by adding the “operating profit” and “patent royalty income” in each year of the respective companies (hereinafter referred to as “ROA δ”) is set as the target variable. The calculation formula of ROA δ is as shown in Formula 10 below.
ROA δ=(Operating Profit+Patent Royalty Income)/Total Assets (Formula 10)

The reason ROA δ is used as the target variable is, firstly, because intellectual assets such as patents are a part of the assets owned by the company, and it is an index suitable for measuring how much profit was gained by utilizing tangible assets and intellectual assets such as patents. Secondly, in order to appropriately valuate the potential competitive power of companies and to measure to what degree such potential competitive power is connected to the overt competitive power and profit, it is necessary to incorporate the profits from intellectual assets such as patents generated as a result of R&D. Incidentally, the patent royalty income is recorded as non-operating income in terms of accounting, but some companies may not have such account title in the non-operating profit. In such a case, the patent royalty income is not added to the operating profit as it will be determined to be already incorporated in the operating profit, or not indicated since it is an amount that will not significantly influence the financial statements.

Next, at step S113, the 5 factors extracted as a result of the factor analysis performed at step S10 are read from the internal database 30A. In an embodiment of the present invention, as shown in FIG. 19, the 5 factors of factor 1 (patent time management), factor 2 (productivity), factor 3 (patent/technology share), factor 4 (R&D), and factor 5 (concentration of patent/technology) are adopted.

Next, at step S114, the profit related index ROA δ is made the target variable, and foregoing factors 1 to 5 are made the explanatory variables upon performing multiple regression analysis, and the partial regression coefficient, standard partial regression coefficient, and t value of the respective factors (explanatory variables) are calculated.

Specifically, foremost, the multiple regression equation represented with Formula 11 below is hypothesized for calculating the value of the ROA δ (target variable) with the information of the respective factors (explanatory variables).
Yⱼ=α+β₁x₁ⱼ+β₂x₂ⱼ+ . . . +β₅x₅ⱼ+ε_{j (j=}1 . . . N) (Formula 11)

In the foregoing formula, Yⱼ is the target variable, and xᵢⱼ (i=1 . . . 5) is the explanatory variable. Further, α and βᵢ (i=1 . . . 5) are parameters to be estimated from the observation data of the explanatory variable xᵢⱼ, α is the constant term, and βᵢ is the partial regression coefficient. εⱼ (j=1 . . . N. N represents number of samples) is the residual of the observed value of target variable Yⱼ and the theoretical value, and represents portions that are not explained with the explanatory variable xᵢⱼ. Incidentally, with respect to explanatory variable xᵢⱼ, since appropriate analysis is performed upon eliminating the influence of the difference among indexes relating to the unit or scale of indexes, it is desirable to use standardized data. The standardization of data is performed with foregoing Formula 1.

Next, the values of constant term α and partial regression coefficient βᵢ contained in Formula 11 are calculated with the estimation method referred to as the least square method. The least square method is a method of minimizing the sum of squares of the residual of the observed value and theoretical value. In the case of Formula 11 above, foremost, when the value of explanatory variable xᵢⱼ is provided, the theoretical value of target variable Yⱼ will be α+Σᵢ₌₁⁵(βᵢxᵢⱼ), and, therefore, residual εⱼ, which is the difference between the theoretical value and observed value, will be calculated with Formula 12 below.
εⱼ=Yⱼ−{α+Σᵢ₌₁⁵(βᵢxᵢⱼ)} (Formula 12)

Next, the sum of squares of the residual is calculated with Formula 13 below.
Q=Σⱼ₌₁^{N}[{Yⱼ−αΣᵢ₌₁⁵(βᵢxᵢⱼ)}²] (Formula 13)

In the foregoing formula, Q is the value calculated as the sum of squares of the residual. Since the least square method is a method of minimizing the sum of squares of the residual, it is necessary to minimize the value of Q in Formula 13 in order to calculate constant term α and partial regression coefficient βᵢ. And, the values of constant term α and partial regression coefficient βᵢ are sought by performing partial differentiation to Formula 13 above respectively with α and βᵢ, and solving the simultaneous equations equaling 0. Specifically, this is as per Formula 14 and Formula 15 below.
∂Q/∂α=−2Σⱼ₌₁^{N}{Yⱼ−α−Σᵢ₌₌₁⁵(βᵢxᵢⱼ)}=0 (Formula 14)
∂Q/∂βᵢ=−2Σⱼ₌₁^{N}[xᵢⱼ{Yⱼ−α−Σᵢ₌₁⁵(βᵢxᵢⱼ)}]=0 (Formula 15)

Incidentally, the value of the partial regression coefficient will change significantly when the unit or scale of the explanatory variable is changed. Accordingly, in an embodiment of the present invention, pursuant to the standardization of data of the index to be used in explanatory variable xᵢⱼ, it is necessary to separately calculate the partial regression coefficient corresponding to the standardized explanatory variable (hereinafter referred to as the “standard partial regression coefficient”)

After calculating the partial regression coefficient (and standard partial regression coefficient) βᵢ, at step S115, the significance of the respective factors used in explanatory variable xᵢⱼ is verified. Specifically, foremost, a hypothesis that explanatory variable xᵢⱼ is absolutely ineffective in the prediction of target variable Yⱼ (hereinafter referred to as the “null hypothesis”). This null hypothesis is represented by the partial regression coefficient (and standard partial regression coefficient) βᵢ being 0. Incidentally, as the hypothesis to be used for verification, in addition to this null hypothesis, there is an alternate hypothesis of performing verification on the premise that the explanatory variable is effective in the prediction of the target variable. Any of these hypotheses may be used according to the objective and nature of analysis. Further, verification based on both of these hypotheses may be conducted, and one of such hypotheses may be adopted.

Next, in order to verify whether the hypothesis of partial regression coefficient (and standard partial regression coefficient) βᵢ=0, t value is calculated based on βᵢ=0. t value is the numerical value showing the statistical reliability of the value of the calculated explanatory variable.

After the calculation of t value, the position occupied by the calculated t value on the t distribution is specified. Here, t distribution is a probability density variable for estimating the scope of the average value of the parent population from a certain finite number of sample data.

Next, a boundary line for determining whether to adopt or reject the hypothesis of βᵢ=0 is set on the t distribution. This boundary line is referred to as the significant level. A significant level is represented based on the probability of the calculated t value occurring on the t distribution. In an embodiment of the present invention, the significant level is set to 5%. This shows that the hypothesis will be rejected when the probability of the calculated t value occurring on the t distribution is within the range of 5%. The area for accepting the hypothesis with this significant level as the criterion is referred to as the adopted area, and the area for rejecting the hypothesis is referred to as the rejected area.

Then, as a result of the verification, if it is specified that the t value calculated based on the hypothesis of βᵢ=0 occupies the position within the significant level of 5%, the hypothesis of βᵢ=0 will be rejected. In other words, here, partial regression coefficient βᵢ pertaining to explanatory variable xᵢⱼ is statistically significant, and it is determined that the factors employed in explanatory variable xᵢⱼ are contributing to the explanation of target variable Yⱼ. Incidentally, the criteria for determining the significance of the explanatory variable is not limited to only the t value, and this may be determined with the p value which represents the probability of the t value exceeding the significant level with an absolute value.

Next, at step S116, the contribution ratio in relation to target variable Yⱼ of the respective factors (explanatory variables) is calculated. The contribution ratio is calculated by dividing the standard partial regression coefficient of the respective factors calculated at step S114 by the total standard partial regression coefficients of the respective factors. And, thereafter, the calculated value is displayed as a percentage.

Finally, at step S117, the adaptation of the multiple regression equation employing the analysis according to an embodiment of the present invention is verified. The determination coefficient is used as the scale for verifying the adaptation of the multiple regression equation. A determination coefficient is an index representing to what degree of the provided multiple regression equation is able to explain the fluctuation of the observed value of the target variable. Here, fluctuation is the variation from the average value of the respective points. The determination coefficient is represented with R², and is calculated by dividing the fluctuation of the theoretical value of target variable Yⱼ derived from the multiple regression equation by the fluctuation of the observed value of Yⱼ. Specifically, this is as per Formula 16 below.
Determination Coefficient R²=Fluctuation of Theoretical Value of Yⱼ/Fluctuation of Observed Value of Yⱼ (Formula 16)

Nevertheless, the value of determination coefficient R² representing the adaptation of the multiple regression equation will increase pursuant to the increase of the explanatory variable. Although this appears to apply favorably, this does not necessarily mean that the power of explanation of the multiple regression equation is high. Thus, in order to supplement the defect of this determination coefficient R², the adaptation of the multiple regression equation is verified with determination coefficient R^{2′} of a corrected degree of freedom. Determination coefficient R^{2′} flexibility corrected is a value obtained by giving consideration not only to the explanatory variable for determining the multiple regression equation, but also to the number of variables output as samples, and thereby adjusting the determination coefficient R². Further, the flexibility (degree of freedom) is a value obtained by subtracting the average value calculated from the sample from the number of samples. For instance, when the number of samples is N, if one average value is determined, the final sample among the N samples will be automatically determined, and the value that may be freely selected among the output samples will be N−1 samples.

FIG. 19 is a list of the multiple regression analysis. The list is constituted from the values of the partial regression coefficient, standard partial regression coefficient, t value and contribution ratio calculated for each of the 5 factors that are extracted.

Foremost, the adaptation of the multiple regression equation adopted upon performing the analysis is viewed. Determination coefficient R^{2′} flexibility corrected is 0.7572, and this shows that that adopted multiple regression equation has a high degree of explanation.

Next, whether each of the factors is statistically significant is viewed. According to the calculation result of t value, it is evident that factor 3 (productivity), factor 4 (concentration of patent/technology) and factor 5 (R&D) are statistically significant. In addition, the foregoing factors are statistically significant even when verified at a significant level of 1%.

And, at step S118, based on the foregoing analysis, a relationship diagram showing the relation of the profit related index ROA δ and factors showing the statistical significance, and the relationship of these factors and the various indexes constituting such factors is created. The created relationship diagram is stored in the internal database 30A.

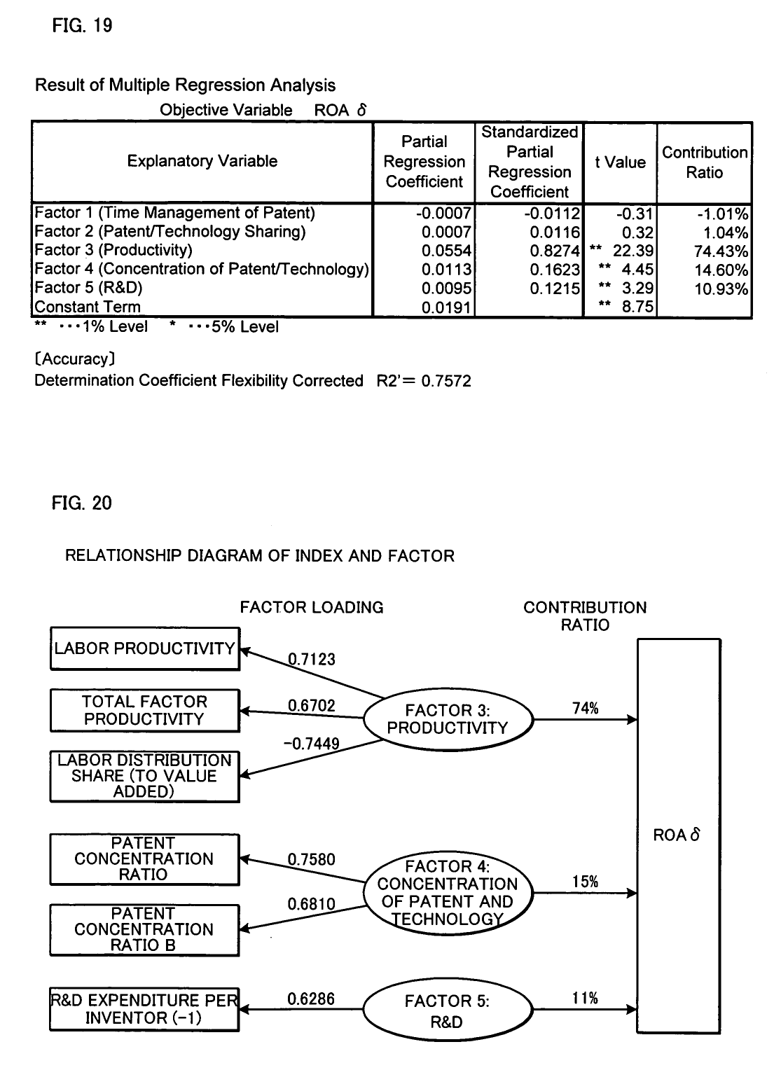

FIG. 20 shows the created relationship diagram. In this relationship diagram, ROA δ, factors showing statistical significance, and indexes constituting the respective factors are shown, and the contribution ratio and factor loading based on the standard partial regression coefficient are indicated above the arrows. According to this relationship diagram, with respect to the contribution ratio of factors in relation to ROA δ, it is evident that factor 3 (productivity) is dominant at 74%. Further, among the indexes constituting factor 3 (productivity), it is evident that “labor distribution share (to value added)” works to lower the productivity. Accordingly, in order to improve the productivity, it is necessary to suppress “labor distribution share (to value added)” to a certain degree, and to seek the promotion of technical innovation shown in “total factor productivity” and improvement of the management efficiency.

Further, factor 4 (concentration of patent/technology) has the next highest contribution ratio in relation to ROA δ at 15% after factor 3 (productivity). Further, as indexes constituting factor 4 (concentration of patent/technology), it is evident that the factor loading of the index relating to “patent concentration index” is significant. This fact, for example, is considered to be based on the fact that the “patent application concentration index” is reflecting the selection of technical development and degree of progress of concentration. Further, the factor loading of “patent concentration index” in relation to factor 4 (concentration of patent/technology) being large means that increasing the “patent application concentration index” will prevent imitations by other companies and improve the asset value of patents, which will contribute significantly to profits.

And, factor 5 (R&D) is showing the third highest contribution ratio in relation to ROA δ at 11%. Further, the highest factor loading among the indexes constituting factor 5 (R&D) is “R&D investment of previous term”. This result not only represents the achievement of the R&D cost of the previous term, it is considered that the ongoing R&D for many years is being reflected in current term ROA δ as achievements. Moreover, this result shows that improving the cost effectiveness of R&D costs such as shortening the period from R&D to commercialization and merchandizing, and early collection of the R&D costs will lead to increased profits of the company.

According to the foregoing analysis, it is evident that engagements by the company in promoting R&D, increasing the efficiency thereof, and simultaneously improving the business productivity will contribute to increased profits. Further, at the same time, the approach of promoting the “selection and concentration” of technical/intellectual assets will also contribute to increased profits. And, these engagements by companies will be represented as figures in the indexes constituting the respective factors.

(2-2-2-3. Principle Component Analysis)

Returning once again to the flowchart of FIG. 3 representing the processing steps of stock portfolio selection, after performing multiple regression analysis at step S11, principle component analysis processing is performed at step S12. In principle component analysis, corporate valuation is performed upon creating a comprehensive index with the indexes constituting the significant factors obtained as a result of the multiple regression analysis, and ROA δ set in the target variable. Incidentally, the processing method of principle component analysis is as described above, and the explanation thereof is omitted.

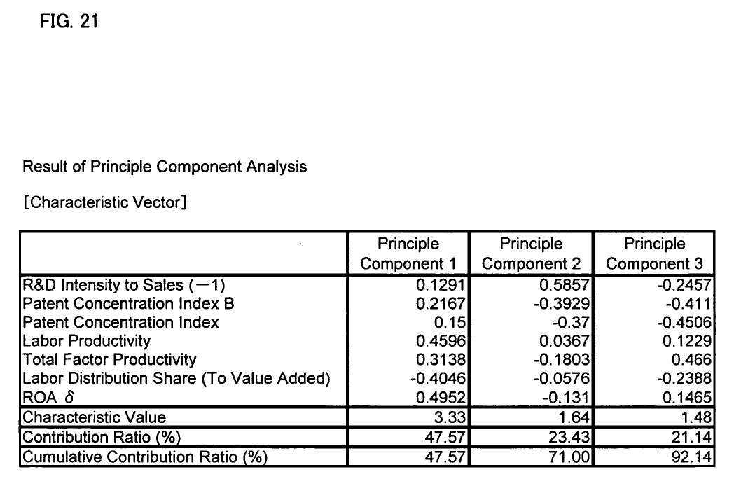

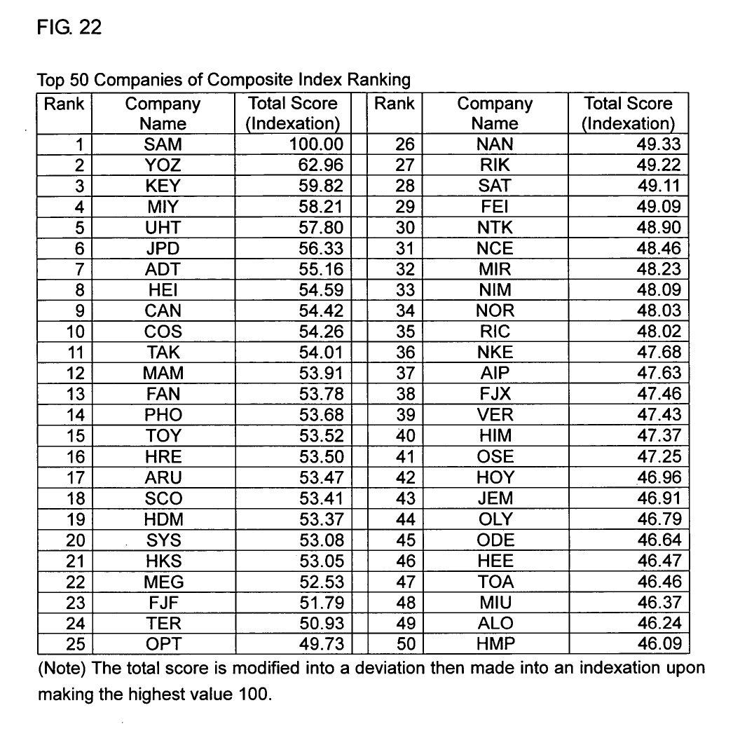

FIG. 21 is a list representing the characteristic vector and characteristic value of the principle component analysis, and the contribution ratio and cumulative contribution ratio. The contribution ratio of the first principle component is sufficiently high at 47.57%, and is also consistent with the results of the factor analysis and multiple regression analysis. Further, since it has no gap in the absolute value of the coefficient pertaining to the indexes as with the second and third principle components, principle component 1 as the first principle component can be selected as the comprehensive index. FIG. 22 is a ranking chart of the corporate valuation corresponding to principle component 1.

(2-2-3. Covariance Structure Analysis)

Returning once again to the flowchart of FIG. 3 representing the processing steps of stock portfolio selection, when the covariance structure analysis is selected at step S9, covariance structure analysis processing is performed at step S19 so as to conduct corporate valuation, and the company ranking is created at step S13.

The processing steps of covariance structure analysis are now explained. Here, covariance structure analysis is a method of comprehending the complex causal relation between a potential variable (constructive concept) which is an unobservable element and an observed variable (actual numerical value) which is an observable element, or between potential variables, with a quantitative model, and valuating the ranking and the like based on such comprehended model. Thereupon, a path diagram may be used to enable the visual analysis of the relationship of the observed variable and potential variable.

As the basic procedure, foremost, a hypothesis on the causal relation between the variables is established. When the relationship between developments is well known, a hypothetical model is created directly. When the relationship between developments is not well known, a hypothetical model is created after extracting a factor based on factor analysis.

Next, a path diagram is created based on the hypothetical model. And, according to the path diagram, the population parameter is estimated. Here, a population parameter is a parameter showing the numerical value representing the situation of the parent population distribution. As the estimation method of the population parameter, generally, the least square method or maximum likelihood estimation method is employed. Thereafter, the relationship between the variables representing the path diagram is actually digitized so as to match the sample data as much as possible.

Next, whether the created hypothetical model coincides with the data is verified. As the index of reference for verifying the hypothetical model, a statistic referred to as the adaptation index (GFI: Goodness of Fit Index or AGFI: Adjusted Goodness of Fit Index) is used. GFI is used as the criterion of “power of explanation” of the model regarding how much the hypothetical model created by the analyzer is able to explain the data. And, closer the value of GFI is to 1, the fitting of the hypothetical model is determined to be favorable. Incidentally, in the case of a complicated model, with GFI, the stability of the estimated value of the population parameter will become inferior. In such a case, the adaptation of the model will be verified with AGFI as the index, which removes the instability of the population parameter from GFI's power of explanation. If the hypothetical model does not coincide with the data as a result of verifying the hypothetical model, the routine returns to the creation of a model diagram, and repeats the estimation of the population parameter.

In an embodiment of the present invention, an intellectual property strategy management (triune management) model is created as the hypothetical model. Here, an intellectual property strategy management (triune management) model is a model for inclusively and comprehensively valuating companies that are associating business strategy, R&D strategy and intellectual property strategy so as to improve the total factor productivity and corporate value. Upon valuating companies, although it is extremely important to analyze the productivity index such as labor productivity and profit related index such as ROA, ROE, valuating the value of companies with only these indexes may lead management in the wrong direction. This is because these indexes merely show a cross section of the current business performance of corporate management. In fact, in order to improve corporate value, companies will depend significantly on intellectual assets including intellectual assets such as technology and know-how created by R&D investment and the like. In light of the above, in corporate valuation, the analysis and valuation of R&D and intellectual property are essential. This is the reason for creating such intellectual property strategy management (triune management) model. Thus, in an embodiment of the present invention, the relationship (correlation) of three potential variables (constructive concept) of “R&D”—“intellectual property”—“business (management/finance) is hypothesized.

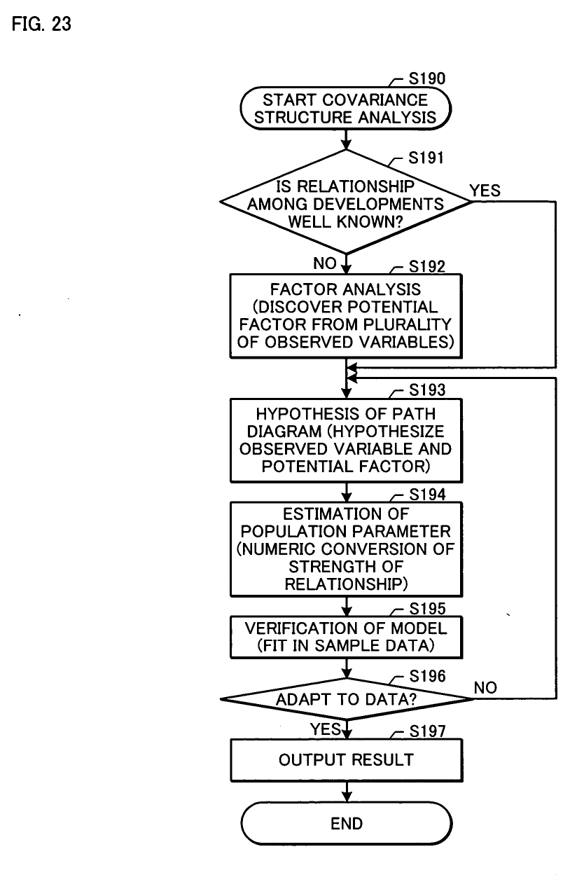

The processing steps of covariance structure analysis are now explained with reference to the flowchart of FIG. 23. When covariance structure analysis is commenced at step S190, whether the “relationship between developments is well known” is determined at step S191. Here, when the user makes in input to the effect that the causal relation between the observed variable and potential variable is known, the routine proceeds to “hypothesize path diagram” at step S193.

When the causal relation between the observed variable and potential variable is not known in the determination at step S191, the routine proceeds to the “factor analysis” processing at step S192. At step S192, in order to discover a potential variable from a plurality of observed variables, a factor is extracted based on factor analysis so as to create a hypothetical model. Incidentally, determination of the number of factors based on factor analysis is conducted based on the preset cumulative contribution ratio and characteristic value. In an embodiment of the present invention, factors are determined with a criterion where the cumulative contribution ratio is 70% or more, and the characteristic value is 1 or more. Incidentally, the judgment criterion is not limited to the above, and this may be arbitrarily set according to the objective and nature of observation.

Next, in the hypothesis of the path diagram at step S193, a hypothesis regarding the relationship of the observed variable and potential variable is created. Next, at the “estimation of population parameter” at step S194, estimation of the population parameter; that is, the strength of relationship of the observed variable and potential variable is estimated. Estimation of the population parameter is conducted by actually digitizing the relationship of the observed variable and potential variable represented in the path diagram so as to coincide with the sample data as much as possible.

Next, in the “verification of model” at step S195, the hypothetical model is verified. As a result of this verification, if it is determined at step S196 the hypothetical model does not coincide with the data, the routine returns to “estimation of path diagram” at step S193 to recreate the hypothetical model, and performs the “estimation of population parameter” at step S194 once again.

After the “verification of model” at step S195, if it is determined that the hypothetical model coincides with the data at step S196, the result is output at step S197, and the routine is ended thereby. And, the routine returns to FIG. 3, and creates the “company ranking” at step S13.

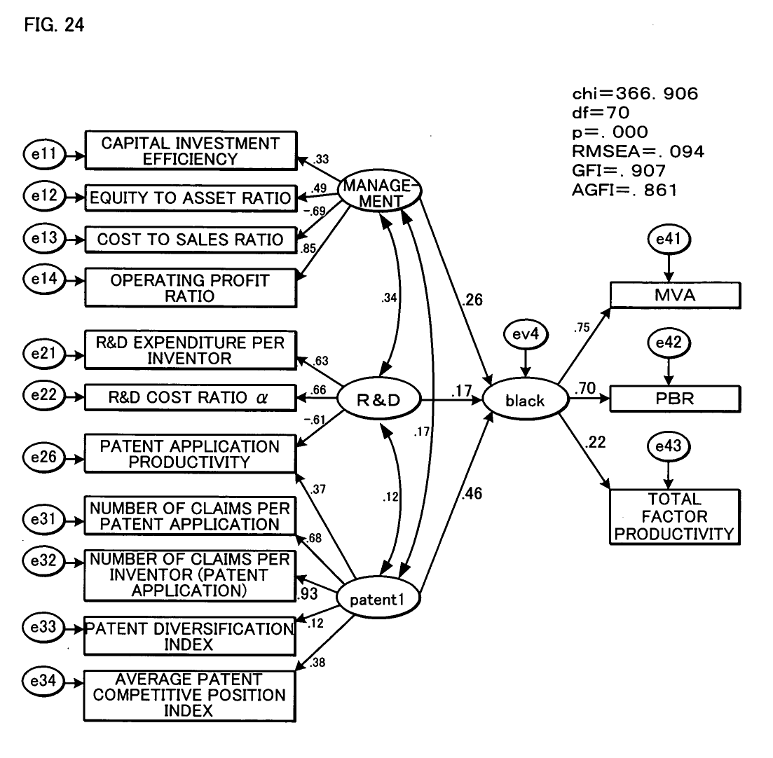

FIG. 24 is an example of the path diagram representing the results of the covariance structure analysis for valuating the intellectual property strategic management company. The path diagram shown in FIG. 24 is used for representing the results after creating the hypothesis and verifying the hypothetical model a few times.

As evident from the drawings, the intellectual property strategic management model shows a structure where the three strategies of “financial/profitability” factor (management), “patent strategy” factor (patent) and “R&D investment” factor (R&D) are associated. As a result of valuating this “intellectual property strategic management company” (black) based on this model, with respect to the influence (contribution ratio) in relation to the “intellectual property strategic management company” model (black), it is clear that the “financial/profitability” factor is roughly 26%, “R&D investment” factor (R&D) is roughly 17%, and “patent strategy” factor is 46%. Further, when viewing the coefficient of correlation between the factors, “financial/profitability”—“patent strategy” is 0.17, “patent strategy”—“R&D investment” is 0.12, and “R&D investment”—“finance/profitability” is 0.34, and each of these shows a weak relationship.

Further, there are 3 indexes that are valuating the “intellectual property strategic management company” from the outside; namely, “MVA (difference between the aggregate market price and stockholders' equity)”, “PBR (price book value ratio)┘(market valuation index), and “total factor productivity”. Here, the “intellectual property strategic management company” is set as a potential factor existing between these 3 external indexes and the “finance/profitability” factor, “R&D investment” factor, and “patent application strategy” factor. The reason a market valuation index is used as the external valuation index is because market price that is greater than the book price corresponds to the valuation in relation to off-balance intellectual assets such as know-how and intellectual property of the respective companies. Contrarily, if the market price is lower than the book value, the market will consider that the company hardly has any off-balance intellectual assets, or is not capable of utilizing this as the source of profit.

Nevertheless, there are restrictions to the intellectual asset valuation obtained from the market valuation index. This is because the market price will rise or fall wrongfully due to the macro economic environment or asymmetry of information existing between the company and market, noises unrelated to the valuation of intellectual assets are contained therein. Thus, in addition to the market valuation index, “total factor productivity” is used as an external index for valuating the “intellectual property strategy management”. Here, the “total factor productivity” is an index for measuring the “technical progress ratio” and which can be obtained by subtracting the rate of change of “facilities” and “workforce” from the rate of change of the “value added amount” in each year of the respective companies.

In an embodiment of the present invention, the “intellectual property strategic management company” has been defined as a structure having an unknown potential factor existing between the three factors of business, R&D and intellectual property and the external valuation indexes of MVA, PBR and total factor productivity. Thereupon, a model is created by selecting and determining indexes that fit the most with such structure among all indexes described in FIG. 4 to FIG. 9. Indexes constituting the respective factors selected and determined based on the creation of the adaptive model are as follows.

Foremost, the model adaptations which are the highest as the index constituting the “finance/profitability” factor are the 4 ratios of “capital investment ratio”, “equity capital ratio”, “costs of goods sold ratio” and “sales volume operating profit ratio”. Subsequently, the model adaptations which are the highest as the index constituting the “R&D investment” factor are the 3 ratios of “R&D cost ratio δ”, “R&D expenditure per inventor” and “patent application productivity”. Finally, the model adaptations which are the highest as the index constituting the “patent strategy” factor are the 4 ratios of “number of claims per application”, “number of claims per inventor”, “patent diversification index” and “average patent competitive position index”. Incidentally, as the index constituting the “patent strategy” factor, additionally there are “patent desire”, “check power against other company” and “total valid patent share”. The definition and calculation method of the respective indexes are as per the lists shown in FIG. 4 to FIG. 9.

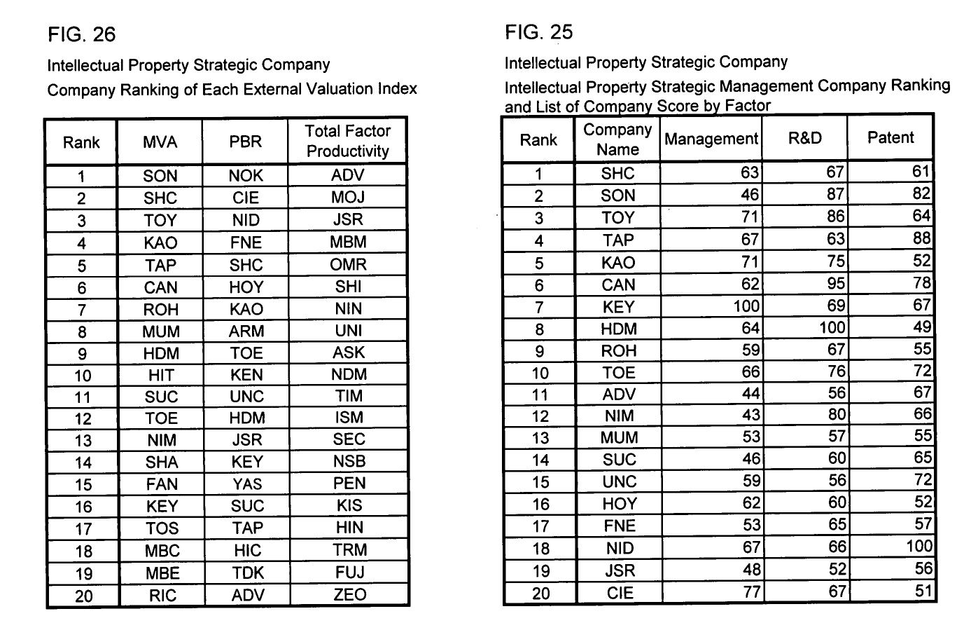

FIG. 25 to FIG. 29 are lists of company rankings valuating the “intellectual property strategic management company” based on the foregoing covariance structure analysis. FIG. 25 is a list constituted from the overall valuation ranking of the “intellectual property strategic management company”, and the respective company scores of the “finance/profitability” factor, “R&D investment” factor and “patent strategy” factor. Incidentally, the overall ranking of the “intellectual property strategic management company” is displayed by calculating the overall “total score”, standardizing the companies with the highest scores as 100 points or 1000 points, and listing the companies in descending order from the company with the highest “total score” down.

The lists shown in FIG. 26 to FIG. 29 respectively show company rankings for each of the three external indexes described above, and the respective indexes constituting each of the factors. As described above, in the covariance structure analysis, in addition to creating a ranking representing the overall valuation of the overall company, it will be possible to create a company ranking representing a multilateral valuation of each factor.

Further, in addition to conducting the corporate valuation for each factor, corporate valuation may also be conducted based on industry or product. Moreover, corporate valuation may be conducted based on the sections, classes, sub classes, and main groups of the International Patent Classification (IPC), or corporate valuation may be conducted based on US Patent Classification (UPC) or US Standard Industry Classification (SIC).

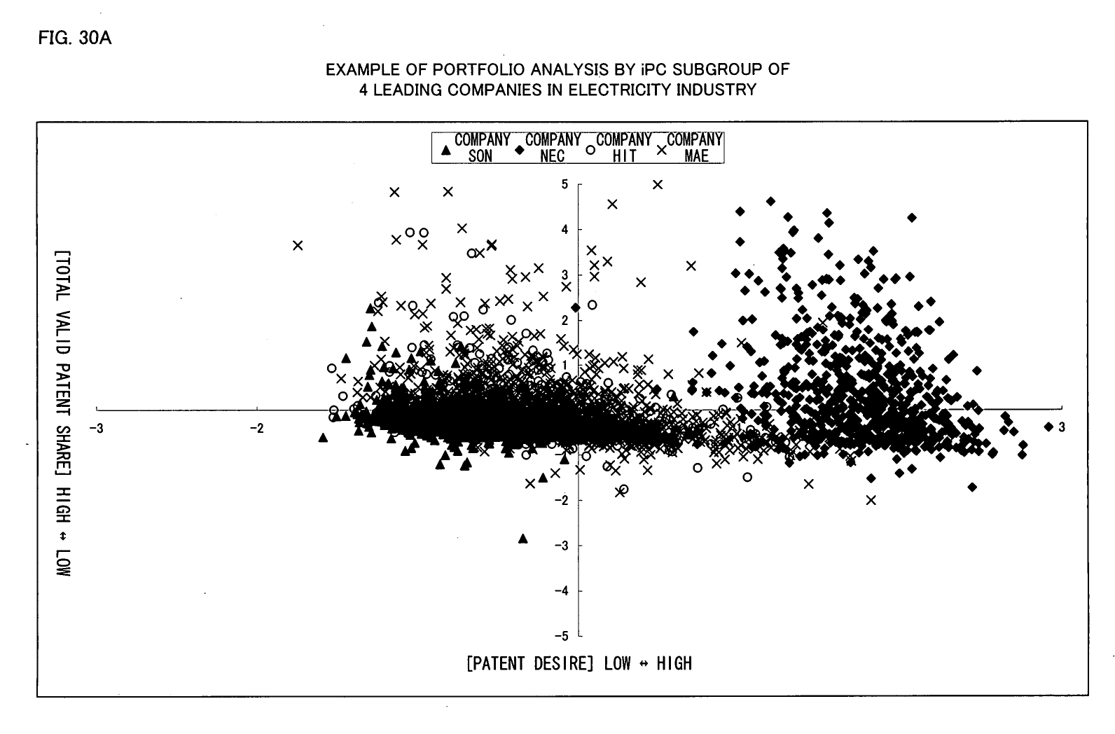

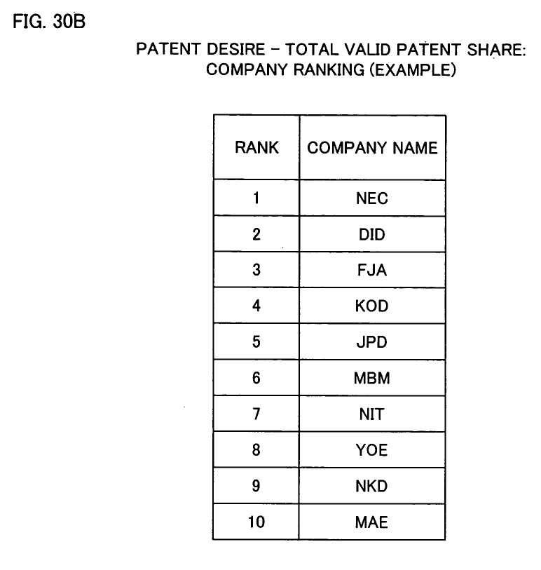

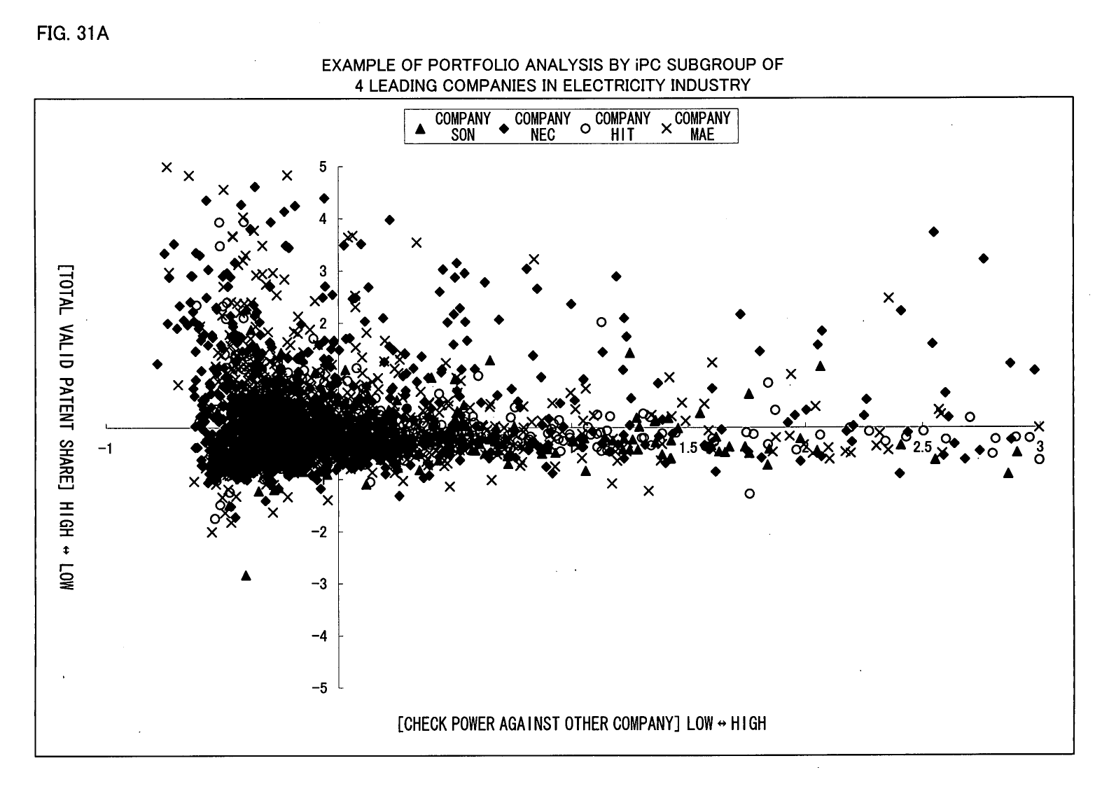

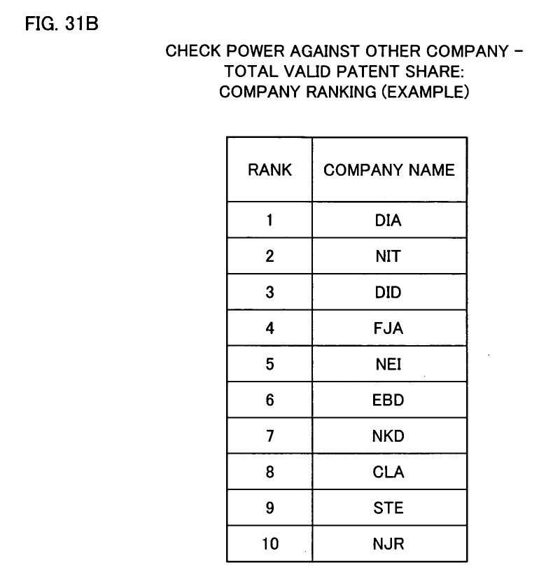

For instance, FIG. 30B and FIG. 31B are representations as company rankings of the results obtained by valuating the patents owned by companies in the electrical industry in arbitrary IPC sub groups based on a plurality of indexes representing patent features. As a result of adopting this kind of corporate valuation method, the potential values of the respective companies can be valued in more detail and with more precision.

Incidentally, FIG. 30A and FIG. 31A are examples of the scatter diagram created from the company ranking shown at FIG. 30B and FIG. 31B. For example, FIG. 30A is an example of a scatter diagram in which the results upon valuating the patents owned by the 4 leading companies in the electrical industry in arbitrary IPC sub groups based on the two indexes of “patent desire” and “total valid patent share” are plotted as a factor score. Similarly, FIG. 31A is an example of a scatter diagram in which the results upon valuating the patents owned by the 4 leading companies in the electrical industry in arbitrary IPC sub groups based on the two indexes of “check power against other company” and “total valid patent share” are plotted as factor scores. As a result of employing the scatter diagrams shown in FIG. 30A and FIG. 31A, it will be possible to compare patents owned by the respective companies by technical fields, or with competitors. In addition, contrary to the foregoing procedures, for instance, the factor scores plotted on FIG. 30A and FIG. 31A may be added and totaled, and, by setting scores in advance by areas in the respective quadrants, the number of dots plotted in the respective areas may be totaled. Thereby, it will be possible to create a company ranking by IPC sub groups and based on each of the plurality of indexes representing patent features.

(2-2-4. Other Methods of Company Valuation)

As described above, in an embodiment of the present invention, as the method of conducting corporate valuation, three methods; namely, a method of selecting an index and performing principle component analysis; a method of performing factor analysis and multiple regression analysis and thereafter performing principle component analysis; and a method of performing covariance structure analysis are explained. Nevertheless, the method of conducting corporate valuation is not limited to the foregoing methods. For example, multiple regression analysis may be performed without performing factor analysis, and principle component analysis may be performed thereafter upon selecting an index having a high contribution ratio in relation to the target variable. In addition, as another method of conducting corporate valuation, linear programming or non-linear programming may also be employed. As described above, a plurality of types of company rankings can be created based on a plurality of corporate valuation methods. Therefore, a company group to become the plurality of stock-for-portfolio candidates can be created based on different perspectives.

(2-3. Selection of Stock for Portfolio Company)

Returning to FIG. 3 once again, subsequently at step S14, N number of companies (hereinafter simply referred to as “N companies”) is selected from the total ranking based on the corporate valuation at step S13 in order to select the stock-for-portfolio company. As the method of selecting N companies, (1) a method of simply selecting the top N companies of the ranking, (2) a method of selecting companies having the standardized value of 1 or more with principle component 1, and (3) a method of selecting companies having the standardized value of 2 or more with both principle component 1 and principle component 2 may be employed. These selection methods are loaded in the program in advance, and may be automatically executed, or manually executed by the user. In an embodiment of the present invention, the top 10 companies and top 20 companies respectively shown in the rankings of FIG. 13 and FIG. 14 will be selected.

(2-4. Selection of Investment Ratio)

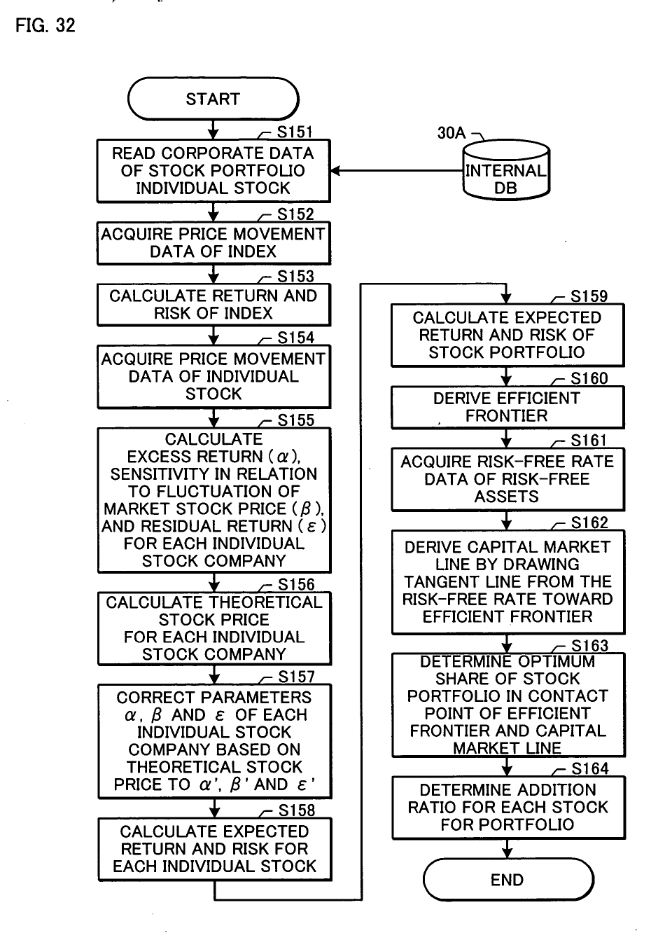

Next, at step S15, the selection of investment ratio of stock relating to the selected stock-for-portfolio company is conducted. FIG. 32 is a flowchart showing the processing steps of the investment ratio selection. Foremost, at step S151, the stock-for-portfolio company data is acquired from the internal database 30A.

(2-4-1. Parameter Calculation)

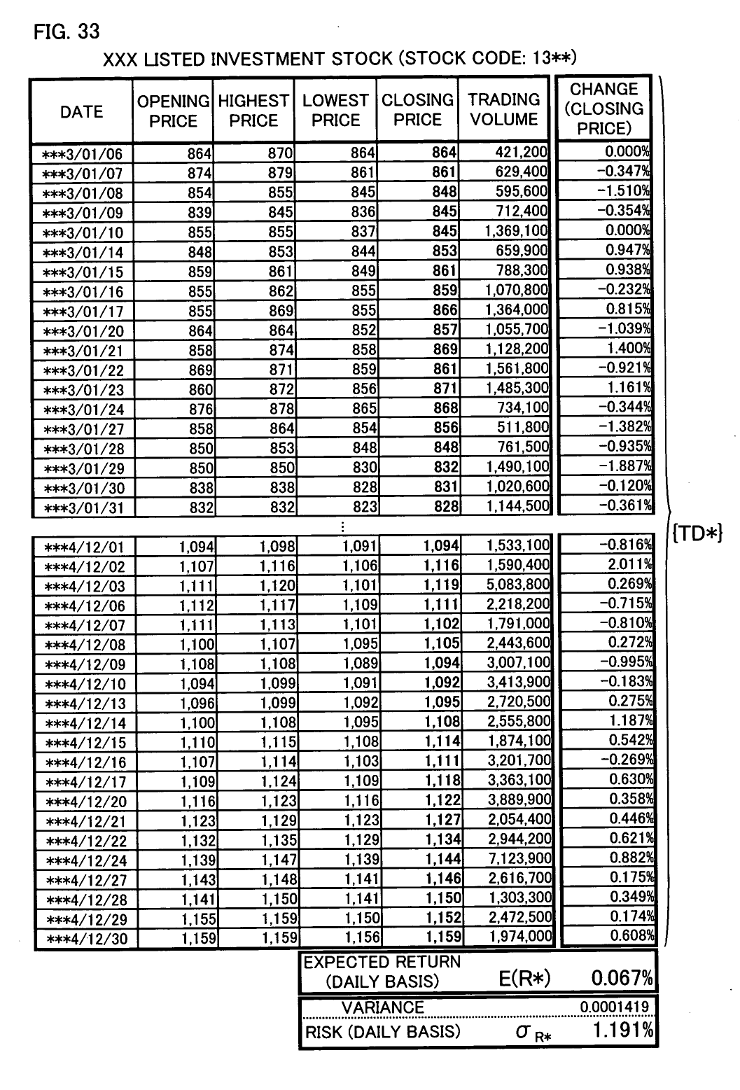

And, at step S152, the index is selected, and the price movement data of publicly available index is acquired. Here, and index is the stock price index showing the trend of the overall market. As the index, for instance, there is the Nikkei Stock Average, TOPIX, S&P 500 and so on. FIG. 33 is a list representing the aggregate {TD*} of the price movement data of the selected index *. In an embodiment of the present invention, although the price movement data for the past 2 years is obtained, the period of acquiring such data is not limited thereto, and an arbitrary period may be set.

Next, at step S153 of FIG. 32, the expected return and risk of the index are calculated. Here, an expected return is the profit ratio expected to be obtained from the investment. Generally, if the profit ratio of assets x is made to be Rx, the expected return will be represented with E(Rx). Further, expectation is a value obtained by weighing and averaging the value of the probability variable with the probability. Further, risk generally means the possibility that the value is not realized, and investment risk in particular is measured based on the variability of the expected return and the scale of variance. The risk value is represented with a standard deviation (a), which is the positive square root of the variance. FIG. 33 shows the expected return E(R*) and risk σ_{R}* of index *.

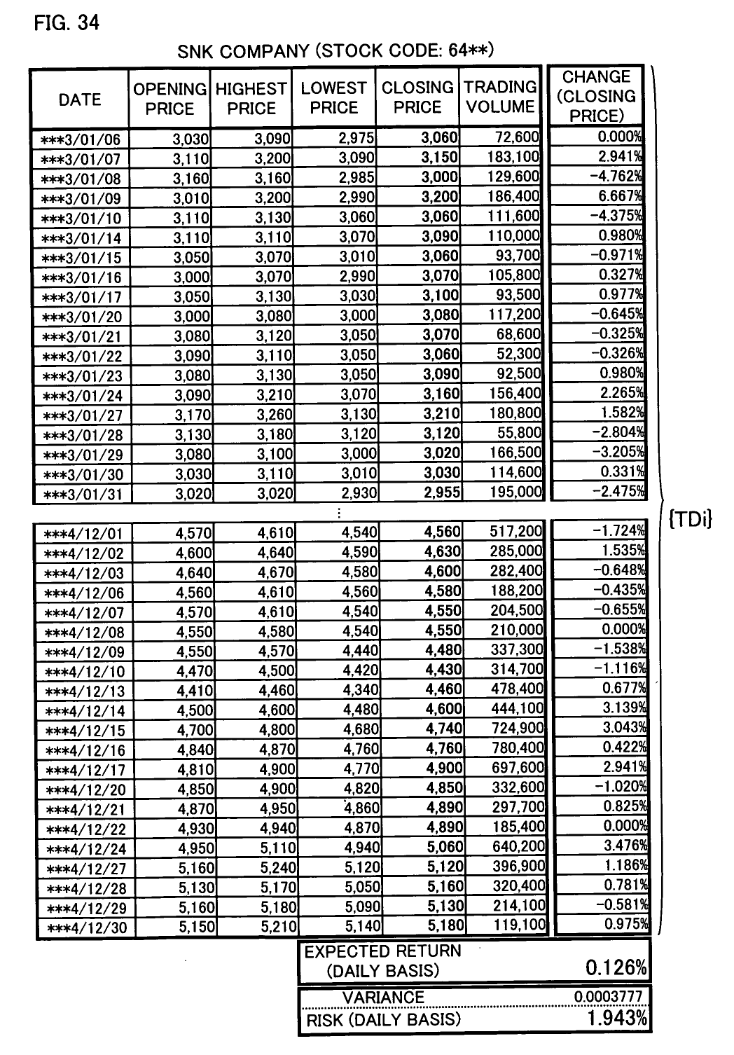

Next, at step S154, price movement data is acquired for each stock of individual company (hereinafter referred to as “individual stock”) constituting the stock for portfolio. FIG. 34 is a list showing the aggregate {TDᵢ} of the price movement data of the actual stock price of individual stock i (i=1 . . . N. N represents number of selected companies).

Next, at step S155, the excess return (α), sensitivity (β) and residual (ε) based on the price movement of the actual stock price of each individual stock are calculated. Here, excess return (α) shows how much the profit ratio of individual stock exceeded or fell below the profit ratio of the index. Sensitivity (β) is a coefficient showing the relationship of the price movement of the index and the price movement of the stock price of individual stock. Residual (ε) is a value generated based on elements unique to companies subject to individual stock.

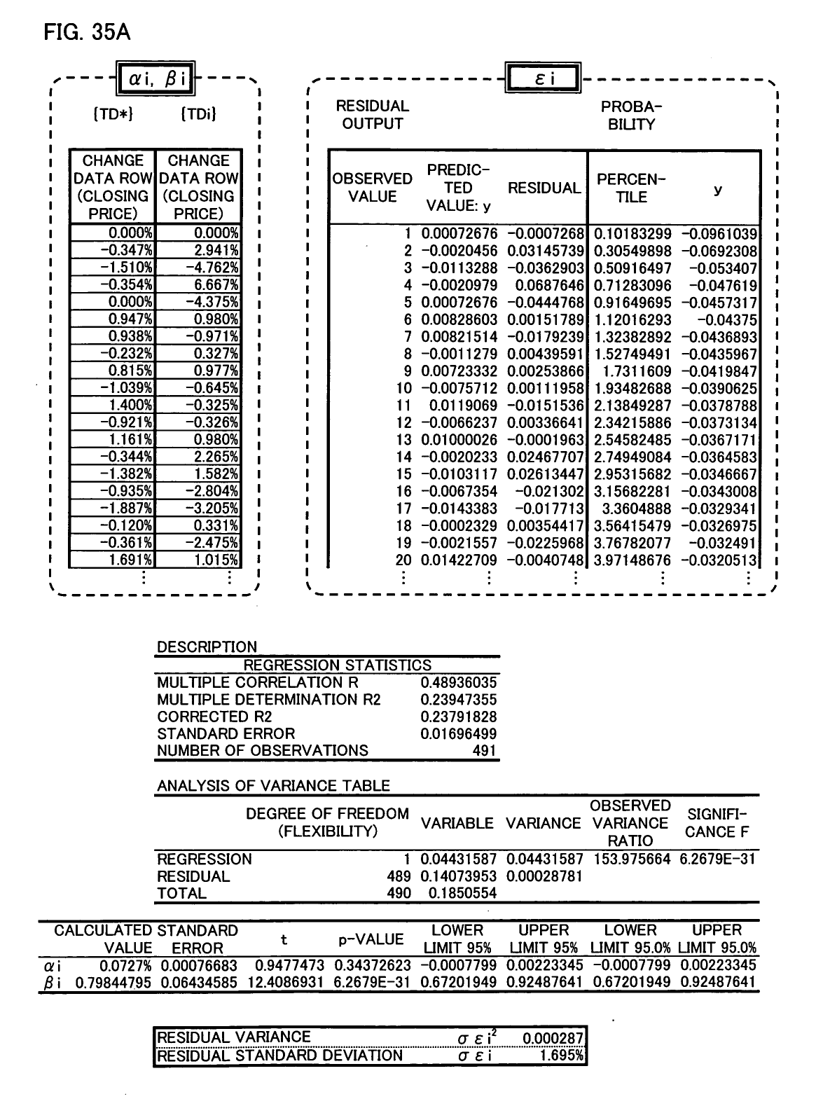

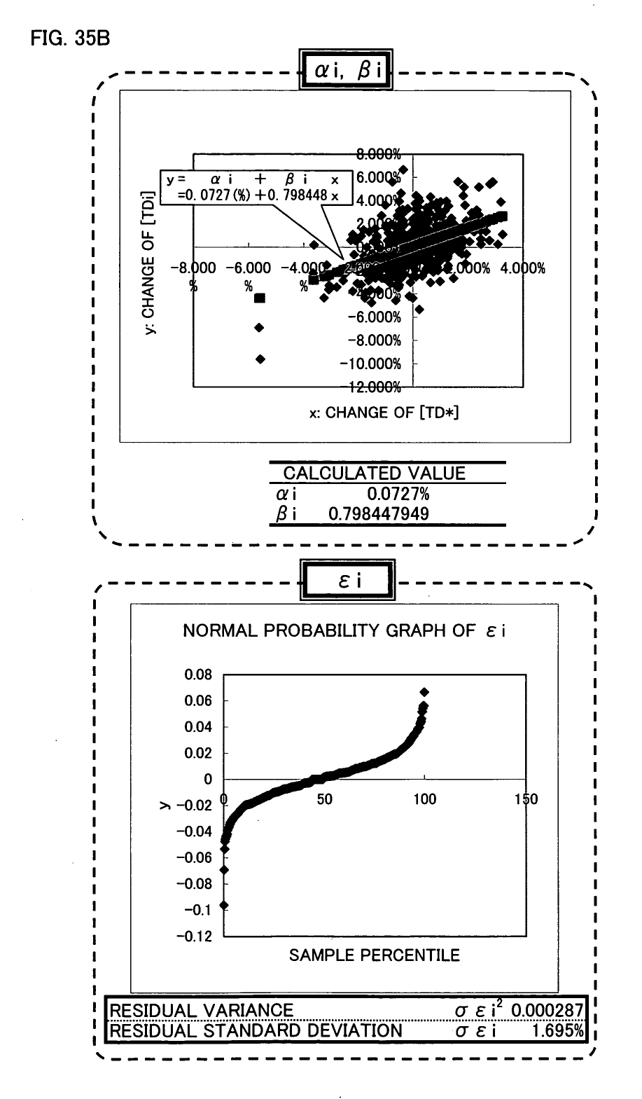

Calculation of αᵢ, βᵢ, εᵢ(i=1 . . . N) of each individual stock is conducted based on the comparative analysis of the price movement data{TDᵢ} individual stock shown in FIG. 34, and the price movement data{TD*} of index* shown in FIG. 33. Further, in an embodiment of the present invention, comparative analysis is conducted based on the regression analysis. FIGS. 35A and 35B are charts representing the calculated values of αᵢ, βᵢ, εᵢ. FIG. 35A shows four types of tables of “regression statistics”, “variance analysis”, “residual output” and “probability”. FIG. 35B shows two graphs of “observed value graph” and “normal probability graph”.

(2-4-2. Theoretical Stock Price Calculation)

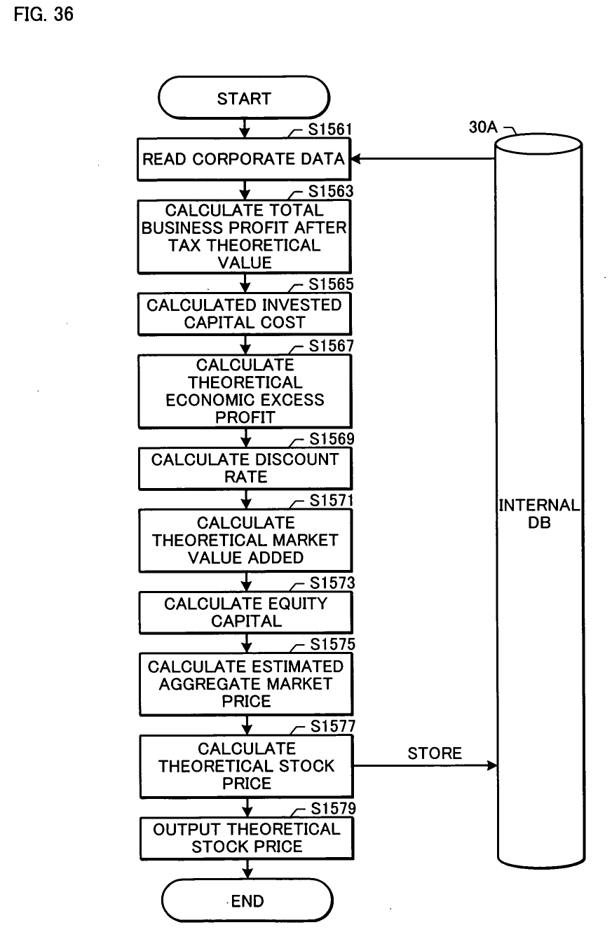

Next, at step S156, the theoretical stock price for each individual stock is calculated. The purpose of calculating the theoretical stock price here is to calculate the stock price which appropriately reflects the company's potential competitive power with the R&D cost related index and intellectual asset related index, and correct the parameter of each individual stock. As a result, a more preferable expected return and risk can be estimated. The theoretical stock price in an embodiment of the present invention is sought by obtaining the estimate aggregate market value by adding the equity capital of companies to the sum of the present value of residual profit in which the return requested from fund providers is deducted from the profits obtained from business activities, and dividing such estimated aggregate market value by the total outstanding stock volume. FIG. 36 is a flowchart representing the processing steps for calculating the theoretical stock price. Foremost, at step S1561, the valuation index data and stock price data of the selected stock-for-portfolio company are acquired from the internal database 30A.

Next, at step S1563, the total business income after tax theoretical value is calculated with the acquired corporate valuation index related data. Here, the gross business profit is an amount obtained by adding the patent royalty income to the amount of profit sought by adding the R&D cost processed as expenses back to the operating profit. The reason for using the gross business profit and not the operating profit is because, firstly, it is necessary to comprehend the profit secured by companies prior to the deduction of the R&D cost. Secondly, as a result of incorporating the profits from intellectual assets such as patents created based on R&D, it will be possible to appropriate valuate the company's potential competitive power, and to comprehend how such potential competitive power is linked with overt competitive power and profits.

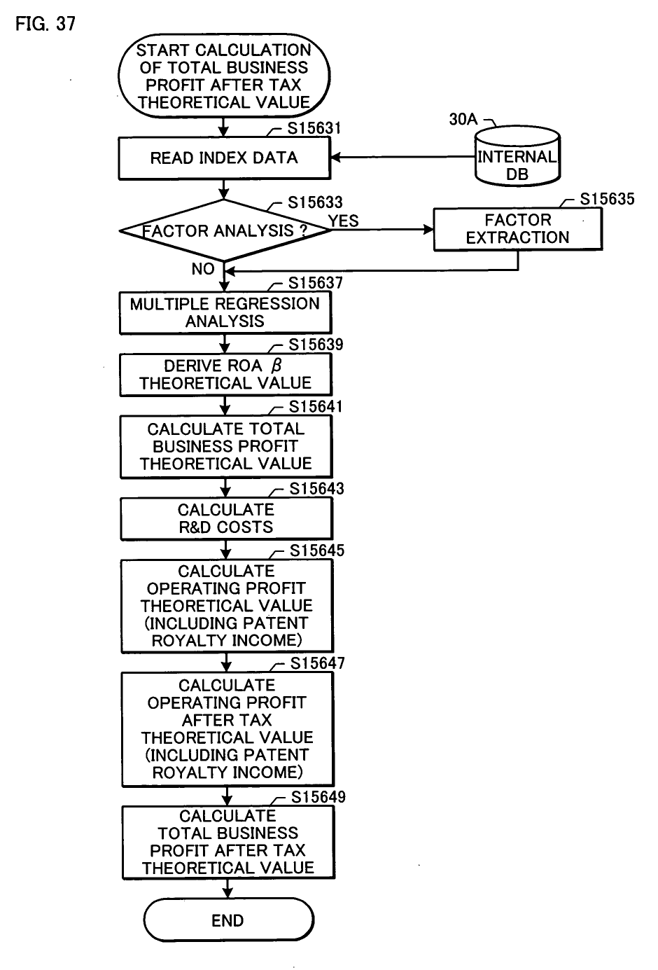

FIG. 37 is a flowchart showing the processing steps for calculating the total business income after tax theoretical value. Foremost, at step S15631, corporate valuation index related data containing the intellectual asset related index is acquired from the internal database 30A.

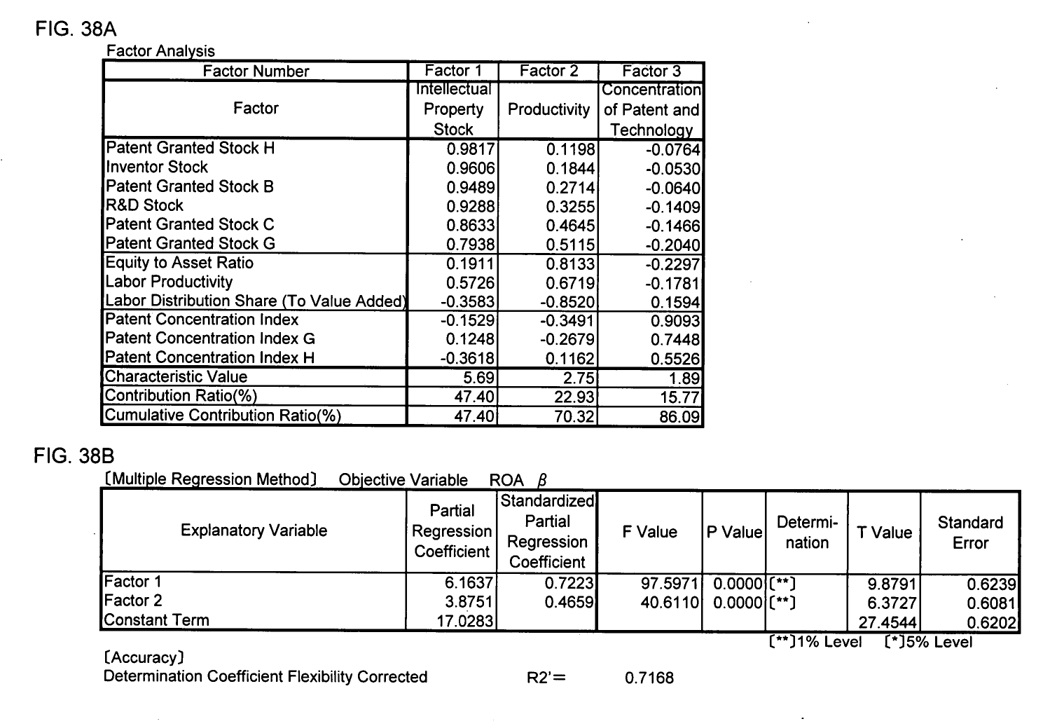

Next, at step S15633, whether to perform factor analysis processing is selected. When selecting to perform factor analysis processing, factor analysis relating to the acquired index data is performed at step S15635 so as to extract primary factors. The respective indexes are united for each of the extracted factors. The processing steps of factor analysis are the same as the procedures during the valuation of a company to become the stock-for-portfolio candidate, and the explanation thereof is omitted. FIG. 38A is a list representing the factor analysis. As a result of performing factor analysis, the three factors of factor 1 (intellectual assets stock), factor 2 (productivity) and factor 3 (concentration of patent/technology) are extracted.

At step S15637 of FIG. 37, the factor extracted in the factor analysis processing is made to be the explanatory variable, and ROA β as the profit related index is used as the target variable upon performing the multiple regression analysis. Here, ROA β is the ratio in relation to the total assets of the gross business profit generated in each year by the company. The calculation formula of ROA β is as shown in Formula 17 below.
ROA β=Gross Business Profit/Total Assets (Formula 17)

Incidentally, the profit related index used as the target variable is not limited to ROA β, and any profit related index may be used according to the objective and nature of analysis.

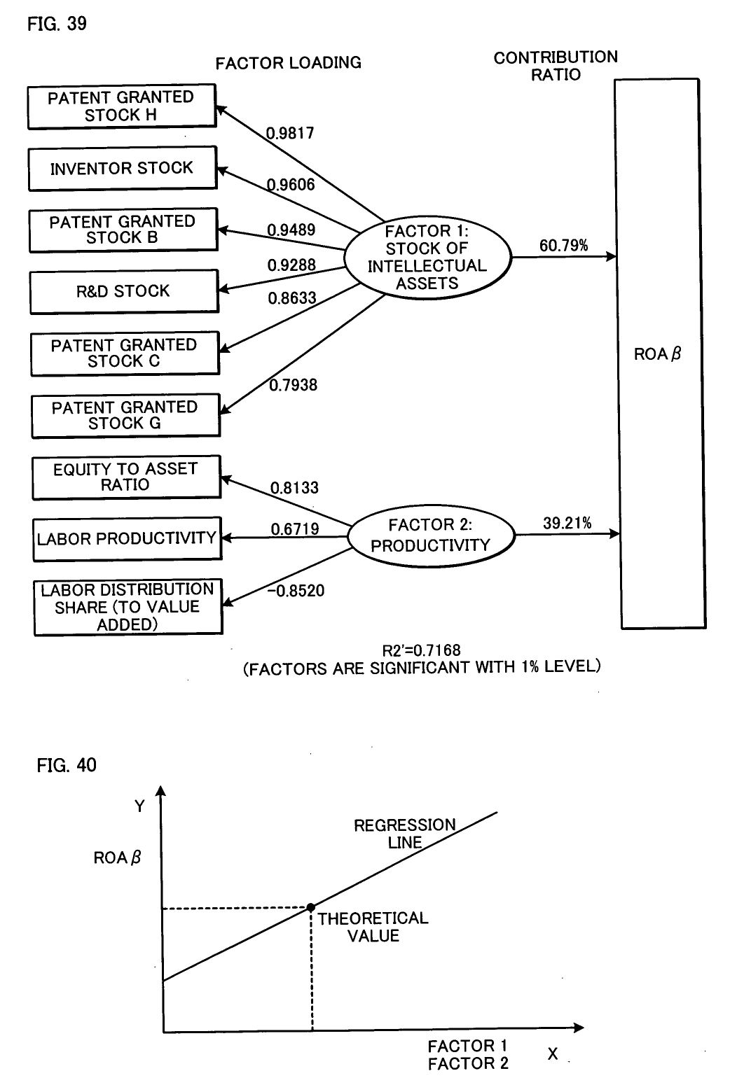

Incidentally, since the processing steps of calculating the partial regression coefficient and standard partial regression coefficient, verifying the respective coefficients with the t value, and verifying the adaptation of the multiple regression equation with determination coefficient R²′ flexibility corrected are also the same as the procedures for valuating the company to become the stock-for-portfolio candidate, the explanation thereof is omitted. FIG. 38B and FIG. 39 are a list and relationship diagram representing the results of the multiple regression analysis. As shown in FIG. 39, as a result of having performed the multiple regression analysis, the statistically significant factors are factor 1 (intellectual assets stock) and factor 2 (productivity). Further, the contribution ratio in relation to ROA β of each factor is 60.79% in factor 1 (intellectual assets stock) and 39.21% in factor 2 (productivity).

Next, at step S15639 of FIG. 37, the theoretical value of ROA β is calculated. In order to perform this calculation, foremost, a regression line is derived in which factor 1 (intellectual assets stock) and factor 2 (productivity) which had a high contribution ratio in relation to ROA β are made to be independent variables, and ROA β employed in the target variable is made to be a dependent variable. FIG. 40 is a graph of the regression line representing the relationship of factor 1/factor 2 and ROA β. The theoretical value of ROA β is sought with a point on this regression line.

Incidentally, when factor analysis is not performed at step S15633, multiple regression analysis is performed at step S15637 based on the index data acquired at step S15631. Here, an index having a high contribution ratio in relation to target variable ROA β is selected, the selected index is made to be an independent variable, and ROA β is made to be a dependent variable upon deriving the regression line. Further, the method of calculating the theoretical value of ROA β at step S15639 is not limited to factor analysis or multiple regression analysis. For instance, covariance structure analysis may also be employed to calculate the theoretical value of ROA β.

Next, at step S15641, the gross business profit theoretical value is calculated. The gross business profit theoretical value is sought by multiplying the total assets of the company to the theoretical value of ROA β once again.

Next, at step S15643, the value of the R&D cost to be deducted from the gross business profit theoretical value is calculated. At present, the R&D cost is collectively recorded as accounting expenses. Nevertheless, R&D is conducted for the purpose of increasing profits with the subsequent commercialization and merchandizing. Thus, it would be appropriate to deem the portion of the R&D cost contributing to the profit of companies as assets, and not expenses. Therefore, investment of funds in R&D will be deems an investment, and not expenses, and losses that do not function as assets will be calculated as annual depreciation costs as with other fixed assets. And, by deducting the calculated depreciation costs, the remaining R&D cost (R&D cost after depreciation) will be calculated as assets. As the calculation method of such depreciation costs, firstly, there is an approach based on a macro corporate valuation of measuring how the R&D funds invested as an input generate intellectual assets as an output, and how such assets lead to achievements. Further, as the second calculation method, there is an approach based on a micro patent information analysis of performing a detailed analysis of the number of applications filed and subject matter of such applications of each company, forming an index of the competitive power of the company in a patent/technical development competitive market, and speculating the technical development characteristics thereof. Incidentally, in an embodiment of the present invention, it will be hypothesized that there are no losses pertaining to R&D, and depreciation costs have not been deducted.

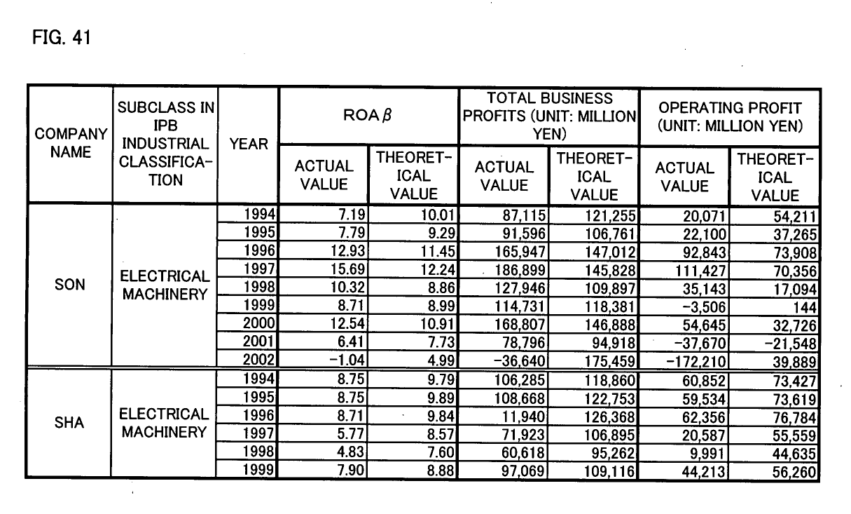

Next, at step S15645, the operating profit theoretical value is calculated. Incidentally, this operating profit theoretical value is a theoretical value of a value including the patent royalty income. The operating profit theoretical value is sought by deducting the R&D cost calculated at step S15643 from the gross business profit theoretical value. In an embodiment of the present invention, the total amount of R&D costs recorded as expenses is deducted from the gross business profit theoretical value. FIG. 41 is a list representing the calculation results of the actual values and theoretical values including ROA β, gross business profit, and operating profit including the patent royalty income of each year of a specific company.

Next, at step S15647, the operating profit after tax theoretical value is calculated. The operating profit after tax theoretical value is calculated by deducting the corporate tax from the operating profit theoretical value including the patent royalty income. Specifically, this is as shown in Formula 18 below.
Operating Profit After Tax Theoretical Value=Operating Profit Theoretical Value (Including Patent Royalty Income)×(1−corporate tax rate) (Formula 18)

Finally, at step S15649, the total business income after tax theoretical value is calculated. The total business income after tax theoretical value is sought by adding the R&D cost calculated at step S15643 to the operating profit after tax theoretical value. Incidentally, the total business income after tax theoretical value according to an embodiment of the present invention employs an average value of three terms of the operating profit after tax theoretical value (including patent royalty income) and R&D cost. Nevertheless, the length of the term to be adopted is not limited to the above, and this may be arbitrarily set.

After calculating the total business income after tax theoretical value, the routine returns once again to FIG. 36, and at step S1565, the investment capital cost of the company is calculated. The investment capital cost is calculated based on the weighted average cost of capital (WACC). WACC is an abbreviation of Weighted Average Cost of Capital, and represents the minimum amount of return requested by the fund provider. Further, weighted average is the act of weighing and averaging the costs arising in connection with the debts as fund procurement resource of companies and stockholders' equity with the procured amount. The calculation formula of WACC is as shown in Formula 19 below.
Investment Capital Cost (WACC)=Market Value of Interest Bearing Debt/Market Value of Company×Debt Cost×(1−corporate tax rate)+Market Value of Stock/Market Value of Company'Stockholders' Equity Cost (Formula 19)

Incidentally, the method of calculating the capital cost is not limited to Formula 19 described above. For example, a method of calculation which multiplies the value obtained by adding the company's operating capital and tangible fixed assets with WACC may also be employed. Any of these methods may be arbitrarily selected according to the objective of analysis or nature of target.

Next, at step S1567, the theoretical economic excess profit is calculated by deducting the investment capital cost calculated at step S1565 from the total business income after tax theoretical value. Here, the theoretical economic excess profit is the theoretical value of the residual profit after deducting the investment capital cost from the total business income after tax theoretical value. The calculation formula of the theoretical economic excess profit is as shown in Formula 20 below.
Theoretical Economic Excess Profit=Total Business Income After Tax Theoretical Value (Average Value of 3 Terms)−Investment Capital Cost (Formula 20)

Next, at step S1569, the discount rate is calculated. A discount rate is a type of interest for calculating the future profits of the company upon returning them to the present value. The discount rate is calculated based on a capital asset pricing model (CAPM). CAPM is the abbreviation of Capital Asset Pricing Model, and is a model for showing that there is a quantitative relationship for balancing the supply and demand between the risk assets and expected profit ratio. CAPM is calculated by adding a value obtained by multiplying coefficient (β) representing the stock price range of individual companies with a value obtained by deducting the risk-free rate of risk-free assets from the profit ratio of the stock market, and the risk-free rate of risk-free assets. The calculation formula of CAPM is as shown in Formula 21 below.
Discount Rate (CAPM)=Risk-free Rate of Risk-free Assets+β×(Profit Ratio of Stock Market−Risk-free Rate of Risk-free Assets) (Formula 21)

Next, at step S1571, the theoretical market value added is calculated by dividing the theoretical economic excess profit by the discount rate. The theoretical market value added is equivalent to the sum of the discounted present value of the theoretical economic excess profit in a future term. Theoretical market value added is the theoretical value regarding the valuation in the market of off-balanced assets of the company. In other words, the theoretical market value added is the difference between the company's potential market value and equity capital, and represents the value deemed to be generated beyond the capital invested in the company. The calculation formula of the theoretical market value added is as shown in Formula 22 below.
Theoretical Market Value Added=Theoretical Economic Excess Profit/Discount Rate (Formula 22)

Next, at step S1573, the company's equity capital is calculated. Equity capital is the stockholders' equity; in other words, the net assets of the company, and an average value of 3 terms is used in an embodiment of the present invention.

Next, at step S1575, the estimated aggregate market value is calculated. The estimated aggregate market value is calculated by adding the average value of 3 terms of equity capital calculated at step S1573 to the theoretical market value added. The calculation formula of the estimated aggregate market value is as shown in Formula 23 below.
Estimated Aggregate Market Value=Theoretical Market Value Added+Equity Capital (Average of 3 Terms) (Formula 23)

Next, at step S1577, the theoretical stock price is calculated. The theoretical stock price is calculated by dividing the calculated estimated aggregate market value by the total outstanding stock volume. The calculation formula of the theoretical stock price is as shown in Formula 24 below.
Theoretical Stock Price=Estimated Aggregate Market Value/Total Outstanding Stock Volume (Formula 24)

Incidentally, the calculation method of the theoretical stock price is not limited to the embodiments of the present invention. For example, a method of calculating the estimated aggregate market value by deducting the amount of debt from the discounted present value of future profits of the company, and dividing this by the total outstanding stock volume so as to obtain the theoretical stock price may also be employed. Or, it is also possible to calculate the theoretical stock price based on the dividends of stock. Any of these methods may be arbitrarily selected according to the objective of calculation and target of calculation of the theoretical stock price. Incidentally, the calculated theoretical stock price is stored in the internal database 30A.

Next, at step S1579, the calculation result of the theoretical stock price is displayed on a display screen together with the actual stock price. Further, as necessary the list or graph of the calculation result of the theoretical stock price and price movement data of the actual stock price is output to the printer 31.

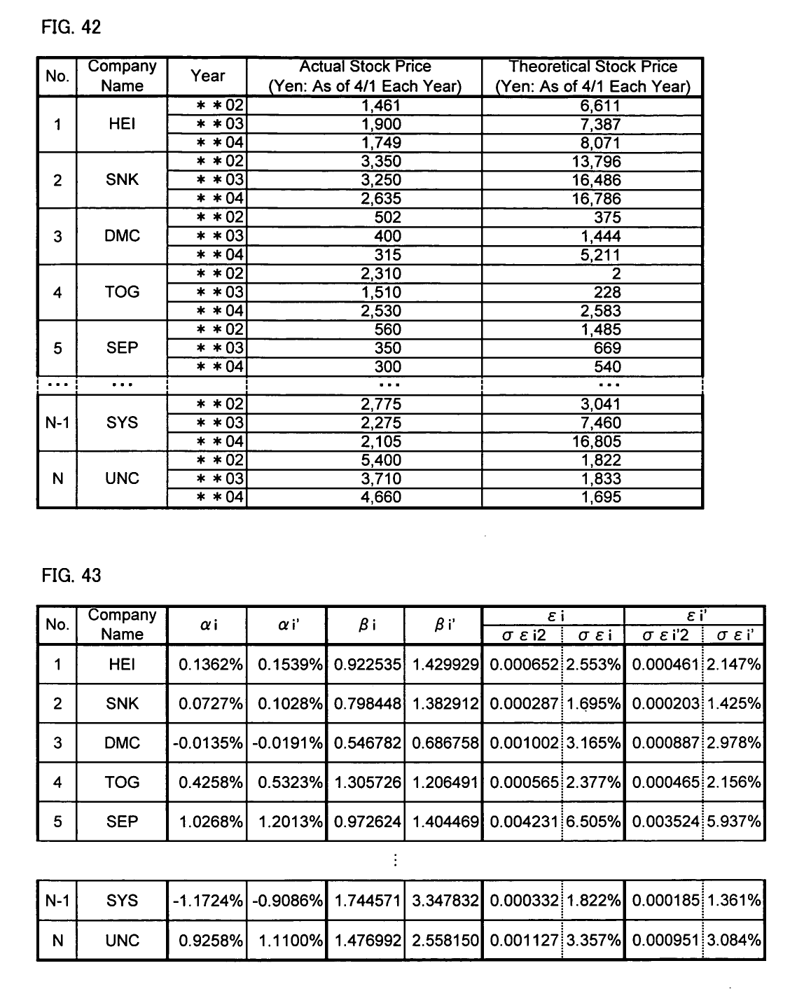

FIG. 42 is a list of the calculation result of the theoretical stock price. In this list, the company name, year, performance of the actual stock price and the theoretical stock price are displayed. Many of the calculated theoretical stock prices are of a higher value than the actual stock prices. This is based on the calculation of stock prices properly reflecting the company's potential competitive power as a result of valuating the outline of the intellectual assets created by the company and the contributions in relation to the corporate profit of intellectual assets employing, in addition to the management/finance related index, the R&D cost related index and intellectual asset related index. From this result, many of the stock prices of prescribed companies shown in FIG. 42 can be judged as being relatively cheap in comparison to the potential corporate value of the companies. Moreover, in light of the above, if there are no problems in areas other than business activities based on the core business of the company, it can be determined that it is highly likely for the stock prices to rise in the future.

(2-4-3. Investment Ratio Selection)

Returning once again to the flowchart of FIG. 32 representing the processing steps of selecting the investment ratio, foremost, at step S157, the parameters (α, β, ε) of each individual stock calculated based on the actual stock price are corrected based on the theoretical stock price. Here, the aggregate {TDᵢ}′ of the price movement data of the theoretical stock price is sought by multiplying a coefficient according to a time series to the actual stock price such that the aggregate {TDᵢ} of the price movement data of the actual stock price of individual stock i (i=1 . . . N) will pass through the present theoretical stock price, the theoretical stock price of the previous year, or the theoretical stock price of 2 years ago, or such that it overlaps with the aggregate value of these theoretical stock prices.

Thereafter, the aggregate {TDᵢ}′ of the price movement data of the theoretical stock price and the aggregate {TD*} of the price movement data of the index * are subject to comparative analysis. And, the theoretical excess profit (αᵢ′), theoretical sensitivity (β′) and theoretical residual (ε′) are calculated for each individual stock. FIG. 43 is a list showing the calculation result of the excess profit (α), sensitivity (β) and residual (ε), and the theoretical excess profit (α′), theoretical sensitivity (β′) and theoretical residual (ε′) of each individual stock.

Incidentally, the method of correcting the parameter of individual stocks is not limited to the above. For instance, after calculating the theoretical stock price, it is possible to calculate the theoretical excess profit (α′), theoretical sensitivity (β′) and theoretical residual (ε′) by directly comparing this with the index. Or, without correcting the excess profit (α), sensitivity (β) and residual (ε) calculated based on the actual stock price with the theoretical stock price, these may be used as the theoretical excess profit (α′), theoretical sensitivity (β′) and theoretical residual (ε′) without change. Further, as another correction method, statistical analysis or nonlinear analysis employing the input information of the theoretical stock price and a variety of other methods of analysis may be employed.

Next, at step S158, the expected return and risk for each individual stock are calculated based on the calculated theoretical excess profit (α′), theoretical sensitivity (β′) and theoretical residual (ε′). Foremost, the expected return of the individual stock is represented with E(Rᵢ)(i=1 . . . N), and is calculated based on Formula 25 below.
Expected Return E(Rᵢ)=Theoretical Excess Profit (α′)+Theoretical Sensitivity (β′)×Return of Index *+Theoretical Residual (ε′) (Formula 25)

Next, the risk of the individual stock is calculated. The risk is represented with σ_{Ri}(i=1 . . . N), and is sought by calculating variance σ² of the expected return of the individual stock. Specifically, this is as shown in Formula 26 below.
Variance σRi² of Individual Stock=Σᵢ₌₁^{N}[{E(Rᵢ)−E(R*)}²]/N−1 (Formula 26)

Incidentally, risk σ_{Ri} is the positive square root of variance σ_{Ri}².

Next, at step S159, the expected return and risk of the overall stock portfolio are calculated based on the expected return and risk calculated for each individual stock. Foremost, the expected return of the overall stock portfolio is calculated. The expected return of the overall stock portfolio is represented with E(Rp), and is calculated based on Formula 27 below.
Expected Return E(Rp)=α′ₚ+β′ₚ×E(R*) (Formula 27)

Here, α′ₚ represents the theoretical excess profit (a′) of the overall stock portfolio. β′ₚ represents the theoretical sensitivity (β′) of the overall stock portfolio. E(R*) represents the expected return of the index *. The theoretical excess profit (α′) of the overall stock portfolio is a weighted average of α′ of the individual stock in relation to the share of portfolio. Further, the theoretical sensitivity (β′) of the overall stock portfolio is similarly a weighted average of β′ of the individual stock in relation to the share of portfolio.

Next, the risk of the stock portfolio is calculated. The risk of the overall stock portfolio is represented with σ_{Rp}, and is sought by calculating variance σ_{Rp}² of the overall stock portfolio. Specifically, this is as shown in Formula 28 below.
Variance σ_{Rp}² of Overall Stock Portfolio=β′ₚ²σ_{R*}²+Σᵢ₌₁^{N}(Xᵢ²σ_{εi}²) (Formula 28)

Here, β′ₚ² represents the variance of the theoretical sensitivity (β′) of the overall stock portfolio. σ_{R*}² represents the variance of the index *. Xᵢ(i=1 . . . N) represents the individual share of portfolio. σ_{εi}² represents the variance of the predicted residual (ε′) of the individual stock. Incidentally, risk σ_{Rp} of the overall stock portfolio is the positive square root of variance σ_{Rp}².

Here, since the first term on the right side is a crossing of the variance of the index * and the variance of β′ of the overall stock portfolio, this value will be influenced based on the price movement of the index. Meanwhile, the second term is determined based on the standard deviation (σ_{εi}) of the predicted residual (ε′) of the individual stock and the share of portfolio (X) of the individual stock, and is not related to the risk of the index *. Thus, the first term on the right side is referred to as the systematic risk (market risk), and the second term is referred to as the unsystematic risk (non-market risk). In other words, the risk of the overall stock portfolio is based on elements resulting from the price movement of the index *, and element resulting from events unique to the stock portfolio.

Next, at step S160, the efficient frontier is derived based on the expected return and risk of the calculated stock portfolio. Specifically, foremost, when the expected return of the stock portfolio is fixed, the share of portfolio of the stock for portfolio in which the risk is to be minimized (hereinafter referred to as the “minimum risk share of portfolio”) is calculated. Next, by changing the expected return of the stock portfolio into various values, the minimum risk share of portfolio corresponding to the respective expected returns is calculated. And, the aggregate of the minimum risk share of portfolio by the obtained expected return is derived as the efficient frontier. Here, “frontier” means the outer edge of the portfolio, and implies that a combination having a smaller risk in an equivalent expected return among any and all combinations of the stock in possess does not exist.

Next, at step S161, data concerning the risk-free rate of risk-free assets is acquired. Here, risk-free assets mean the assets such as government bonds in which assured profits are guaranteed. A risk-free rate is the return of the risk-free assets. For example, in Japan, the risk-free rate of the 10-year government bond to be the index of a long-term interest rate and, in the US, the risk-free rate of a 30-year bond will become the index of the risk-free rate of risk-free assets.

Next, at step S162, the capital market line is derived. A capital market line is a straight line representing the relationship of the risk and return of the portfolio incorporating risk assets such as stocks and risk-free assets. A capital market line, foremost, is derived by drawing a tangent from a fixed point, which is the risk-free rate of risk-free assets, toward the efficient frontier.

No investor only owns financial assets as stock, and always owns safe assets without any risk in decrease in prices. Thus, the decision making for selecting the investment ratio of stock portfolio, and the decision making for selecting the investment ratio upon combining risk-free assets and risk assets such as stock are conducted completely separately. As a result, the optimum portfolio for an investor in the efficient frontier will be determined at one point which contacts the capital market line. This is the reason the capital market line is introduced in addition to the efficient frontier.

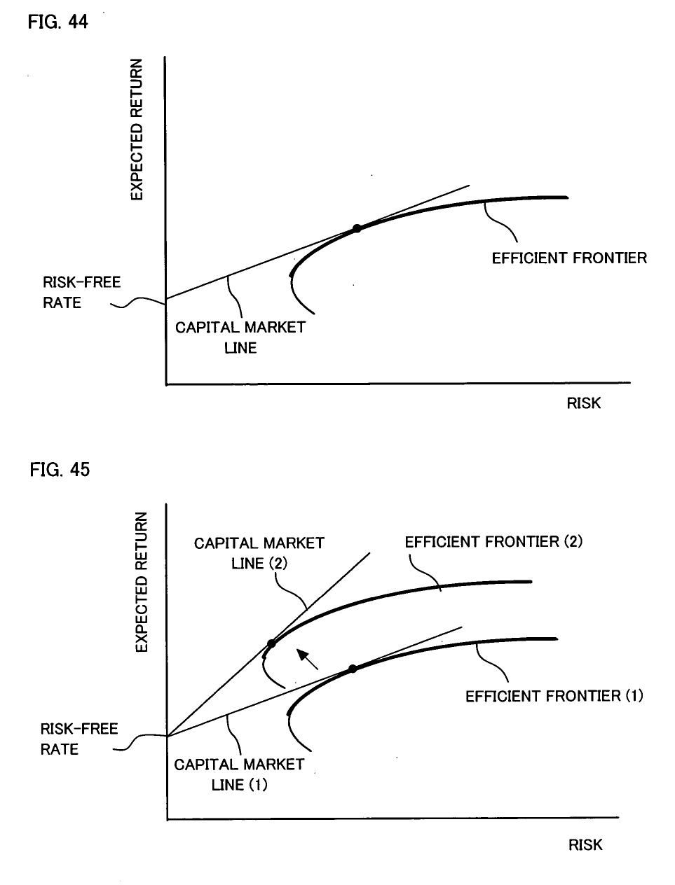

Next, at step S163, the optimum share of portfolio of the stock for portfolio is determined in the contact point of the efficient frontier and capital market line. FIG. 44 is a graph representing an example realizing the optimum share of portfolio in the contact point of the efficient frontier and capital market line.

The foregoing is the standard processing steps for selecting the optimum investment ratio of a stock portfolio. Nevertheless, in an embodiment of the present invention, by calculating the theoretical stock price of each stock-for-portfolio company, the parameters (αᵢ′, βᵢ′, εᵢ′) are corrected by appropriated valuating the potential competitive power of the respective companies. As a result, it is highly likely that the value of the expected return E(Rᵢ) of the theoretical stock price compared with the actual stock price will comparatively rise. Or, at the same time, it is highly likely that the value of risk σ_{Ri} of the theoretical stock price compared with the actual stock price will comparatively fall.

Accordingly, for instance, as shown in FIG. 45, when both the rise of the expected return and the fall of the risk occur, the efficient frontier will shift toward the upper left direction from (1) to (2). Pursuant thereto, the contact point of the capital market line and efficient frontier will also shift toward the upper left direction, and the optimum share of the stock portfolio will be changed thereby. Further, although not shown, when only the expected return rises, the efficient frontier will shift upward. Moreover, when only the risk falls, the efficient frontier will shift leftward. And, in either case, the contact point of the capital market line and efficient frontier will change, and the optimum share of the stock portfolio will be changed thereby.

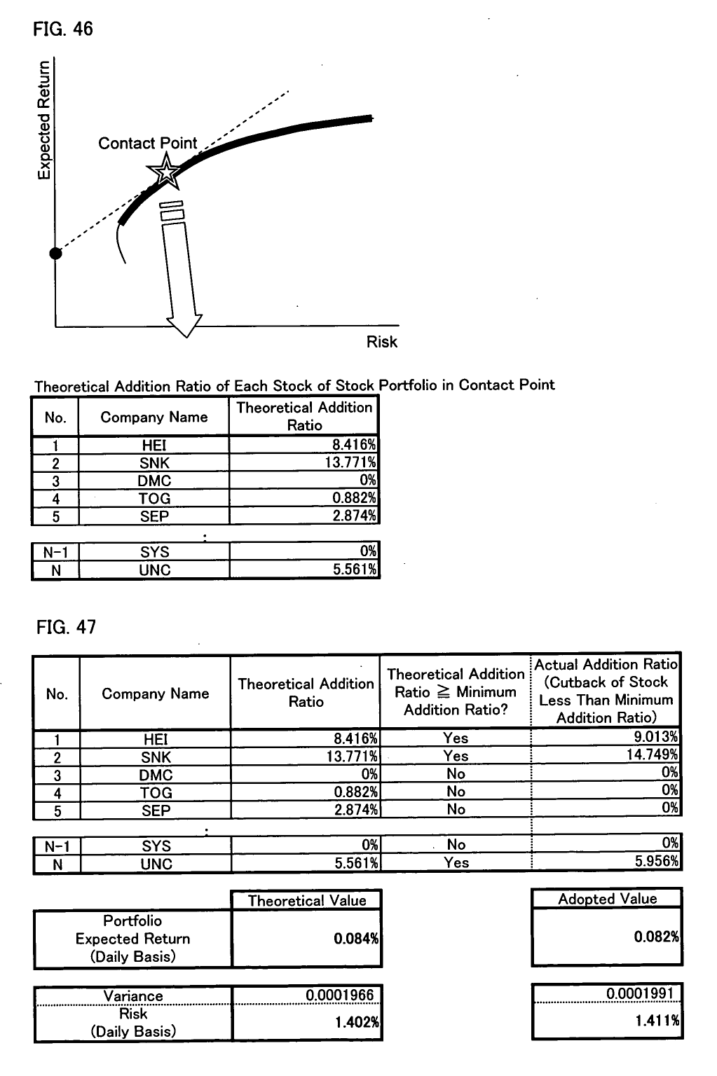

Next, at step S164, the addition ratio for each individual stock of the stock portfolio is determined. Foremost, the optimum share of portfolio in the contact point of the efficient frontier (2) and capital market line (2) shown in FIG. 45 is specified. Next, in this contact point, the respective addition ratios of each individual stock of the stock portfolio are calculated. FIG. 46 is a chart representing an example of the theoretical addition ratio of each individual stock in the contact point of the efficient frontier and capital market line.

Incidentally, with the calculated theoretical addition ratio as is, there may be cases where the investment ratio cannot be distributed. In other words, there may be cases where it is necessary to determine the actual addition ratio capable of actual distribution according to the minimum required investment amount or actual stock price per stock. FIG. 47 shows an example of the actual addition ratio determined from the theoretical addition ratio. And, after the actual addition ratio is determined, the selection procedure of the investment ratio is ended.

Incidentally, the investment ratio selection method is not limited to the above. For example, a method of simply distributing an equal number of stocks or a method of distributing an equal amount to the stock-for-portfolio company may be employed. Or, a method of distributing in proportion to the company score, or a method of distributing to companies having a standardized value of 1 or 2 or more in the company ranking based on the principle component analysis may be employed. Or, a method of selecting the investment ratio with a linear programming or the like may be employed. An investment ratio in relation to the respective companies can be selected with any of these methods, or with a combination of these methods.

Further, without selecting the stock-for-portfolio company in advance, it is possible to select the investment ratio regarding the stock for portfolio constituted from all companies or an arbitrary company group. For example, the investment ratio can be selected by calculating the risk and return, respectively, for all target companies, and determining the optimum share of portfolio in the contact point of the efficient frontier and capital market line derived as a result thereof.

(2-5. Portfolio Creation)

Returning now to the flowchart of FIG. 3 representing the processing steps of the stock portfolio selection, after the investment ratio selection procedures is complete, at step S16, the stock portfolio is created and stored in the internal database 30A.

Then, at step S17, the transition of the stock price fluctuation ratio and return of the created stock portfolio is computed, and, a list or graph visually displaying this is output as necessary, and the routine is thereby ended.

(2-6. Transition Result of Stock Price Fluctuation Ratio and Return of Stock Portfolio)

Next, an example of the transition result of the stock price fluctuation ratio and return of the stock portfolio is described. In this example, as a result of conducting the company ranking based on principle component 1 and principle component 2 in the principle component analysis performed for selecting the stock-for-portfolio candidate company, the stock price transition of the respectively selected top 10 companies, top 20 companies and top 30 companies is shown. Further, the investment ratio is all equally distributed.

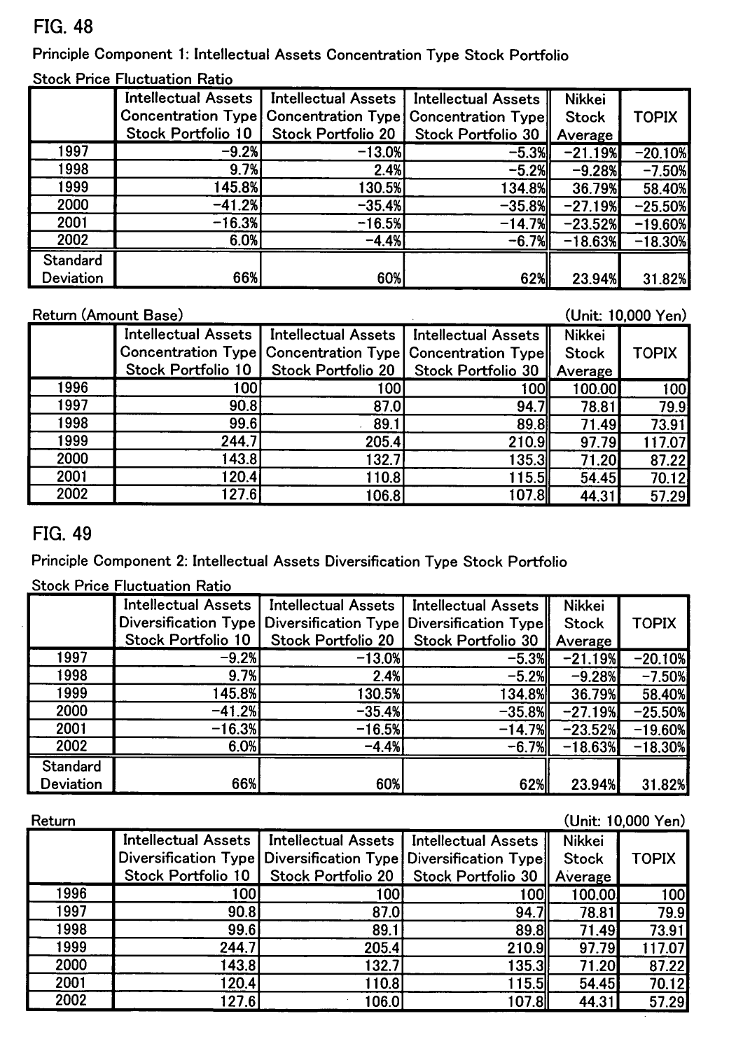

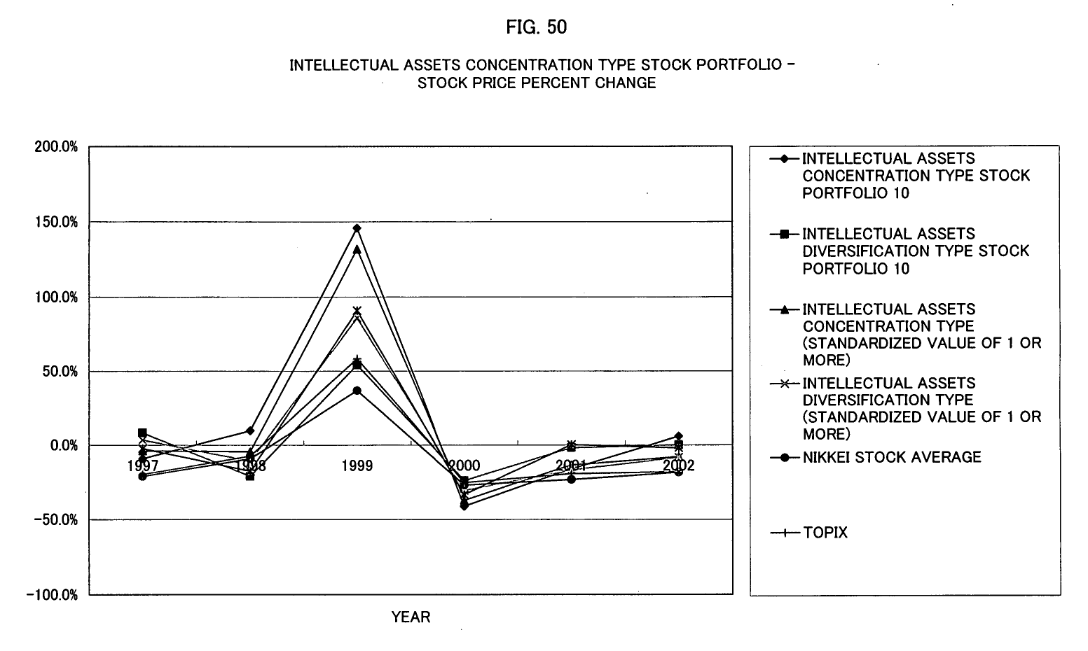

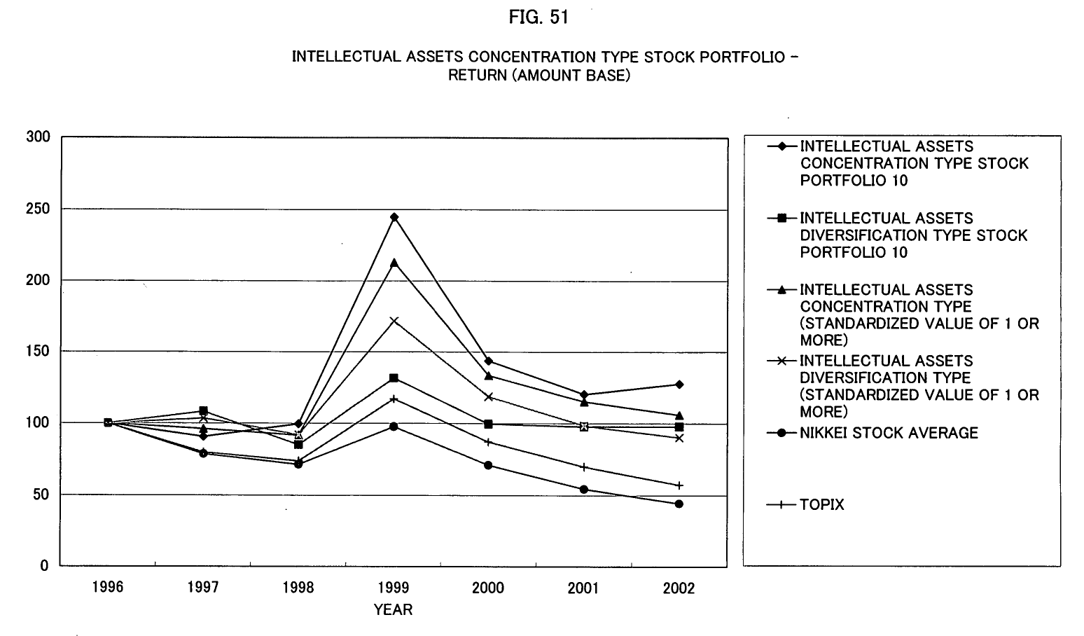

FIG. 48 is a list representing the transition of the stock price fluctuation ratio and return of the stock portfolio of the top 10 companies, top 20 companies and top 30 companies corresponding to principle component 1. FIG. 49 is a list showing the transition of the stock price fluctuation ratio and return of the stock portfolio of the top 10 companies, top 20 companies and top 30 companies corresponding to principle component 2. Further, FIG. 50 is a graph representing the comparative example of the stock price fluctuation ratio. FIG. 51 is a graph representing a comparative example of the stock return. FIG. 51 shows a comparative example of the return in the case of distributing an equal amount (=¥1,000,000) to the respective companies constituting the stock for portfolio.

When viewing the comparative example of the stock price fluctuation ratio shown in FIG. 50, the stock portfolio of the “intellectual assets concentration type” corresponding to principle component 1 shown in FIG. 48 has a larger data spread in the stock price in comparison to the stock portfolio of the “intellectual assets diversification type” corresponding to principle component 2 shown in FIG. 49. This is considered to be a reflection of the principle component 1 containing many specialized companies, and the fluctuation of the profit ratio being significant in comparison to the diversification type company group of principle component 2.

When viewing the comparative example of the stock portfolio return shown in FIG. 51, it is evident that the stock portfolio of the “intellectual assets concentration type” corresponding to principle component 1 and the stock portfolio of the “intellectual assets diversification type” corresponding to principle component 2 are both obtaining returns larger than the Nikkei Stock Average or TOPIX in all three categories of top 10 companies, top 20 companies and top 30 companies.

As described above, the stock portfolio selection device pertaining to the present invention uses the indexes obtained from patents representing off-balance intellectual assets and further adds data obtained from information concerning the management and finance of companies. Further, the stock portfolio selection device then comprehensively valuates how the respective companies are creating and operating the triune management strategy consisting of business strategy, R&D strategy and intellectual property strategy so as to increase the corporate value. Therefore, a more preferable stock-for-portfolio company can be selected based on such corporate valuation. Moreover, as a result of calculating the theoretical stock price based on the same criterion as in the case of selecting the stock-for-portfolio company, an investment ratio having a higher expected return and/or a reduced risk can be selected.

Accordingly, by employing the stock portfolio selection device pertaining to the present invention, it will be possible to provide to investors and others a new service system for creating a stock portfolio with higher profitability while linking with the index. Further, it will also be possible to provide a new stock portfolio selection method as a service. Moreover, as a result of providing the program itself for controlling the stock portfolio selection system, each client will be able to personally utilize this system to realize a stock portfolio with high profitability.

The stock portfolio selection device, stock portfolio selection method and stock portfolio selection program according to the present invention comprehensively valuates companies based on a corporate valuation index containing an R&D cost related index, management/finance related index and intellectual asset related index, and are employed for the purpose of providing a highly profitable stock portfolio based on the valuation result thereof.

1. A stock portfolio selection device for selecting a stock portfolio based on a corporate valuation index, comprising:
data acquisition means for acquiring corporate valuation index related data containing an intellectual asset related index;
company ranking creation means for performing corporate valuation with said corporate valuation index related data to create the company ranking;
stock-for-portfolio selection means for selecting a prescribed number of companies from said company ranking and making the companies the stock for portfolio;
investment ratio selection means for selecting the investment ratio of funds to be invested in the respective companies selected by said stock-for-portfolio selection means; and
stock portfolio creation means for creating a stock portfolio corresponding to said stock for portfolio based on said investment ratio.

2. The stock portfolio selection device according to claim 1, further comprising industry/company selection means for selecting an industry and/or company.

3. The stock portfolio selection device according to claim 1, wherein said company ranking creation means comprises:
index selection means for selecting a prescribed number of corporate valuation indexes so as to contain at least one intellectual asset related index from the corporate valuation index related data acquired by said data acquisition means; and
principle component analysis means for performing principle component analysis with the corporate valuation index selected by said index selection means and calculating principle component score of each company.

4. The stock portfolio selection device according to claim 1, wherein said company ranking creation means comprises:
factor analysis means for performing factor analysis to extract factor with the corporate valuation index related data acquired by said data acquisition means and uniting said corporate valuation index based on said factor;
multiple regression analysis means for performing multiple regression analysis based on the factor extracted by said factor analysis means and profit related index representing various profits such as intellectual asset related profits, and selecting the corporate valuation index based on the factor showing the statistical significance in relation to said profit related index; and
principle component analysis means for performing principle component analysis with the corporate valuation index selected by said multiple regression analysis means and calculating principle component score of each company.

5. The stock portfolio selection device according to claim 1, wherein said company ranking creation means comprises covariance structure analysis means for performing covariance structure analysis taking the corporate valuation index containing said intellectual asset related index as observed variable so as to perform corporate valuation for said respective companies.

6. The stock portfolio selection device according to claim 1, wherein said investment ratio selection means distributes investment funds equally to the stock of the respective companies selected by said stock-for-portfolio selection means.

7. The stock portfolio selection device according to claim 1, wherein said investment ratio selection means comprises:
theoretical stock price calculation means for calculating the theoretical stock price of the respective companies selected by said stock-for-portfolio selection means;
first parameter calculation means for calculating first parameters of the theoretical excess profit in relation to the market stock price of said respective companies, theoretical sensitivity of the stock price of said respective companies in relation to the fluctuation of the stock market price, and theoretical residual showing an independent price movement of the stock of said respective companies based on said theoretical stock price;
expected return calculation means for calculating the expected return of said stock for portfolio based on said first parameters;
risk calculation means for calculating the risk of said stock for portfolio based on said first parameters;
efficient frontier derivation means for deriving the efficient frontier by calculating the share of portfolio of said stock for portfolio in relation to the value of the respective expected returns so as to make the value of said expected return a fixed value and make the value of said risk a minimum value;
risk-free rate data acquisition means for acquiring the risk-free rate data;
capital market line derivation means for deriving a capital market line through a fixed point of the risk-free rate and tangent to said efficient frontier;
optimum share of portfolio calculation means for calculating the share of portfolio of said stock for portfolio in the contact point of said efficient frontier and said capital market line; and
fund investment ratio calculation means for calculating the fund investment ratio in relation to the stock of the respective companies forming said stock for portfolio based on said optimum share of portfolio.

8. The stock portfolio selection device according to claim 1, wherein said investment ratio selection means comprises:
theoretical stock price calculation means for calculating the theoretical stock price of the respective companies selected by said stock-for-portfolio selection means;
stock price index data acquisition means for acquiring price movement data of the stock price index;
individual stock data acquisition means for acquiring price movement data of the stock price of said respective companies;
second parameter calculation means for performing comparative analysis of the price movement of said stock price index and the price movement of the stock price of said respective companies, and calculating second parameters of the excess profit of each stock of said respective companies in relation to the profit of said stock price index, sensitivity of the stock price of said respective companies in relation to the price movement of said stock price index, and residual showing an independent price movement of the stock of said respective companies which is independent from the price movement of said stock price index;
correction means for correcting said second parameters based on said theoretical stock price;
expected return calculation means for calculating the expected return of said stock for portfolio based on said corrected second parameters;
risk calculation means for calculating the risk of said stock for portfolio based on said corrected second parameters;
efficient frontier derivation means for deriving the efficient frontier by calculating the share of portfolio of said stock for portfolio in relation to the value of the respective expected returns so as to make the value of said expected return a fixed value and make the value of said risk a minimum value;
risk-free rate data acquisition means for acquiring the risk-free rate data;
capital market line derivation means for deriving a capital market line through a fixed point of the risk-free rate and tangent to said efficient frontier;
optimum share of portfolio calculation means for calculating the share of portfolio of said stock for portfolio in the contact point of said efficient frontier and said capital market line; and
fund investment ratio calculation means for calculating the fund investment ratio in relation to the stock of the respective companies forming said stock for portfolio based on said optimum share of portfolio.

9. The stock portfolio selection device according to claim 7, wherein said theoretical stock price calculation means comprises:
total business income after tax theoretical value calculation means for calculating the total business income after tax theoretical value of a company with corporate valuation index related data containing said intellectual asset related index;
investment capital cost calculation means for calculating the investment capital cost of a company with said corporate valuation index related data;
theoretical economic excess profit calculation means for calculating the theoretical economic excess profit by deducting said investment capital cost from said total business income after tax theoretical value;
discount rate calculation means for calculating the discount rate for derivation of the present value of a company with the corporate valuation index related data containing said intellectual asset related index;
theoretical market-value-added calculation means for calculating the theoretical market-value-added by dividing said theoretical economic excess profit by said discount rate;
equity capital calculation means for calculating the equity capital of a company with corporate valuation index related data containing said intellectual asset related index;
estimated aggregate market value calculation means for calculating the estimated aggregate market value of a company by adding said market-value-added and said equity capital; and
theoretical stock price calculation means for calculating the theoretical stock price by dividing said estimated aggregate market value by the total outstanding stock volume.

10. The stock portfolio selection device according to claim 8, wherein said theoretical stock price calculation means comprises:
total business income after tax theoretical value calculation means for calculating the total business income after tax theoretical value of a company with corporate valuation index related data containing said intellectual asset related index;
investment capital cost calculation means for calculating the investment capital cost of a company with said corporate valuation index related data;
theoretical economic excess profit calculation means for calculating the theoretical economic excess profit by deducting said investment capital cost from said total business income after tax theoretical value;
discount rate calculation means for calculating the discount rate for derivation of the present value of a company with the corporate valuation index related data containing said intellectual asset related index;
theoretical market-value-added calculation means for calculating the theoretical market-value-added by dividing said theoretical economic excess profit by said discount rate;
equity capital calculation means for calculating the equity capital of a company with corporate valuation index related data containing said intellectual asset related index;
estimated aggregate market value calculation means for calculating the estimated aggregate market value of a company by adding said market-value-added and said equity capital; and
theoretical stock price calculation means for calculating the theoretical stock price by dividing said estimated aggregate market value by the total outstanding stock volume.

11. A stock portfolio selection method for selecting a stock portfolio based on a corporate valuation index, comprising:
a data acquisition step for acquiring corporate valuation index related data containing an intellectual asset related index;
a company ranking creation step for performing corporate valuation with said corporate valuation index related data to create the company ranking;
a stock-for-portfolio selection step for selecting a prescribed number of companies from said company ranking and making the companies the stock for portfolio;
an investment ratio selection step for selecting the investment ratio of funds to be invested in the respective companies selected by said stock-for-portfolio selection step; and
a stock portfolio creation step for creating a stock portfolio corresponding to said stock for portfolio based on said investment ratio.

12. The stock portfolio selection method according to claim 11, further comprising an industry/company selection step for selecting an industry and/or company.

13. The stock portfolio selection method according to claim 11, wherein said company ranking creation step comprises:
an index selection step for selecting a prescribed number of corporate valuation indexes so as to contain at least one intellectual asset related index from the corporate valuation index related data acquired by said data acquisition step; and
a principle component analysis step for performing principle component analysis with the corporate valuation index selected by said index selection step and calculating principle component score of each company.

14. The stock portfolio selection method according to claim 11, wherein said company ranking creation step comprises:
a factor analysis step for performing factor analysis to extract factor with the corporate valuation index related data acquired by said data acquisition step and uniting said corporate valuation index based on said factor;
a multiple regression analysis step for performing multiple regression analysis based on the factor extracted by said factor analysis step and profit related index representing various profits such as intellectual asset related profits, and selecting the corporate valuation index based on the factor showing the statistical significance in relation to said profit related index; and
a principle component analysis step for performing principle component analysis with the corporate valuation index selected by said multiple regression analysis step and calculating principle component score of each company.

15. The stock portfolio selection method according to claim 11, wherein said company ranking creation step comprises a covariance structure analysis step for performing covariance structure analysis taking the corporate valuation index containing said intellectual asset related index as observed variable so as to perform corporate valuation for said respective companies.

16. The stock portfolio selection method according to claim 11, wherein said investment ratio selection step distributes investment funds equally to the stock of the respective companies selected by said stock-for-portfolio selection step.

17. The stock portfolio selection method according to claim 11, wherein said investment ratio selection step comprises:
a theoretical stock price calculation step for calculating the theoretical stock price of the respective companies selected by said stock-for-portfolio selection step;
a first parameter calculation step for calculating first parameters of the theoretical excess profit in relation to the market stock price of said respective companies, theoretical sensitivity of the stock price of said respective companies in relation to the fluctuation of the stock market price, and theoretical residual showing an independent price movement of the stock of said respective companies based on said theoretical stock price;
an expected return calculation step for calculating the expected return of said stock for portfolio based on said first parameters;
a risk calculation step for calculating the risk of said stock for portfolio based on said first parameters;
an efficient frontier derivation step for deriving the efficient frontier by calculating the share of portfolio of said stock for portfolio in relation to the value of the respective expected returns so as to make the value of said expected return a fixed value and make the value of said risk a minimum value;
a risk-free rate data acquisition step for acquiring the risk-free rate data;
a capital market line derivation step for deriving a capital market line through a fixed point of the risk-free rate and tangent to said efficient frontier;
an optimum share of portfolio calculation step for calculating the share of portfolio of said stock for portfolio in the contact point of said efficient frontier and said capital market line; and
a fund investment ratio calculation step for calculating the fund investment ratio in relation to the stock of the respective companies forming said stock for portfolio based on said optimum share of portfolio.

18. The stock portfolio selection method according to claim 11, wherein said investment ratio selection step comprises:
a theoretical stock price calculation step for calculating the theoretical stock price of the respective companies selected by said stock-for-portfolio selection step;
a stock price index data acquisition step for acquiring price movement data of the stock price index;
an individual stock data acquisition step for acquiring price movement data of the stock price of said respective companies;
a second parameter calculation step for performing comparative analysis of the price movement of said stock price index and the price movement of the stock price of said respective companies, and calculating second parameters of the excess profit of each stock of said respective companies in relation to the profit of said stock price index, sensitivity of the stock price of said respective companies in relation to the price movement of said stock price index, and residual showing an independent price movement of the stock of said respective companies which is independent from the price movement of said stock price index;
a correction step for correcting said second parameters based on said theoretical stock price;
an expected return calculation step for calculating the expected return of said stock for portfolio based on said corrected second parameters;
a risk calculation step for calculating the risk of said stock for portfolio based on said corrected second parameters;
an efficient frontier derivation step for deriving the efficient frontier by calculating the share of-portfolio of said stock for portfolio in relation to the value of the respective expected returns so as to make the value of said expected return a fixed value and make the value of said risk a minimum value;
a risk-free rate data acquisition step for acquiring the risk-free rate data;
a capital market line derivation step for deriving a capital market line through a fixed point of the risk-free rate and tangent to said efficient frontier;
an optimum share of portfolio calculation step for calculating the share of portfolio of said stock for portfolio in the contact point of said efficient frontier and said capital market line; and
a fund investment ratio calculation step for calculating the fund investment ratio in relation to the stock of the respective companies forming said stock for portfolio based on said optimum share of portfolio.

19. The stock portfolio selection method according to claim 17, wherein said theoretical stock price calculation step comprises:
a total business income after tax theoretical value calculation step for calculating the total business income after tax theoretical value of a company with corporate valuation index related data containing said intellectual asset related index;
an investment capital cost calculation step for calculating the investment capital cost of a company with said corporate valuation index related data;
a theoretical economic excess profit calculation step for calculating the theoretical economic excess profit by deducting said investment capital cost from said total business income after tax theoretical value;
a discount rate calculation step for calculating the discount rate for derivation of the present value of a company with the corporate valuation index related data containing said intellectual asset related index;
a theoretical market-value-added calculation step for calculating the theoretical market-value-added by dividing said theoretical economic excess profit by said discount rate;
an equity capital calculation step for calculating the equity capital of a company with corporate valuation index related data containing said intellectual asset related index;
an estimated aggregate market value calculation step for calculating the estimated aggregate market value of a company by adding said market-value-added and said equity capital; and
a theoretical stock price calculation step for calculating the theoretical stock price by dividing said estimated aggregate market value by the total outstanding stock volume.

20. The stock portfolio selection method according to claim 18, wherein said theoretical stock price calculation step comprises:
a total business income after tax theoretical value calculation step for calculating the total business income after tax theoretical value of a company with corporate valuation index related data containing said intellectual asset related index;
an investment capital cost calculation step for calculating the investment capital cost of a company with said corporate valuation index related data;
a theoretical economic excess profit calculation step for calculating the theoretical economic excess profit by deducting said investment capital cost from said total business income after tax theoretical value;
a discount rate calculation step for calculating the discount rate for derivation of the present value of a company with the corporate valuation index related data containing said intellectual asset related index;
a theoretical market-value-added calculation step for calculating the theoretical market-value-added by dividing said theoretical economic excess profit by said discount rate;
an equity capital calculation step for calculating the equity capital of a company with corporate valuation index related data containing said intellectual asset related index;
an estimated aggregate market value calculation step for calculating the estimated aggregate market value of a company by adding said market-value-added and said equity capital; and
a theoretical stock price calculation step for calculating the theoretical stock price by dividing said estimated aggregate market value by the total outstanding stock volume.

21. A computer-readable medium storing a program for causing a computer to execute a function of selecting a stock portfolio based on a corporate valuation index, said function comprising:
a data acquisition step for acquiring corporate valuation index related data containing an intellectual asset related index;
a company ranking creation step for performing corporate valuation with said corporate valuation index related data to create the company ranking;
a stock-for-portfolio selection step for selecting a prescribed number of companies from said company ranking and making the companies the stock for portfolio;
an investment ratio selection step for selecting the investment ratio of funds to be invested in the respective companies selected by said stock-for-portfolio selection step; and
a stock portfolio creation step for creating a stock portfolio corresponding to said stock for portfolio based on said investment ratio.

22. The computer-readable medium according to claim 21, said function further comprising an industry/company selection step for selecting an industry and/or company.

23. The computer-readable medium according to claim 21, wherein said company ranking creation step comprises:
an index selection step for selecting a prescribed number of corporate valuation indexes so as to contain at least one intellectual asset related index from the corporate valuation index related data acquired by said data acquisition step; and
a principle component analysis step for performing principle component analysis with the corporate valuation index selected by said index selection step and calculating principle component score of each company.

24. The computer-readable medium according to claim 21, wherein said company ranking creation step comprises:
a factor analysis step for performing factor analysis to extract factor with the corporate valuation index related data acquired by said data acquisition step and uniting said corporate valuation index based on said factor;
a multiple regression analysis step for performing multiple regression analysis based on the factor extracted by said factor analysis step and profit related index representing various profits such as intellectual asset related profits, and selecting the corporate valuation index based on the factor showing the statistical significance in relation to said profit related index; and
a principle component analysis step for performing principle component analysis with the corporate valuation index selected by said multiple regression analysis step and calculating principle component score of each company.

25. The computer-readable medium according to claim 21, wherein said company ranking creation step comprises a covariance structure analysis step for performing covariance structure analysis taking the corporate valuation index containing said intellectual asset related index as observed variable so as to perform corporate valuation for said respective companies.

26. The computer-readable medium according to claim 21, wherein said investment ratio selection step distributes investment funds equally to the stock of the respective companies selected by said stock-for-portfolio selection step.

27. The computer-readable medium according to claim 21, wherein said investment ratio selection step comprises:
a theoretical stock price calculation step for calculating the theoretical stock price of the respective companies selected by said stock-for-portfolio selection step;
a first parameter calculation step for calculating first parameters of the theoretical excess profit in relation to the market stock price of said respective companies, theoretical sensitivity of the stock price of said respective companies in relation to the fluctuation of the stock market price, and theoretical residual showing an independent price movement of the stock of said respective companies based on said theoretical stock price;
an expected return calculation step for calculating the expected return of said stock for portfolio based on said first parameters;
a risk calculation step for calculating the risk of said stock for portfolio based on said first parameters;
an efficient frontier derivation step for deriving the efficient frontier by calculating the share of portfolio of said stock for portfolio in relation to the value of the respective expected returns so as to make the value of said expected return a fixed value and make the value of said risk a minimum value;
a risk-free rate data acquisition step for acquiring the risk-free rate data;
a capital market line derivation step for deriving a capital market line through a fixed point of the risk-free rate and tangent to said efficient frontier;
an optimum share of portfolio calculation step for calculating the share of portfolio of said stock for portfolio in the contact point of said efficient frontier and said capital market line; and
a fund investment ratio calculation step for calculating the fund investment ratio in relation to the stock of the respective companies forming said stock for portfolio based on said optimum share of portfolio.

28. The computer-readable medium according to claim 21, wherein said investment ratio selection step comprises:
a theoretical stock price calculation step for calculating the theoretical stock price of the respective companies selected by said stock-for-portfolio selection step;
a stock price index data acquisition step for acquiring price movement data of the stock price index;
an individual stock data acquisition step for acquiring price movement data of the stock price of said respective companies;
a second parameter calculation step for performing comparative analysis of the price movement of said stock price index and the price movement of the stock price of said respective companies, and calculating second parameters of the excess profit of each stock of said respective companies in relation to the profit of said stock price index, sensitivity of the stock price of said respective companies in relation to the price movement of said stock price index, and residual showing an independent price movement of the stock of said respective companies which is independent from the price movement of said stock price index;
a correction step for correcting said second parameters based on said theoretical stock price;
an expected return calculation step for calculating the expected return of said stock for portfolio based on said corrected second parameters;
a risk calculation step for calculating the risk of said stock for portfolio based on said corrected second parameters;
an efficient frontier derivation step for deriving the efficient frontier by calculating the share of portfolio of said stock for portfolio in relation to the value of the respective expected returns so as to make the value of said expected return a fixed value and make the value of said risk a minimum value;
a risk-free rate data acquisition step for acquiring the risk-free rate data;
a capital market line derivation step for deriving a capital market line through a fixed point of the risk-free rate and tangent to said efficient frontier;
an optimum share of portfolio calculation step for calculating the share of portfolio of said stock for portfolio in the contact point of said efficient frontier and said capital market line; and
a fund investment ratio calculation step for calculating the fund investment ratio in relation to the stock of the respective companies forming said stock for portfolio based on said optimum share of portfolio.

29. The computer-readable medium according to claim 27, wherein said theoretical stock price calculation step comprises:
a total business income after tax theoretical value calculation step for calculating the total business income after tax theoretical value of a company with corporate valuation index related data containing said intellectual asset related index;
an investment capital cost calculation step for calculating the investment capital cost of a company with said corporate valuation index related data;
a theoretical economic excess profit calculation step for calculating the theoretical economic excess profit by deducting said investment capital cost from said total business income after tax theoretical value;
a discount rate calculation step for calculating the discount rate for derivation of the present value of a company with the corporate valuation index related data containing said intellectual asset related index;
a theoretical market-value-added calculation step for calculating the theoretical market-value-added by dividing said theoretical economic excess profit by said discount rate;
an equity capital calculation step for calculating the equity capital of a company with corporate valuation index related data containing said intellectual asset related index;
an estimated aggregate market value calculation step for calculating the estimated aggregate market value of a company by adding said market-value-added and said equity capital; and
a theoretical stock price calculation step for calculating the theoretical stock price by dividing said estimated aggregate market value by the total outstanding stock volume.

30. The computer-readable medium according to claim 28, wherein said theoretical stock price calculation step comprises:
a total business income after tax theoretical value calculation step for calculating the total business income after tax theoretical value of a company with corporate valuation index related data containing said intellectual asset related index;
an investment capital cost calculation step for calculating the investment capital cost of a company with said corporate valuation index related data;
a theoretical economic excess profit calculation step for calculating the theoretical economic excess profit by deducting said investment capital cost from said total business income after tax theoretical value;
a discount rate calculation step for calculating the discount rate for derivation of the present value of a company with the corporate valuation index related data containing said intellectual asset related index;
a theoretical market-value-added calculation step for calculating the theoretical market-value-added by dividing said theoretical economic excess profit by said discount rate;
an equity capital calculation step for calculating the equity capital of a company with corporate valuation index related data containing said intellectual asset related index;
an estimated aggregate market value calculation step for calculating the estimated aggregate market value of a company by adding said market-value-added and said equity capital; and
a theoretical stock price calculation step for calculating the theoretical stock price by dividing said estimated aggregate market value by the total outstanding stock volume.
